(19) United States
(12) Patent Application Publication
(10) Pub. No.: US 2009/0063427 A1
(43) Pub. Date: Mar. 5, 2009

(54) Communications System and Method

(76) Inventors: Marc Zuta, Petah Tikva (IL); Idan Zuta, Petah Tikva (IL)

Correspondence Address: MARC ZUTA, 19 BEN YEHUDA STREET, P.O. BOX 2162, PETAH TIKVA, 49120, IL

(21) Appl. No.: 12/203,450

(22) Filed: Sep. 3, 2008

(30) Foreign Application Priority Data
Sep. 3, 2007 (GB) 0716959.2

(51) Int. Cl. G06F 17/30; G06F 7/06; G06Q 10/00

(52) U.S. Cl. 707/3; 705/1

(57) ABSTRACT

A method for describing an invention comprising: a. defining a vocabulary of standard terms; b. describing the invention in a concise form and using only standard terms for the substantive description. The description may be in concise form uses mathematical equations or mathematical-like statements or tables. The description comprises, for an apparatus invention, the parts of the apparatus and the interrelationships therebetween, and for a method invention the steps of the invention and the order of execution of the steps.

### FIELD OF THE INVENTION

This invention relates to a system and method for communicating, processing and protecting inventions, using high tech instruments.

Copyright® 2007, 2008 by Marc Zuta and Idan Zuta

All rights reserved.

The present applicants do not claim Copyright rights in material cited from the U.K. Intellectual Property Office (UK IPO) and U.S. Patent and Trademark Office (USPTO).

The moral right of the authors has been asserted.

Patentics^{SM}, LIM-IP^{SM}, Patent4u^{SM}, QualSearch^{SM} and PatEdit^{SM} are claimed as service marks by Idan Zuta and Marc Zuta.

InvenEq™, ClaimInv™, QualPat™ and SafePaper™ are claimed as trade marks by Idan Zuta and Marc Zuta.

### Trademark Protection for Products Disclosed in the Present Application

The applicants plan to start offering these products in commerce shortly after filing the present patent application:

InvenEq™—a concise description of an invention using a standard vocabulary. This description may be part of a patent application, either in hard copy or soft format.

ClaimInv™—a (patent) claim for an invention, including a description of the invention and info re compliance with the patentability requirements. The description of the invention may use the InvenEq™ technology.

QualPat™—a patent or patent application which includes all or part of the novel features (such as the trademarked products and service marked services) disclosed in the present application.

SafePaper™—a document including a description pertaining to an invention and additional info relating to the transmission of the invention. The document may be paper (hard copy) or an electronic document; the description may include one or more pages of text, drawings and/or computer code. The additional info may include the number of pages, date and time of transmission, the area of the page which was received, a digital signature.

### Service Mark Protection for Services Disclosed in the Present Application

The applicants plan to start offering these services in commerce shortly after filing the present application:

Patentics^{SM}—a method for patenting inventions and enforcing patents, using a scientific approach and Invention formulas^{SM}, adopting and adapting from the methodology of physics and mathematics.

LIM-IP^{SM}—an integrated, coherent method for achieving multiple IP (intellectual property) protection for an invention or technology

QualSearch^{SM}—advanced search method, optionally also including processing of the search results.

PatEdit^{SM}—editing of patents or patent applications, while keeping track of changes and otherwise taking into account patent law requirements regarding such editing.

### BACKGROUND OF THE INVENTION

Filing a patent application is the first step in manufacturing the product disclosed in that application. Patents are concerned with manufacturing, as a method of manufacture and as an Intellectual Property (IP) instrument, thus it is patentable, non excluded matter:

1. A patent application includes a method for manufacturing the product disclosed therein. Without that disclosure, the new product cannot be manufactured. Using the disclosure, the rest is routine: the description in the patent application includes enough details for a person skilled in the art (or a team of such engineers and technicians as may be required) to finish the design and bring it to production.

2. If the inventor becomes discouraged, loses interest or simply forgets it, thereby not filing a patent application, the innovative product may be lost forever.

3. Sometimes the invention is fuzzy in inventor's mind, characterized by its inconcinnity or incomplete disclosure. The invention may become complete when put in writing and challenged by an agent during the application drafting process.

4. Publishing the invention prior to filing a patent application may cause loss of rights; inventors will postpone manufacturing until filing a patent application.

5. Patents are essential for the development and manufacture of new products; on the other hand, the industry in a country may be prohibited from manufacturing a product if the patent therefor is owned by a manufacturer in another country.

Thus, it is important to file a quality patent application, which has a better chance of being approved for patent, and as soon as possible (first to file).

Inventors may get discouraged with the high cost of patenting, the waste of time and the complexities of the process, and refrain from filing the application.

Others may file the application themselves. Such an application may lack the required technical basis, so that not enough info is presented to allow its industrial application. The description may include just a list of requirements, pieces of wishful thinking or a commercial advertisement. The inventor, feeling protected after filing the application, may then prematurely disclose the invention to the public, thus reducing his chance of getting a patent approved.

Others may get stuck in the patent prosecution process, or with inadequate protection because of inferior claims. Professional help is required to obtain a patent—a quality, useful patent. Patents now protect the most advanced inventions, yet the patenting process itself remains basically manual. There are databases for storing information, word processors for editing documents, graphic editors for drawings, general purpose communications systems—but these tools do not address the substantive aspects of the invention itself.

Patent drafting is a manual process, involving face-to-face meetings between inventor and agent and writing a story-like description. Comparisons with prior art are made manually and intuitively by reading their textual descriptions and comparing their drawings, one to one.
There are no objective, technical, high tech means to support a user in dealing with the substantive aspects of inventions.

Thus, people may refrain from pursuing the patenting process altogether. Opportunities to pursue inventions, for the benefit of the inventor and the economy at large, may be lost.

A method for effective communication between inventor and agent is required. Inventors may desire to file documents with the agent or with the Patent Office directly. How can one be sure the documents were received correctly? Sometimes the head of the page is clipped off, or the bottom part, or several lines are missing, or the same page is sent twice but another is missing—how can the sender and recipient be sure the transmission went OK? If not, the application may be filed with omissions and may cause irreparable damage.

A first step may be the patent search—people want to study the prior art. If the invention is already known, the inventor may quit at this stage. Knowledge of prior art may help enhance the present application and better distinguish it, thus increasing the chances of its getting approved to patent, and of achieving a stronger patent protection. A search may be undesirable for copyright protection, for example.

There are many search options, including for example a free search on the Internet at USPTO, UK IPO, EPO, JPO, etc.; a search performed by a patent attorney; a paid search performed at the US PTO, the UK IPO, EPO.

The inventor may find it difficult to choose a search strategy and manage it. A patentability search should include not only patents and patent applications, but also technical information, products data, etc.

Various databases may each require a different search method, and the inventor may need guidance in using them.

More important still—the inventor may need a professional's advice in interpreting the patents found, as these involve both technical and legal issues. During patent prosecution, the inventor may need to acquire various documents, for example copies of patents.

Various databases may each refer in a different way to these documents. Tools to help the inventor are highly desirable. The patent search may address various needs—to learn a technology field, to evaluate patentability issues or infringement chances, or to keep up-to-date on emerging, relevant patents/patent applications. A different type of search may be required in each case.

Yet another problem with the patent system is the structure of the patent application itself. Patent applications are sometimes unclear, the parts of the application do not match, the terms used are not standard. There may be errors or conflicting parts in an applications.

The patent application's structure is dialectic and linear: it strives to describe the invention by contrasting the existing technology (background, prior art) with the new (summary, detailed description, drawings), through a linear, textual presentation.

The issue is further complicated, as the text sometimes does not present a clear functional interrelationship between the description of embodiments of the invention, the benefits promised or provided, and the claims.

A difficult problem in the examination and evaluation of patents relates to inventor's right to define his own terminology for the disclosure and claims. This poses a most difficult dilemma: On the one hand, inventions are sometimes difficult to define in traditional terms, and precluding this inventor's prerogative may prevent the legitimate expression of new ideas; on the other hand, the inventor may lack knowledge of accepted scientific terms, may not be fluent in the English language, or may simply be mistaken.

Because of nonstandard terminology, claims cannot be read at face value, but have to be interpreted in light of the disclosure. Every time the Examiner studies prior art, he/she has to read the disclosure to refresh his memory on each cited patent. This takes time, and slows down the examination. Furthermore, patent searches using standard terms may not be effective.

How is it possible to search tens of millions of patens, hoping to address nonstandard terms which may be used there? How, then, can someone compare an application with prior art patents, to search tens of millions of patents and applications, understand their meaning and decide on the novelty and inventive step in a new application?

Mathematics of Comparing a New Application with a Cited Patent:

Let us assume each document contains 20 claims, of 5 terms each. Number of total claims comparisons to perform: 400 (20*20) Now let us assume each term used has 6 equivalent terms (synonyms/antonyms) Another application uses similar terms, not quite the same, also 6 of them. Each claim now can be expressed in 6 exp. 5 ways=7,776 possibilities. Comparing two claims has 60 million possibilities. Now multiply this by 400 . . .

The above—if standard terms are used. The problem is greatly complicated if the inventor used unusual terms.

How is the problem presently solved? The human mind has extraordinary capabilities, it can take the gist of a claim in a flash and solve the synonyms problems, but it takes an effort and time. There is a large applications log at the Patent Office, and such delays are a worldwide problem. How are decisions on patentability been reached?

There is a problem with examining patent applications: the backlog at the USPTO is about 800,000 applications and growing; a similar problem exists in other industrialized countries. Helping ameliorate this problem may benefit the Patent Office, inventors and patent agents, and the industry.

Starting 25 Aug. 2006, the USPTO has established a new procedure for accelerated examination of patent applications, to complete examination within 12 months. To be eligible, an inventor has to file an application which is easier to examine, together with a prior art search and further documentation to distinguish the invention from the cited references.

It is difficult to comply with the requirements for accelerated examination using the manual, intuitive patent prosecution methods now in use. For example, USPTO demands that the Accelerated examination support document, Information Disclosure Statement (IDS), detail how each of the claims are patentable over the cited references, indicating where each limitation of the claims is supported in the description, etc.

The applicant is required to include all the relevant prior art in the IDS, but not too many citations (this is considered as obfuscating matter to hide the relevant prior art). How is one to be sure what is most relevant? The applicant has to agree to a telephone interview; it may be difficult to answer (by inventor or agent) without a real-time computer support system.

The new Accelerated Examination demands more difficult preparations by the applicant, such as:

1. To perform a preexamination search of patents, applications and non-patent literature;

2. To draft an IDS citing references most closely related to the invention and, for each reference, identifying all the limitations in the claims that are disclosed by that reference, and where;

3. An explanation of how each of the claims is patentable over the references;

4. A concise statement of the Utility of the invention;

5. To indicate where each limitation of the claims is supported in the written description; To identify any cited reference that may be disqualified as prior art under 35 U.S.C. 103(c) as amended by the CREATE Act;

6. To agree to a telephone interview with the Examiner.

It may be difficult and cumbersome to comply with the above requirements using prior art manual methods, for there is much material, the terms used in each cited document may be different, etc.

The inventor faces a dilemma: On the one hand, a wide search has to be performed to find relevant prior art: “This preexamination search must be directed to the claimed invention and encompass all the features of the claims, giving the claims the broadest possible interpretation”. On the other hand, USPTO disapproves of submitting too many cited documents: “marginally relevant information was submitted with the intent to obscure material information, this may run afoul of the duty of candor and good faith . . . ”

How, then, is one to analyze many documents and select the most relevant, where this selection has to withstand the scrutiny of the USPTO and possibly also the courts of law? How to define or measure relevancy?

How to prove compliance with the requirements?

The problem is further complicated in a global patenting system where patents in foreign languages are also relevant. Their precise translation is of paramount importance. Some languages, such as from the Far East, are difficult to translate.

The inventor is required by law to cooperate with the Examiner, to disclose prior art known to him, provide prior art documents to the Patent Office or explain some unusual use of terms in the application (according to U.S. Patent Law, for example).

However, the inventor could do more to assist the Examiner. Such activities will be detailed below, to achieve a Quality patent application.

A Quality patent application more clearly presents the invention, facilitating the dialog inventor-representative, the examination of the application and upholding one's patent rights in the courts of law.

At present, applications sometimes lack a clear presentation of the invention; there is no description of the rationale of the presentation and the links between the various parts of the application: the disclosure, drawings and claims. The present disclosure details new tools applicable to achieving a clear presentation of inventions, in patent applications having a novel structure.

There are deficiencies in a technical description of some patent applications. Whereas technical descriptions in books or magazines pass a technical review, there is no such process for patent applications, some of which are incomprehensible. A patent application will be eventually published even if it describes a system lacking utility or industrial applicability altogether, or uses baseless “technical” terms. Such applications may become “Cited prior art” and thus waste the time of people involved in the patenting process.

Often, a patent application will change during its lifetime:

The applicant may add material to the application or edit it;

A second application is filed, claiming priority from the first but also possibly including various changes;

A new application is filed, claiming priority from several prior applications;

The application is translated into another language and maybe adapted to the format required in that country.

There are various reasons for such changes: Additional material to be protected; correction of errors; requirements of Patent Law and Regulations; filing of a divisional application, a continuation, reissue, etc.; amendments made during the examination of an application; the applicant hires a patent attorney/agent to try to save a provisional, flawed application, etc. Previous Material may be included by reference, still it may be preferable to also include it in the application itself. It is required to distinguish such material from inventor's present disclosure.

A difficult problem in such cases is, How to perform changes in an application while preserving the original filing date(s). This may be of paramount importance to applicant, and also to other parties involved, who may either desire to protect the priority or contest it.

There are emerging novel technologies in use now, however these apparently do not address nor solve the above problems, for example:

Description of electronic digital systems by mathematical equations:
VHDL used by Altera Inc. for example.
VHDL—Very high speed Hardware Design Language, allows to describe a digital circuit with a set of mathematical equations. A suitable software package can simulate the circuit, to compute/simulate its outputs for an arbitrary sequence of input vectors. Thus, for all practical purposes, the computer “knows” that circuit and “understands” its operation.

CAD—computer aided design—various devices and systems are simulated in a computer, allowing an engineer to more efficiently design a new integrated circuit, airplane, car, etc.

Electronic filing of Patent applications, for example with the U.S. PTO and the British Patent Office

Filing an electronic file with info on the Patent application and applicants—PCT Easy filing with the WIPO/PCT

Artificial Intelligence

Information science

Communication technologies—Internet, cellular, other wireless, etc.

Marketing over the Internet, both of products and services

A problem in prior art is, when is it justifiable to combine prior art citations. In hindsight, the parts of many inventions may be found in prior art. Other combinations may be obvious to persons skilled in the art.

It is an objective of the present invention to address, among others, the above problems in patents filing, prosecution and subsequent use and protection.

### BRIEF SUMMARY OF THE INVENTION

Patents protect technologies based on scientific disciplines: electronics, mathematics, communications, physics, optics, mechanics, etc. The patent structure and the processes relating to patenting should also have a scientific basis and methodology—this is Patentics^{SM}. Patentics^{SM}—the science of patenting.

The present invention aims to introduce high tech, advanced methods and systems to the process of patenting inventions. These tools are adapted to address the peculiar properties of inventions and patents.

The invention helps automate parts of the patenting process, as relating to the substantive aspects of inventions: defining the invention in precise terms, comparing with prior art, drafting the patent application while distinguishing from prior art, prosecuting the patent, protecting the patent when attacked.

Using these novel methods and tools, the invention will speed up the patent drafting and prosecution processes, will reduce costs and will improve the quality of ensuing patents.

The invention relates to a system and method which assists all the parties involved in achieving and enforcing intellectual property (IP) protection: inventor, applicant, patent agent, patents examiner, courts of law. The new method may help clarify matters and expedite IP-related procedures.

Industrial applicability (not excluded matter) is detailed in the Detailed description section.

The various aspects of the invention include, among others:

1. Scientific Definition of Inventions

The science and technology develop so fast due, among others, to the methodical approach used there, with standard terms and automation. If Patenting is to keep pace with technology, it should cease to be a manual, labor-intensive, intuitive process and become governed by scientific principles as well.

The understanding and intelligence can only provided by people; but there is much legwork which can be replaced by automatic processing, and non-standard procedures which can be eliminated.

We refer not to routine office work, for which there are suitable automated tools, but to the Patenting processes themselves—drafting, examination, etc.

a. Standard terms

b. InvenEq^{SM}—Invention equations

c. Drafting the Invention equations

d. Using the Invention equations

e. Adapting the invention equation to multi-language processing

Patentics^{SM} is a systematic, scientific approach and method to patenting. Inventions are described in a mathematical, precise way, which lends itself to automatic processing in a computer. Thus inventions can be easily compared. Patentics^{SM} is a new method for patenting inventions, adopting and adapting from the methodology of physics and mathematics.

2. Achieving a Quality Patent, QualPat^{SM}

a. A definition of the Quality Patent

b. Drafting a Quality patent application

c. Structure of a Quality patent application

d. Structure of a claims-sliced patent

3. Complex Patents

The present structure of patent applications is practical and efficient for disclosing simple inventions. At present, however, many of the inventions are complex and more difficult to grasp. Also, the number of prior art patents and applications to be considered has greatly increased.

Therefore, a new structure of patent application is presented, which facilitates the understanding and examination of complex inventions.

The new structure implements the applicant's duty of disclosure as adapted to today's complex inventions.

A new approach to presenting Novelty in an application is disclosed, which facilitates comparison with the prior art in complex inventions. The new approach conforms with approaches in other aspects of patenting practice.

4. Software Patents

At present, software is looked upon as something difficult or impossible to understand. After all, who can read and understand a file with a million commands in machine code, or a plurality of strange mnemonics? How to compare a program in Visual C with prior art patents in Assembly, Basic or Cobol?

Based on applicants' experience as software programmers, software architects and software programs managers, it appears that the problem is that of incomplete disclosure.

During software development, copious documentation is created which may be advantageously used during examination. Thus, the disclosure practice can be adapted to the peculiarities of software.

Moreover, automatic processing of this info may be performed using novel methods, to facilitate the examination of Software patent applications.

a. A definition of a Quality Software Patent

b. Drafting a Quality software patent application

c. Examination of a Quality software patent application

5. Multi-IP Protection

It is possible to claim several types of IP protection in one invention. Sometimes, actions to protect one type of IP may forfeit inventor's rights to other type(s) of IP: for example, if a patents search is made, it may endanger inventor's right to copyright.

If a proper strategy is used, however, such interference between different types of IP can be prevented. Moreover, activities to achieve one type of IP protection may actually contribute to also achieving other type(s) of IP.

Unified IP protection strategy—search, patent, design, copyright, etc. A method for implementing a unified intellectual property IP protection strategy. Its use in patent protection: a unified filing and search strategy, to achieve improved patent protection—both faster filing to get earlier priority and studying the prior art for enhanced patent protection.

6. Communicating Inventions and Invention-Related Processes

Patenting activities can be performed fast and easy using high tech. Rather than wasting time to visit the patent attorney, the applicant can use novel Internet tools to communicate from a distance.

At present, patent-related activities are custom-made. A new approach uses standartized stages and activities, to allow the applicant a choice, to compare intelligently offers from various advisers.

Inventive aspects of Communicating inventions:

1) Communications system and method for supporting a dialog between inventor, agent and Patent Office using advanced computer and communications tools adapted to patenting; which hardware to use for each task according to patenting considerations, and using methods adapted to the tasks. The method is used for defining inventions, for drafting and processing patent applications (MPRP), to achieve better protection for the invention, expedite the process and reduce costs.

2) Define the invention in pictures, in dialog between inventor and agent. Pictures are a preferred way of presenting an invention or idea to humans. The pictures may include mechanical/electronic drawings, block diagrams, flow charts, tables, etc. Use picture processing methods for discussing the invention, organizing it and drafting and prosecuting the patent application.

3) Method for guiding the inventor through the patenting process, using the Internet. Various choices are explained, then the inventor can choose a strategy to pursue—whether to perform each recommended task, and how much to invest in it.

4) Safe Paper^{SM} for reliable transfer of invention documents through the Internet, even for drafts or sketches, while preventing loss of info.

7. Patenting Worldwide

Novel methods are use to translate a patent application for filing abroad, taking into account the ambiguities of words in each language.

These methods may also be used to translate prior art during search or examination.

Inventing Aspects:

1) Translating an invention drawings to textual formulas and processing the textual description.

2) Multilingual patenting for processing patents on a global scale.

Tools are required to cross the language barrier with China, Japan, Korea, etc.—either to file and prosecute patents there or to search for prior art.

8. Applications of the Patentics^{SM} technologies

These may include the various processes in the Life of a Patent. The above methods are used, in various combinations, for application drafting; prosecution, accelerated examination in USA infringement, cancelation of patent, etc.

The above, and other aspects of the invention, are interrelated and may be used in various combinations.

a. Prior Art Search

The problem is not the search itself, but the interpretation of the results. See (8) for details of interpreting prior art using this invention. The search aspects may include:

1) Method for Prior art Search and evaluate, relating to inventions rather than keywords, using Patentics^{SM}.

2) Multipurpose, multisource search method and strategy.

The new method may achieve various purposes, such as technology search, patentability, infringement, early warning searches.

The method may be used to search worldwide for a specific patent, a patent search in multiple databases, and using an improved search strategy.

b) Examination of a Quality Patent Application

1) Leveling the field during examination

The application under examination and the prior art are brought to a common form using the same standard terms and concise expressions. This may make the examination and patent prosecution process more effective.

2) Support for Accelerated Examination at the USPTO. USPTO requires complex searches and preparations of documents for this venue. Moreover, the applicant or agent should be ready to a telephone interview.

c. Refining the Patent Application

Now that the applicant sees his invention in a clear, precise and concise way, and also the prior art, he can improve his invention's description so as to better define it and distinguish from the cited prior art.

d. Patent Infringement Proceedings

Level the field using standard terms for own and other's inventions description

Compare inventions using automatic tools

Review by humans/experts/professionals the results of automatic processing

e. Patent Annulation/Cancelation Proceedings

Level the field using standard terms for own and other's inventions description

Compare inventions using automatic tools

Review by humans/experts/professionals the results of automatic processing

Benefits:

1) Sharing the results of analyzing patents, to improve the effectiveness of various people who are drafting or examining patent documents. Each of these patent experts can use the results of other's analysis.

2) The process is completely traceable and verifiable—where necessary, all the steps in analyzing a patent or comparing several patents can be reconstructed, for example during an appeal.

3) Patent experts can use the help of others for specific parts/steps of the analysis, as the need be: Linguists, Scientists, Lawyers, etc. They all communicate using concise, unambiguous, standard language and terms.

4) Higher quality of inventions processing, combining an expert's understanding of the invention with the power of computer processing.

5) The various systems and methods herein detailed may be used separately or in combinations as the need be. Thus, an integrated, high tech framework is formed for supporting the process of protecting inventions.

6) The invention also strives to improve communications between people: the inventors, applicants, patent agent, the Examiner, a court of law, all relating to pursuing inventions.

Various instruments in the telecommunications and computer fields are used for this purpose, together with novel methods.

Further objects, advantages and other features of the present invention will become obvious to those skilled in the art upon reading the present disclosure together with the computer code and drawings.

### BRIEF DESCRIPTION OF THE SEVERAL VIEWS OF THE DRAWINGS

FIG. 1 illustrates a method for defining inventions

FIG. 2 illustrates a patentable invention (apparatus) as a block diagram

FIG. 3 illustrates a claims-centric structure of a patent application

FIG. 4 illustrates a data structure for presenting an invention, enhanced with info which facilitates the examination using the patentability criteria

FIG. 5 details a method for defining an invention or inventive aspect or embodiment

FIG. 6 details a novel Patent application system—a structure of the new patent application and the interrelation between its parts

FIGS. 7A, 7B and 7C detail three embodiments of a method for numbering the sentences in a patent application

FIG. 8 details a Patent application drafting method

FIG. 9 details a multi-file editor PatEdit^{SM} method suitable for processing electronic documents, adapted for use with patents and patent applications

FIG. 10 details an example of a drawing in a Quality patent application, using a mesh topology description of a system in mathematical equations

FIG. 11 details a structure of an electronic document adapted for patents and patent applications use, including changes made by applicant

FIG. 12 details an editor PatEdit^{SM} method, suitable for processing electronic documents, adapted for use with patents and patent applications

FIG. 13 details a structure of an electronic document adapted for patents and patent applications use, including references to a plurality of prior documents

FIG. 14 details another structure of an electronic document adapted for patents and patent applications use, including references to a plurality of prior documents

FIG. 15 details a text/drawings editor PatEdit^{SM} suitable for processing electronic documents, adapted for use with patents and patent applications

FIG. 16 details a method for providing a broad protection for an invention and pursuing accelerated examination of its parts

FIG. 17 details a method for drafting a quality patent application

FIG. 18 details a method for disclosing an invention in pictures and processing it

FIG. 19 illustrates a block diagram describing a system invention

FIG. 20 illustrates a flow chart describing a method invention

FIG. 21 illustrates a claims-sliced structure of a patent application or patent

FIG. 22C presents a novel approach to checking for Novelty using indirect criteria, which may be useful especially in complex inventions like Software,

FIG. 22A presents an indirect test for Non-obviousness and

FIG. 22B presents an indirect test for patent Infringement

FIG. 23 illustrates typical stages in developing computer software, using accepted practices in the software industry, and a method for presenting software inventions created in the process

FIG. 24 illustrates a method for comparing software inventions to decide on Novelty

FIG. 25 details the LIM-IP^{SM} method—an integrated, coherent approach to multiple-IP protection of inventions or new technologies

FIG. 26 details the LIM-IP^{SM} method—an integrated, coherent approach to multiple-IP protection of functional inventions

FIG. 27 illustrates a system for drafting and filing patent applications using the Internet and other telecommunication channels

FIG. 28 details a method for drafting and filing patent applications using the Internet and other telecommunication channels

FIG. 29 details a method for guiding a user by displaying the stages of filing a patent application and pursuing the invention, giving the user a choice of activities to do and their cost, as a bi-dimensional Time/Cost matrix

FIG. 30 details a user's menu for connecting with various Patent Office sites

FIG. 31 details an interface method and menu for disclosing an invention to a patent agent in pictures and using computer interface means, over the Internet

FIG. 32 details a unified method for assisting in achieving intellectual property protection for an invention

FIG. 33 details one implementation of a user's choice of activities to do and their cost, to perform a unified patents search and patent application filing

FIG. 34 details a page structure for sending safe messages

FIG. 35 details another embodiment of a page structure for sending safe messages

FIG. 36 details the structure of a Page returned from a Patent Office (PDF format) with filing acknowledgement and relevant info.

FIG. 37 details a multisource, multipurpose search strategy

FIG. 38 details a method for performing a patents search at the US PTO

FIG. 39 details an automatic method for assisting in comparing patents and applications

FIG. 40 details a menu to user for performing multi-database patent searches

FIG. 41 details a method for automatic comparison of inventions.

FIGS. 42A, 42B and 42C illustrate methods for comparing structured text in drawings

FIG. 43 illustrates an example of highlighting differences between two drawings

### DETAILED DESCRIPTION OF THE INVENTION

A preferred embodiment of the present invention will now be described by way of example and with reference to the accompanying drawings.

Glossary

InvenEq™—a concise description of an invention as a mathematic statement using a standard vocabulary, comprising:

a) a list of its components if apparatus, or steps if method;

b) the interconnections and/or interrelations between the components;

c) the uses, functions and/or benefits of the invention.

Mathematic statement—a concise string of words with optional symbols, arranged in a predefined order, unambiguously describing the interconnections and/or interrelations between the components of an invention.

ClaimInv™—a (patent) claim for an invention, including a description of the invention and info re compliance with the patentability requirements.

Patentics^{SM}—a method for patenting inventions and enforcing patents, using a scientific approach and Invention formulas^{SM}, adopting and adapting from the methodology of physics and mathematics.

Standard terms are words from a Standard vocabulary.

Standard vocabulary—a set of words so devised as to unambiguously define each of the possible components, interconnections and/or interrelations between components, benefits, uses, functions and advantages of inventions.

1. Scientific Definition of Inventions

In patenting, a basic issue is the definition of the invention itself. The Applicant wants protection for what he defines as his invention: a patent which grants him exclusive rights and can be enforceable in Court.

Patent Examiners and Courts want a well-defined invention which can be easy to process, examine, decide various issues relating to it.

Society wants to understand the invention so it can reclaim it after the patent expired. What was it for which exclusive rights were granted?

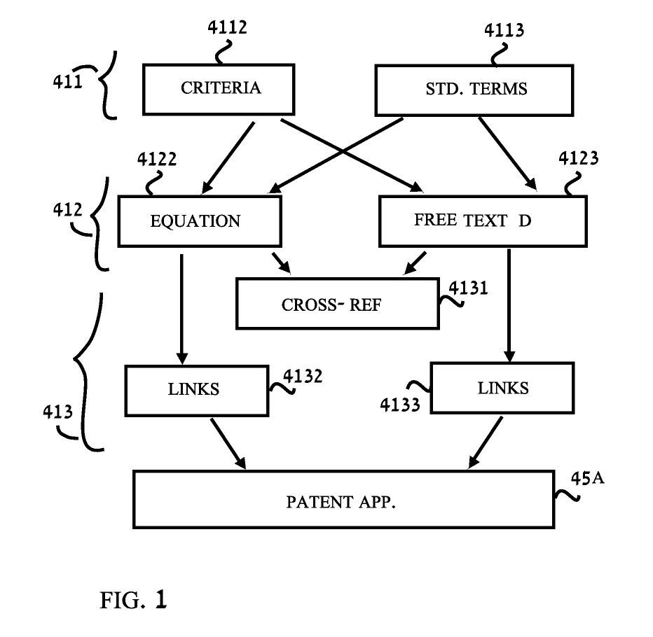

FIG. 1 illustrates a method for defining inventions, comprising: a. defining a framework for defining the invention 411; within this framework may be defined, according to the relevant Patent Laws of each country or region or PCT, the relevant patentability criteria 4112 and the standard terms 4113 in use. Preferably, only the standard terms may be used to describe the parts of the invention and their operation, the benefits achieved, advantages, etc.

Thus, the same terms may be applied to all the inventions and the same criteria, to achieve a reliable, repeatable performance.

The patent drafting software or method used may present questions based on the patentability criteria to the applicant, for example:

a. What it is, that is to be patented?
R: Is it non-excluded matter?

b. What it does? What is its function or use?
R: Complete disclosure. Utility.

The inventor knows what the invention should do, so why not disclose it to the Patent Office?

c. How it is done? The structure, components, operation, chemical structure of the invention.
R: Complete disclosure. Utility. Novelty.

d. Benefits. what the new structure will accomplish, what is the benefit to society.
R: Non-obviousness using Secondary Considerations for example.

b. invention definition 412, within the framework 411 defined above; free-text description of invention 4123, like in prior art, and a description of the invention using math equation 4122, as detailed in the present invention. The two representations are equivalent.

Here, a concise and precise definition of the invention is achieved. The textual version 4123 is mostly for humans; the equation 4122—more for computer use, for automatic comparison of inventions.

The two versions 4122 and 4123 can be compared manually, to ensure their equivalence.

c. support 413 for the invention description: here may be presented a cross-reference 4131 between (4122 and 4123), to allow further verification. This may be implemented as pointers or links between the two versions. Moreover, the support 413 may also include links to support the equations 4122 in text, drawings and others 4132 and/or links to support the free text 4123 in text, drawings and others 4133. The links 4132, 4133 may point to the full patent application including all its parts 45A, including for example the text, drawings and computer software included there.

Such a structure may allow automatic processing of the invention and also its verification by examiners, applicants or patent attorneys, to ensure that the substance of the invention is not affected by the transition to automatic representation.

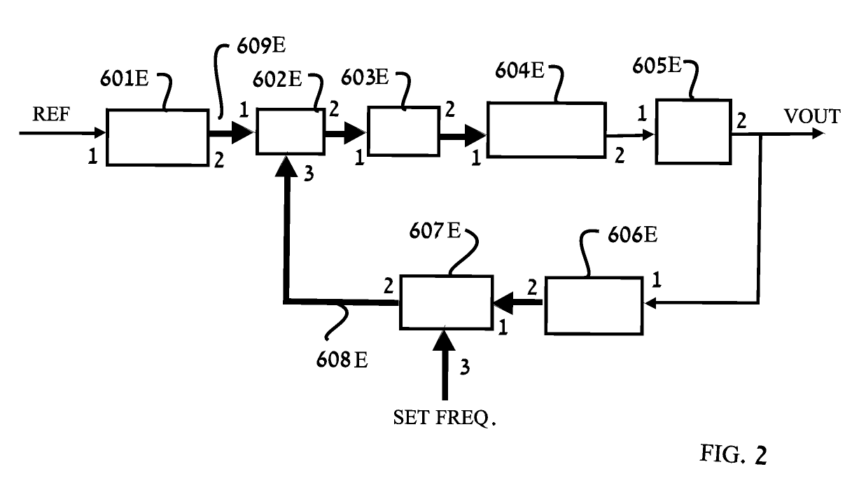

FIG. 2 illustrates a patentable invention (apparatus) as a block diagram This is a phase locked loop (PLL), comprising:

reference counter 601E

phase comparator 602E

digital to analog converter (DAC) 603E

low pass filter (LPF) 604E

voltage controlled oscillator (VCO) 605E

VCO counter 606E

digital multiplier 607E

reference signal (bus) 609E

VCO signal (bus) 608E

Structure: the parts are standard prior art parts; the structure of the PLL is novel, due to the use of a reference bus 609E and VCO bus 608E rather than one wire for each of the reference and VCO signals. This novel structure (using buses of digital info rather than single wire signals) requires a bus phase comparator 602E. The new structure also includes a multiplier 607E in the feedback loop.

The structure of the apparatus can be described as an interconnections list, for example:

601E,2>602E,1 (port 2 of block 601E is connected to port 1 of 602E, etc.

602E,2>603E,1 (port 2 of block 601E is connected to port 1 of 602E, etc. and parts list

601E=reference counter

602E=phase comparator

these lists can be entered into a computer, to allow automatic comparison with other structures, until a match is possibly found.

The operation as a PLL is also novel, due to the new structure.

There are advantages to this structure, for example faster settling time, low phase noise, output signal with lower phase noise, etc.

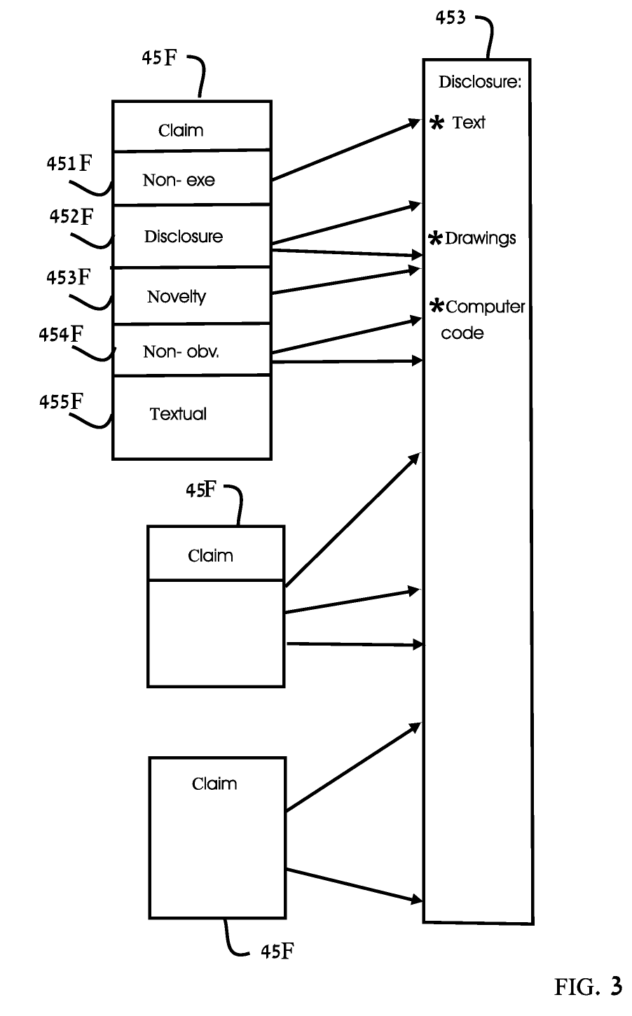

FIG. 3 illustrates a claims-centric structure of a patent application. The claims are believed to be the most important part of the application and of the patent if granted.

For the applicant—if at least one claim is allowed, then he has a patent; if none—then the application is refused.

For the examiner—the examination starts with the claim—what the applicant is asking for? The various criteria for patentability are then applied, where support for the claim is looked upon in the rest of the application.

At present, the examiner has to search all the application to find the various info which may support the claim:

is it non-excluded matter? how so?

are the terms in the claim to be read according to their usual meaning, or is another, different meaning indicated in the description?

is there support in the description and drawings for what is claimed?

Is there enough description for a person skilled in the art to do it?

what is the difference between the disclosed apparatus or method, and the prior art? Is the Novelty criterion satisfied?

is the claimed invention non-obvious to a person skilled in the art?

Take into account that that person is not dumb, but can solve simple problems. Else, are there Secondary Considerations being presented to solve this issue?

Now, if the applicant has answers to these questions, then he may present them to the examiner, to convince him he is entitled to a patent. Since the claims are the focal point during examination, a new claims structure was devised which includes all the above information. To keep the claim concise, in a preferred embodiment the info is supplied as links (pointers) to the disclosure—to the locations there, in the text, software listings and drawings, where the relevant info is presented.

Such a claims structure is presented in FIG. 3 in the exemplary claim 45F, which includes:

pointers 451F to locations in the disclosure 453 with indication of what non-excluded matter is included in the invention;

pointers 452F to locations with the various aspects of disclosing the invention—its components and their interactions, how the apparatus operates or what are the stages of the method, etc.

pointers 453F to locations where the novelty of the invention is indicated: differences in the structure and operation of the invention with respect to prior art.

pointers 454F to locations where the non-obviousness of the invention is presented, if necessary

the claim itself 455F in a textual form, as found in prior art patents.

Other claims 45F may have a similar structure. In a preferred embodiment, independent claims have a more detailed structure, whereas dependent claims may only include part of the above elements, or as the need be.

The innovative method illustrated above includes:

a. rather than letting the examiner to guess and search the application looking for clues, the claim itself includes the info required for its evaluation with respect to the accepted patentability criteria;

b. the info is presented in a concise form, preferably as pointers to the relevant text in the disclosure.

**End of Method**

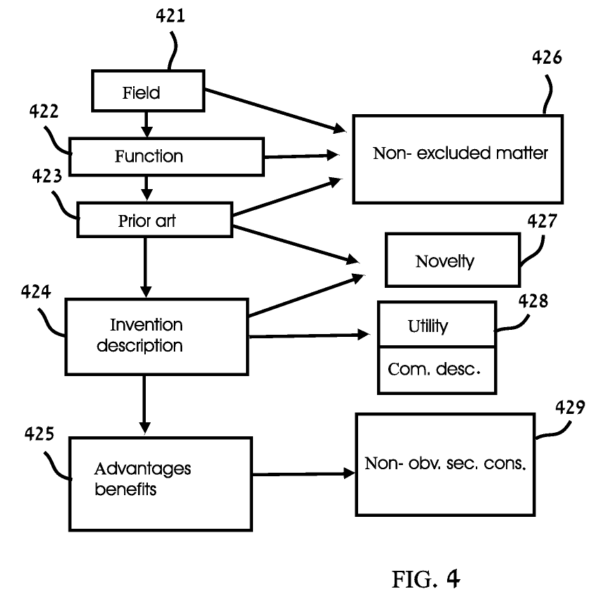

FIG. 4 illustrates a data structure for presenting an invention, enhanced with info which facilitates the examination using the patentability criteria.

The parts of the description evolve logically and sequentially each from the previous one:

the field of the invention 421,

the function of the invention 422.

the prior art 423 used to implement that function

a description 424 of the invention, and

the advantages and/or benefits 425 of the invention vs. the prior art.

Actually the description is bi-dimensional, for in addition to the above description presenting in a logical, sequential form the invention, there are presented the conclusions regarding patentability, each aspect of the patentability criteria as found in the description:

is it non-excluded matter 426?

is the invention novel 427?

is there a complete description of a useful invention (utility) 428?

is the invention non-obvious 429? this may be based on the usual criterion, and/or on Secondary Considerations, as the applicant deems adequate.

The above structure facilitates finding the answers to these and other relevant questions, either manually or automatically.

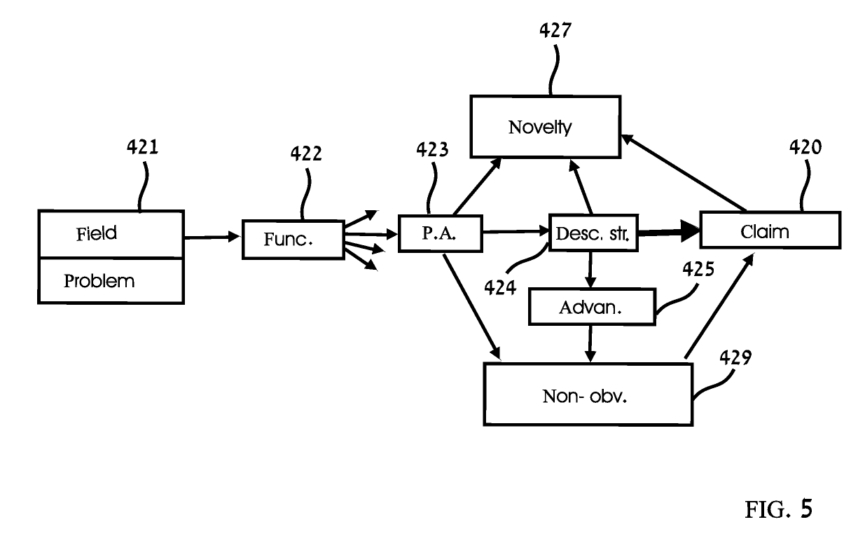

FIG. 5 details a method for defining an invention or inventive aspect or embodiment, including:

defining the field of the invention, or the problem being solved 421

describing the function or use of the invention 422—what is the use of it?

describe a practical application of the invention 423;

there may be a plurality of functions with innovative aspects, and a corresponding plurality of blocks 423.

detail the structure and operation of an embodiment 424 which implements the application 423

draft a claim 420 which protects this invention or innovative aspect.

evaluate the above with respect to Novelty 427 and Non-obviousness 429.

this can be done based on the Advantages 425 of the embodiment 424.

**End of Method**

(5) Systematic, Scientific Approach and Method to Patenting—Patentics™

Method for Defining Inventions—Introduction

At present, there is no scientific tool to describe inventions. Inventions may be understood intuitively and are described as tales, or stories. How effective is this approach in comparing a 1,000 pages patent with twenty other, cited documents, just as voluminous and verbose?

How to compare ten drawings in one patent with ten in another? One should compare both the structure (block diagram, flow chart . . . ) and the text there.

This reminds one of the arithmetic problems in primary school such as “A first car starts from A to B at a speed of 60 mph; after 3.5 hours, a second car starts from B to A, at a speed of . . . ”. Such problems required a lot of ingenuity to solve, until we learned a bit of algebra, then it was simple, just routine.

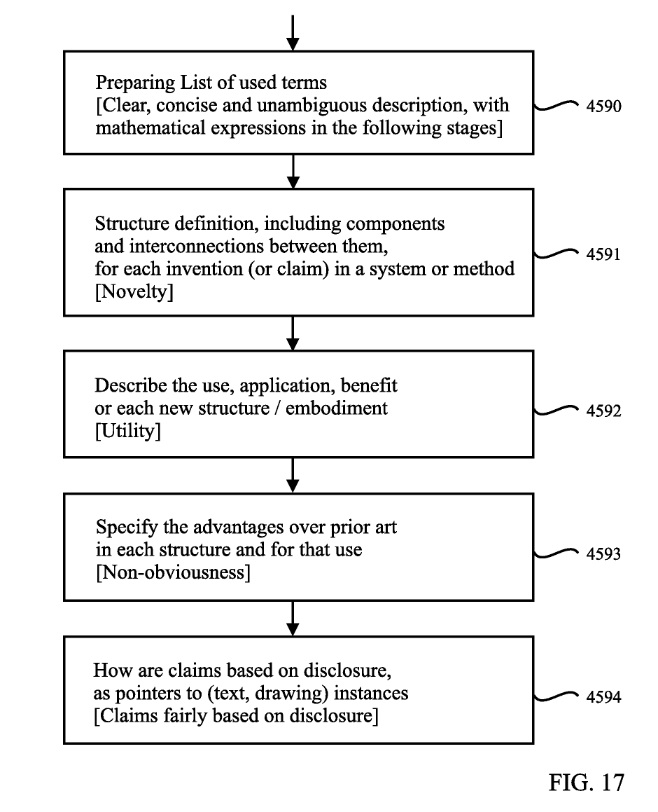

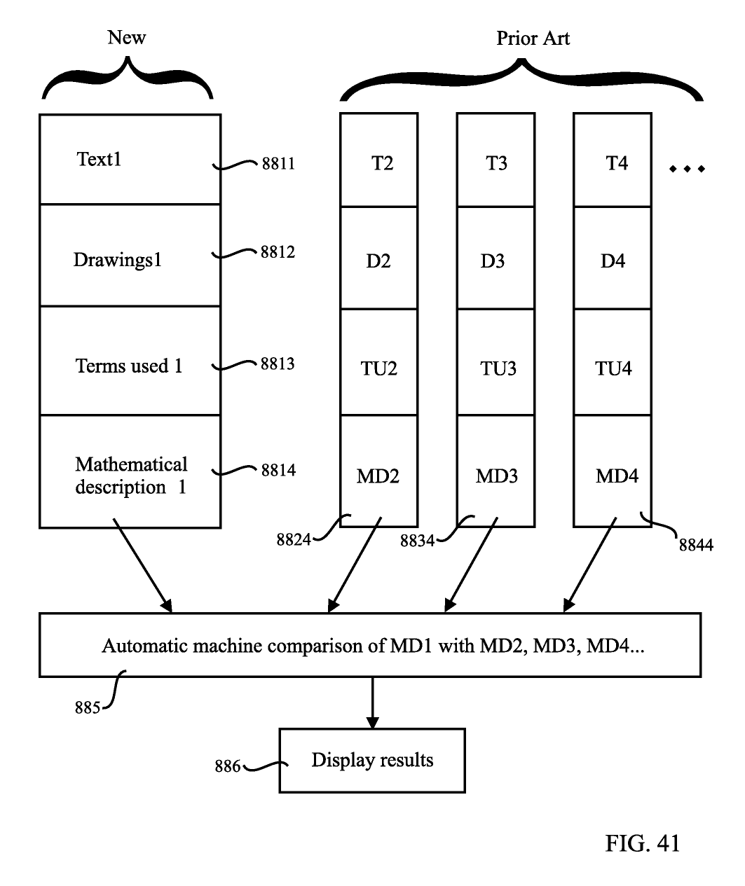

Patentics™ is a new method which borrows from the methodology of physics and mathematics to describe inventions in a precise and concise way, see for example the disclosure with reference to FIGS. 17 and 41.

When the invention is scientifically described, it can be processed by computer, to search and compare millions of inventions per second.

An invention is defined or described as a three-dimensional vector comprising the variables of:

1. Structure description

2. Use/application, how it works, how it is used; and

3. Advantages over prior art and/or other Secondary Considerations.

This definition complies with Patent Law regarding Novelty, Utility and Non-obviousness, respectively. Each of the above variables is defined using standard terms with mathematical terms defining the interconnections between the terms.

Method C8 for Defining Inventions

a. Prepare a list of standard terms in use [4590], that is the list of relevant terms for describing the invention.

See for example Method C9 for developing a Standard vocabulary. The terms used 1 [8813] are drawn from the Text1 [8811] and Drawings1 [8812].

Every scientific discipline has standard terms, accepted and understood by scientists worldwide. Preferably, each term here should be that used in the scientific discipline relevant to the invention, with a reference to an accepted document defining it.

The standard terms are used to describe the invention. These terms are the building blocks for describing the invention clearly and unambiguously.

b. Structure definition [4591], including the components with the interconnections and/or interrelations between them, using mathematic terms. The components are described using the standard vocabulary of step (a). Thus, an invention description will define a specific structure.

The above structure definition may be used to evaluate the Novelty issue in Patent Law, providing a scientific, quantitative answer to the question whether two structures are identical, or if similar—to what degree.

c. Description of the use, function, application or benefit of the above structure/embodiment [4592]. This is an important inventive aspect, since a known structure may be used in a novel, unexpected application. An invention has to have Utility, some useful function. A new structure which does not have a specific function and use is not an invention. The use also identifies the profession of a person knowledgeable in the art for the Non-obviousness test. The result is the Invention formula™.

The mathematical structure may also indicate how it works, how the components of the disclosed structure interreact to provide the above use/function.

A sound technical basis should be presented by the inventor—the working model required in the past was not a bad idea, after all: It is only too easy to put words to paper, even if there is no technical basis whatsoever for them; let them sweat it out, to prove it does not work!

If not a model, then references to technical literature where support for the technical claims can be found or a report of some practical tests made.

Preferably, the use is described using standard terms from step (a).

d. The advantage over prior art [4593]. An invention has to advance the state of the art in some way, to do it better, faster, more precise, in a structure which is smaller, bigger, sturdier, lighter, softer, etc. This may address the Non-obviousness issue, for a person knowledgeable in the art would have done it if there were a benefit in doing it, or: If it is Novel and there is an advantage—then it is Non-obvious.

An invention may be disclosed in a patent document (i.e. in the claims and description), a scientific document, a product description, etc.

Each such description may be rendered to a mathematical expression as detailed above, to be capable of being read and processed by computer. A computer can search millions of patents, scientific and other documents, and find very fast, whether there is a similar or identical structure, for the same/similar use and offering the same/similar advantages.

***End of Method***

Notes:

1. Patentics™ may use the above scientific description of inventions to define an invention during the inventor—patent attorney dialog, to search for similar inventions using automatic tools, for patent prosecution, patent infringement and patent interference proceedings, etc.

2. Important: Until now, sets of words with some Boolean logic were used to describe and invention, however it was a futile attempt. Even if several words were included in a document, they may not be functionally related. A reliable way to search prior art is to retrieve a large number of documents and to manually read and compare them.

The new method describes a structure in a precise, mathematic way.

3. A structure may refer to a system or a method.

4. Where known physical phenomena are mentioned, pointers to technical literature on the subject may be included, or an affidavit from a technical professional such as a professional engineer, may be attached, or a description of a feasibility study performed by the inventor.

5. The new description allows to compare a system structure with that of other systems, rather than comparing a set of words as in prior art. A set of words randomly found in a document is not indicative of a structure.

6. The method strives to unambiguously describe a structure in mathematical terms; it may be imperfect, so human review and intervention may be required. The method may be used as a support, rather than final decision, system.

7. It is preferable to describe inventions using standard terms, that is words accepted in the scientific discipline related to the invention. As a practical compromise, until such a standard vocabulary is developed, it may be assumed that the terms in the present invention are standard terms, and translate prior art/cited patents terms into these terms. This may facilitate faster assimilation of the new methods. Throughout the present disclosure and claims, where “standard terms” or “standard vocabulary” is mentioned, it should also refer to this option.

Method C9 for Developing a Standard Vocabulary

This method may be used to define and use standard terms in inventions.

a. Use standard terms. Every scientific discipline has standard terms, accepted and understood by scientists worldwide. In Patentics™ also, each term will be that used in the scientific discipline relevant to the invention, with a reference to an accepted document defining it. Preferably, the disclosure will include, for each component of the invention, a reference to literature with its technical description.

b. Use the standard terms to describe the invention. These terms are the building blocks for describing the invention clearly and unambiguously.

c. Eliminate ambiguous words and synonyms/antonyms; strive to achieve a one-to-one correspondence between real world things and words defining them. There are ambiguous terms in every language. For example, the words Mixer, file, disk, plane, seal, draw in English. In these cases, the words may be modified to indicate a specific meaning, for example:

Mixer.a for the electronic instrument for mixing audio signals

Mixer.b for the mixer truck used in the building industry

Mixer.c for the communications component used in frequency translation

Mixer.k for the mixer utensil in the kitchen

A standard vocabulary preferably includes only terms each having one specific meaning, and just one term for each meaning (no synonyms allowed).

For example, in computer programs, there may be several commands to achieve the same function. For example, in Assembly, the commands have the same meaning, to clear the register AX:

MOV AX, 0

AND AX, 0

SUB AX, AX

XOR AX, AX

MOV AX, ZERO

MUL ZERO

IMUL ZERO

A vocabulary for computer programs may identify functions having different names in different computer languages or as provided by different vendors.

d. Novel or non-standard terms may be defined using the above standard terms. For example, assuming a novel element is used, it can be defined unambiguously by the number of protons and neutrons in its nucleus.

e. A standard vocabulary may be developed gradually: Starting with each inventor or patent agent office, then adopted by the Patent Office of a country, then defined in an international system with one-to-one official translations into all the languages, for each of its terms.

f. If the various standard vocabularies are developed systematically and using accepted scientific terms, it is likely that there will be a one to one translation between their terms, and that automatic means (computers) can be used to translate from one into the other, to ultimately unite them all into a multi-language, global patenting vocabulary.

***End of Method***

Method C10—Structure Definition Method

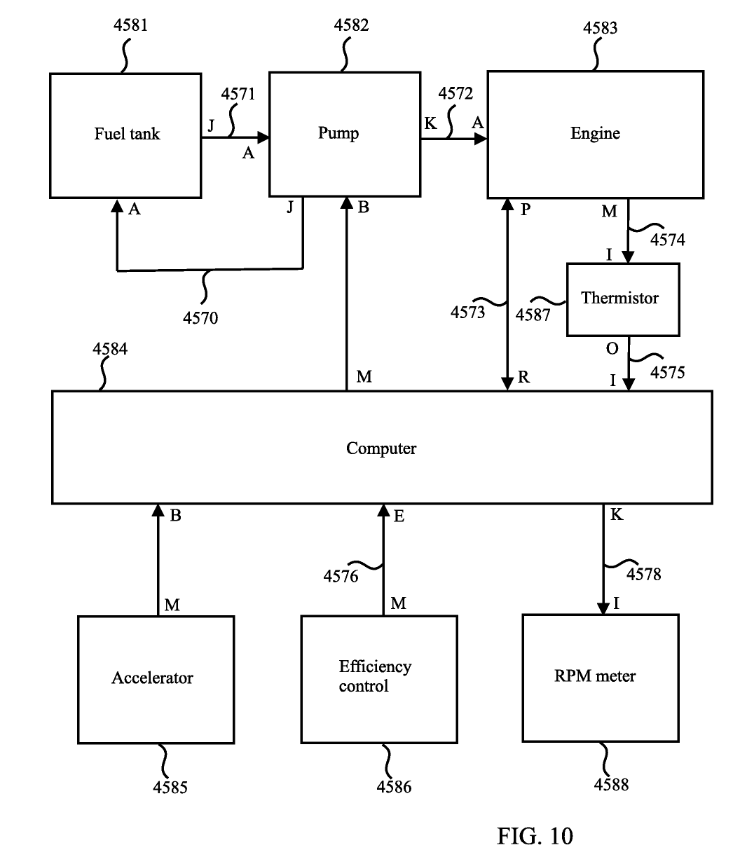

An invention detailed in a drawing or picture such as FIG. 10 is converted into a precise textual description. A Structure definition [4591] includes the components with the interconnections and/or interrelations between them, using mathematic terms:

a. The components of the invention are described using the standard vocabulary defined above. Where non-standard terms are used, a translation dictionary may be prepared, see for example step (c) in Method S1 for searching inventions.

b. For an invention described as a Block diagram, an interconnection list as illustrated with FIG. 10 and the related description may be used.

A table or a vector may be used to detail all the connections between the blocks.

A bi-dimensional description may include:

1) a list of interconnections between blocks.

2) the function and/or structure of each block. It may include a string of keywords, a concise description, a mathematic term describing a function or structure, etc. To search for this invention, the computer first searches the structure according to the list in (1), to find identical or similar structures. Next, the text in each block is compared with the relevant keywords. Fuzzy logic may be used, or cross-correlation computations, or weighed averages, to compute likeness or otherwise, of relevant inventions.

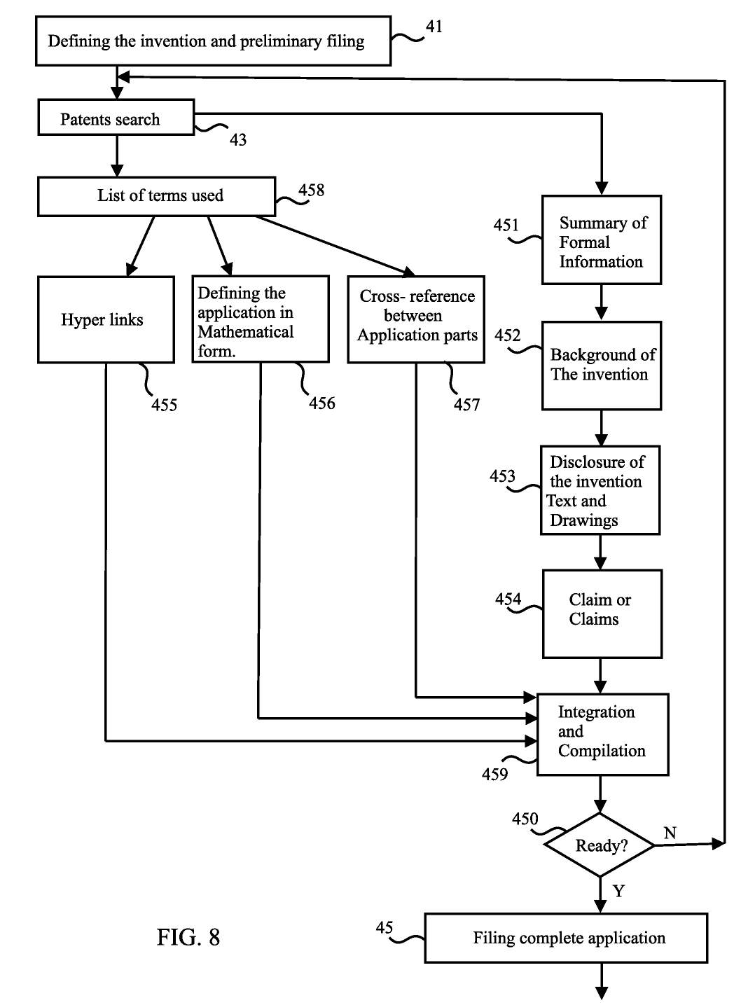

c. For a computer method disclosed as a Flow chart such as that in FIG. 8, an Interconnection list such as in step (b) above may be used. For example, an execution block may have an Entry port #1 and an Exit port #2; a decision diamond may have an Entry port #1, a Yes_Exit port #2 and a No_Exit port #3; then the structure or layout of a flow chart may be described as an interconnections list. The other dimension relates to the text or formulas or whatever is in each block of the flow chart.

Alternately, a tri-dimensional description may include:

1) a list of interconnections between blocks.

2) the type of each block, such as: Signals Input, Signals Output, Signal processing, Display to user, Input from user, Decision block, Start, End. Each block may have specific numbers or letters preassigned to each of its ports.

3) the specific function of each block. It may include a string of keywords, a concise description, a mathematic term describing a function or structure, etc.

d. The interrelations between the above blocks may be described using mathematic operators or standard terms, for example: Unidirectional signal path, Bidirectional signal path, Enable signal, Rotatably mounted on, Removably attached to, Synchronization channel, etc.

e. A computer program may be normalized to a functional operations list, to become in fact a method. Standard terms may be used and synonyms resolved, so that a listing will unambiguously refer to a method, to allow automatic comparison of computer programs using computers.

See for example Step (c) of “Method for developing a Standard vocabulary” above.

f. Where the structure comprises a novel shape, the shape may be brought to a standard, computer readable format using for example the “Arbitrary shape standard description method” below.

***End of Method***

Method C11—Arbitrary Shape Standard Description Method

An arbitrary shape may be described using a modified vector representation of that shape. In Vector representation, a drawing is described as comprising a set of geometric shapes such as lines, circles, circle arcs, etc. The standard description is so devised as to allow fast comparison between millions or billions of shapes using computers.

To bring a shape or drawing to a standard form:

a. Remove text and other details which are not relevant to the shape itself.

b. Scale it up or down so as to bring the shape to a standard size, for example for it to be contained within a circle of radius 10 cm. Store a first parameter indicating the magnification factor used.

c. Rotate the shape to a predefined orientation. For example, the standard circle containing the shape is divided into circular sectors; the number of black pixels in each is counted, and the “blackest” sector is identified. The shape is clockwise rotated so that the blackest sector is the lowest sector.

Store a second parameter indicating the rotation angle used.

d. Represent the above-processed shape in vector form, that is as a set of geometric shapes, for example: Line between (1,2) to (0,5), Circle of radius 3.3 center at (2,1) . . .

A computer can read this list of components and compare it with similar lists of other drawings in patents for example.

e. A tri-dimensional shape may be defined as three views, each defined as above, or using other methods. For example, a tri-dimensional wireline description may be used.

***End of Method***

Method G9 for Disclosing an Invention to the Patent Agent

a. The inventor describes a drawing by writing a connections list, as detailed for example with reference to FIG. 10.

The connection list completely and unambiguously defines the drawing. Thus, a precision description of a drawing may be entered.

The connection list may be entered as textual information in window 77 and using the textual tools window 73.

b. the system checks the list for consistency, correctness and completeness. Errors are presented to the inventor, who can correct them in an iterative, closed loop mode of operation with the system.

c. the inventor checks the final list and approves it. The list may become part of the description in the patent application.

d. during the above stages, the system may synthesize a drawing according to the connections list supplied by the inventor.

The drawing is then presented to the inventor, possibly in graphic form.

e. the inventor reviews the drawing and corrects it as necessary, preferably by correcting the connections list the drawing is based on.

Rationale: it may be easier for a person to write a connection list than to prepare a drawing; however, the same person may find it easier to verify a drawing (a visual presentation) rather than a textual list. Thus, by performing the tedious, labor-intensive tasks, the system frees the inventor to focus on the real important task—the full and correct description of the inventive concepts.

f. more drawings may be added using steps (a)-(e) above. The system may process the whole description to detect discrepancies among drawings, such as contradictions in defining terms or interconnections. Such problems are presented to the inventor and/or agent.

***End of Method***

According to another aspect of the present invention, a new patenting strategy is disclosed, with coordinated filing and search. The new method achieves both an earlier filing date to secure an international priority, and an improved patent application which takes into account the prior art. The strategy is compatible with the new method of cooperation with an agent as herein disclosed.

Translating an Invention Drawings to Textual Formulas

Pictures or drawings represent inventions. Several drawings may detail motion of the parts, thus the operation of a system. Drawings may detail a complex system as a hierarchy, with one global system structure and the others—details of its parts.

A precise method for converting pictures to text or text formulas in a mathematic, precisely defined form may facilitate patent drafting and prosecution, or searches.

Drawings are widely used to convey an idea or invention. A drawing can clearly present an invention, even a complicated invention, more than text.

Despite their importance, searches of invention drawings are not supported by present database/patents search systems. There is no system which accepts an invention description as presented in a drawing, and searches for similar drawings. Thus, a patents expert, when considering patentability or infringement issues, has to manually review a multitude of patents and applications.

There are prior art technologies for searching for a specific shape—Pattern Recognition methods, however these are not useful in this case, since the same invention may be drawn in different shapes, whereas different inventions may have similar shapes. The shape is not indicative of an invention.

This problem is inherent with block diagram or flow chart drawings—the blocks there, and the interconnecting links, may have various shapes in different patents, yet they may refer to the same functional structure.

The minute details of a topology may obscure the gist of the invention, the main points of the idea presented in that drawing. The computer may be led astray by the multitude of details, the forest cannot be seen for the trees. Decisions may be based on marginal or irrelevant factors, thus being practically useless.

Therefore, precise comparisons between drawings, using prior art methods, may be useless in comparing invention-related drawings.

For inventions, the text in the drawings may be important as well. Therefore, a drawings search should take into account the functional graphic structure and the text therein.

It is useless to search for several words in all the text of the drawings of one patent: maybe one word will be found in one drawing, another word in another and so on, with no functional relationship between the keywords.

There may arise various occasions where it is necessary to compare a patent (or patent application) drawing with other drawings:

Searching office's database: A patent attorney receives a new invention description from a prospective new customer, in the form of a drawing. She wants to check whether there was a similar drawing in another application drafted by that office.

Prior art analysis: A patents search revealed 100 possibly relevant patents. It may be very expensive or impractical to analyze in depth all of them. Narrowing the search may lose some relevant patents. If it were possible to compare the drawings to find the closest inventions, this can justify in-depth analysis of just 10-20 patents.

Comparing drawings manually may be difficult: Assume an application with 10 drawings, to be compared with 100 patents having 10 drawings each.

This amounts to 10,000 comparisons. Assuming 6 minutes per comparison, this may take 60,000 minutes or 1,000 hours—about 5 months.

Who can do that and remember the relative relevancy of each drawing? The inventor may need a professional's advice in interpreting the patents found, as these involve both technical and legal issues. What will be the cost for the patent agent's time?

A difficult problem in analyzing drawings is inventor's right to define his own terminology for a disclosure. This poses a most difficult dilemma: On the one hand, inventions are sometimes difficult to define in traditional terms, and precluding this inventor's prerogative may prevent the legitimate expression of new ideas; on the other hand, the inventor may lack knowledge of accepted scientific terms, may not be fluent in the English language, or may simply be mistaken.

Because of nonstandard terminology, drawings cannot be read at face value, but have to be interpreted in view of the disclosure. Every time a professional studies prior art, he/she has to read the disclosure to refresh his memory on each cited patent. This takes time, and slows down the analysis. Furthermore, patent searches using standard terms may not be effective.

Starting 25 Aug. 2006, the USPTO has established a new procedure for accelerated examination of patent applications, to complete examination within 12 months. To be eligible, an inventor has to file an application which is easier to examine, together with a prior art search and further documentation to distinguish the invention from the cited references. An analysis of cited documents is required: USPTO demands that the Accelerated examination support document detail how each of the claims are patentable over the cited references, indicating where each limitation of the claims is supported in the description, etc.

How to choose the most relevant patents, to include in the search report? The inventor faces a dilemma: On the one hand, a wide search has to be performed to find relevant prior art: “This preexamination search must be directed to the claimed invention and encompass all the features of the claims, giving the claims the broadest possible interpretation”. On the other hand, USPTO disapproves of submitting too many cited documents: “marginally relevant information was submitted with the intent to obscure material information, this may run afoul of the duty of candor and good faith . . . ”

How, then, is one to analyze many documents and select the most relevant, where this selection has to withstand the scrutiny of the USPTO and possibly also courts of law? How to define or measure relevancy?

This aspect of the invention relates to a system and method for storing and processing information in invention-related drawings.

This aspect of the invention has three main parts:

A. Method for describing an invention drawing, for example a block diagram or a flow chart.

The method uses an Invention Formula™—a concise description of an invention in textual format, which can also be read by computer.

B. Processing of drawings information, and display of the results.

C. Data entry of drawings information. Data Base update.

Benefits:

1. Using the new method for inventions description, fast searches may be done by computer on huge amounts of data, for patentability or infringement purposes.

2. Complex, large documents or a multitude of documents may be reliably processed to reach a decision regarding patentability or infringement (using different algorithms in each case), and the relevancy of each document can be objectively measured. “Objective” here may be a goal to strive to rather than a scientific fact, preferably an expert should review and verify it, still higher performance at a lower cost may be achieved.

3. Searching for prior art inventions, rather than searching for a string of keywords. A new invention is presented in mathematic terms using a standard vocabulary. Prior art inventions are also presented in a novel form, further including the step of translating non-standard words used there into a standard vocabulary. The new invention can then be compared by computer with a multitude of prior art inventions.

4. Sharing the results of analyzing patents, to improve the effectiveness of a team of Patent Examiners or Patent Attorneys.

Each of these patent experts can use the results of other's analysis.

5. The process is traceable and verifiable—where necessary, all the steps in analyzing a patent or comparing several patents can be reconstructed, for example during an appeal.

6. Patent experts can use the help of others for specific parts/steps of the analysis, as the need be: Linguists, Scientists, Lawyers, etc. They all communicate using unambiguous, standard language and terms.

7. Higher quality of inventions processing, combining an expert's understanding of the invention with the power of computer processing. Invention descriptions may be found in patents and patent applications, scientific documents, new product literature, etc.

Using the new invention definition allows to automatically search for, and compare, inventions across a multitude of prior art data.

The method allows an invention to be clearly distinguished from prior art.

InventionFormula™—a description of an invention as a mathematic statement using a standard vocabulary, comprising:

a) a list of its components;

b) the interconnections and/or interrelations between the components;

c) the uses, functions and/or benefits of the invention.

Notes:

1. The components may include, for example, the blocks of a system, the stages of a method or the operations of a computer program.

2. The Invention formula™ may describe an invention as found in text, drawings, pictures, computer programs, video clips, multimedia, etc.

The description generally relates to a system and method for storing and processing information relating to drawings of inventions.

A drawing is treated as conveying an invention, an idea, rather than just an arbitrary shape.

The invention will now be detailed with reference to the following main inventive subjects:

A. Description of an Invention Drawing

1. Invention description using an InventionFormula™—a concise description of an invention in textual format, which can also be read by computer.

2. bi-dimensional description of an invention: both the structure of the drawing (its layout) and the text there.

3. Enhanced description: also include the function/benefits as detailed in the text, and the advantage over prior art.

4. Describe the gist of the invention, its main aspects rather than all minute details. Alternately, a complete description is provided, but also including info indicating the relative importance of each of the components.

5. drawing (layout) aspects:

functional network topology, layout, shape paths description: forward (in to out), feedback, parallel
Note: forward path is in a general direction from input toward output; feedback path is in a general direction from output toward input.

blocks characteristics: number of terminals, in/out, single line/multi/bus interconnections: hard wired or wireless

in/out: hard wired connection or wireless; antenna, sensor or other interface means

6. structured text (text words or blocks of words, as in drawings)

7. use a standard vocabulary, translation of non-standard terms if required

8. weights, relative importance of the above in the invention description

B. Processing of Drawings Information, and Display

9. method for comparing drawings relating to inventions search structured text—text words all in one drawing compare, search main features, more important features parameters to search—adapted to each invention and its peculiarities weights to various parts.—different for each invention

10. display common areas, pinpoint areas of difference.

11. Allow for a manual final decision—an operator/expert in patent law

C. Data Entry of Drawings Information. Data Base Update.

12. data entry, drawings-related info entry into the computer

13. extract distinguishing features, gist of the invention

14. compare with text of disclosure. Text is converted to a standard vocabulary.

The invention is detailed, by way of example, relating to functional invention drawings such as a flow chart (for a method) or a block diagram (for a system) but can be adapted to other types of drawings.

According to one aspect of the invention, a bi-dimensional description of an invention refers to both the structure of the drawing (its layout) and the text there. The invention is described in a concise textual format “Invention formula™” which can be also read by computer.

According to another aspect, a method for comparing drawings relating to inventions is disclosed.

The method refers to features of both the layout/structure and the text. It takes into account the location of the text in the drawings. For example, the blocks of text searched should be in one drawing, or in a specific part of the drawing. The method is suitable to be performed by computer.

Invention Description Method R1

The method includes:

1. Invention description using an Invention formula™—a concise description of an invention in textual format, which can also be read by computer for automatic processing.

At present, there is no scientific tool to describe inventions. Inventions may be understood intuitively and are described as tales, or stories. How effective is this approach in comparing a 1,000 pages patent with twenty other, cited documents, just as voluminous and verbose?

This reminds one of the arithmetic problems in primary school such as “A first car starts from A to B at a speed of 60 mph; after 3.5 hours, a second car starts from B to A, at a speed of . . . ”. Such problems required a lot of ingenuity to solve, until we learned a bit of algebra, then it was simple, just routine.

Patentics™ is a new method which borrows from the methodology of physics and mathematics to describe inventions in a precise and concise way.

When the invention is scientifically described, it can be processed by computer, to search and compare millions of inventions per second.

Each of the above variables is defined using standard terms with mathematical terms defining the interconnections between the terms.

2. Bi-dimensional description of an invention drawing: both the structure of the drawing (its layout) and the text there.

A bi-dimensional description of an invention refers to both the structure of the drawing (its layout) and the text there. The invention is described in a concise textual format “Invention formula™” which can be also read by computer.

Characteristic features of each drawing relating to inventions are entered into a database. This is a bi-dimensional description, relating to the layout of the drawing and the text there.

Examples of such characteristics are detailed in the present disclosure.

The invention is detailed, by way of example, relating to a functional drawing such as a flow chart (for a method) or a block diagram (for a system) but can be adapted to other types of drawings.

3. Enhanced description of the drawing: it also includes function/benefits as detailed in the text, and the advantage over prior art.

An invention is defined or described as a three-dimensional vector comprising the variables of Structure description, Use/application and Advantages over prior art.

This definition complies with Patent Law regarding Novelty, Utility and Non-obviousness, respectively.

4. Describe the gist of the invention, its main aspects rather than all minute details. Alternately, a complete description is provided, but also including info indicating the relative importance of each of the components.

The invention description strives to convey the gist of the invention, rather than the precise form and contents of each drawing. A comparison is performed for the main features of the invention.

***End of Method***

Invention Description Method R2

A bi-dimensional description may include:

1) a list of interconnections between blocks.

2) the function and/or structure of each block. It may include a string of keywords, a concise description, a mathematic term describing a function or structure, etc.

To search for this invention, the computer first searches the structure according to the list in (1), to find identical or similar structures. Next, the text in each block is compared with the relevant keywords.

***End of Method***

Invention Description Method R3

A tri-dimensional description may include:

1) a list of interconnections between blocks.

2) the type of each block, such as: Signals Input, Signals Output, Signal processing, Display to user, Input from user, Decision block, Start, End.

3) the specific function of each block. It may include a string of keywords, a concise description, a mathematic term describing a function or structure, etc.

***End of Method***

Drawing (Layout) Description Method R4

For an invention described as a Block diagram, an interconnection list may be used. A table or a vector may be used to detail all the connections between the blocks, for example “B1.k B7.h” indicating terminal k of block B1 is connected to terminal h of block B, etc. This may not be the preferred method, as it may include irrelevant info which may be difficult to encode and decode.

Preferably, the Drawing (layout) aspect of the “Invention description method” includes part or all of the following:

1. functional network topology, layout, shape number of in blocks, out blocks, i/o blocks number of forward paths number of feedback paths, number of blocks with 1 terminal, 2, 3, . . . number of blocks in each forward path and feedback path

2. paths description: forward (in to out), feedback, parallel

3. blocks characteristics: number of terminals, in/out, single line/multi/bus importance/relevance to invention: essential, important, optional location: can be moved or not

function: detailed therein, or is a known component having a known function text added? or separate, as vector, matrix

4. interconnections: hard wired or wireless type of wire: metal, fiber optics

wireless: RF, IR, UV, visible light, US, subsonic, sonic, weak/strong force, electrostatic field, magnetic field, gravitation field

5. text added to interconnections

6. in/out: hard wired connection or wireless; antenna, sensor or other interface means; one line/multiple lines/bus; text added

***End of Method***

Drawing (Layout) Description Method R5

1. The interrelations between the above blocks may be described using mathematic operators or standard terms, for example: Unidirectional signal path, Bidirectional signal path, Enable signal, Rotatably mounted on, Removably attached to, Synchronization channel, etc.

2. A computer program may be normalized to a functional operations list, to become in fact a method. Standard terms may be used and synonyms resolved, so that a listing will unambiguously refer to a method, to allow automatic comparison of computer programs using computers.

***End of Method***

Drawing (Layout) Description Method R6

The method refers to improved drawings for a method.

A method may be precisely defined in a way similar to that in FIG. 10. There are standard symbols in computer science, used in programs flowcharts for example: Terminal, Processing, Decision, Connector, Input/Output, Manual input, Printer, Storage.

Each type may be filled with specific terms detailing the process, decision, etc. The above elements are connected by lines indicating the direction of flow.

***End of Method***

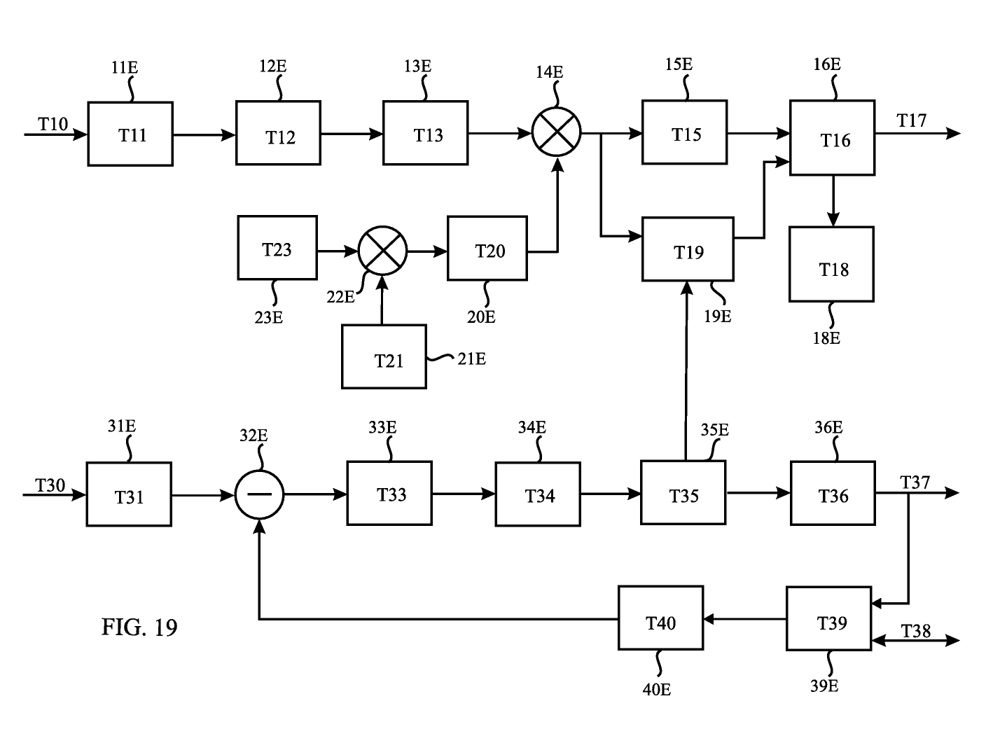

For example, referring to FIG. 19 which illustrates a block diagram describing a system invention:

input signal-related text T10, T30

output signal-related text T17

input/output signal-related text T37,T38 (bi-directional pins)

forward path includes components 11E, 12E, 13E, 14E, 15E, 16E

another forward path includes components 11E, 12E, 13E, 14E, 19E, 16E

yet another forward path includes components 31E, 32E, 33E, 34E, 35E, 36E

yet another forward path includes components 23E, 22E, 20E, 14E, 15E, 16E

a feedback path includes components 39E, 40E, 32E

one-input blocks include components 18E

one-output blocks include components 21E

two-terminal blocks include 11E, 12E, 13E . . .

three-terminal blocks include 22E, 14E, 19E, 39E . . .

four-terminal blocks include 16E

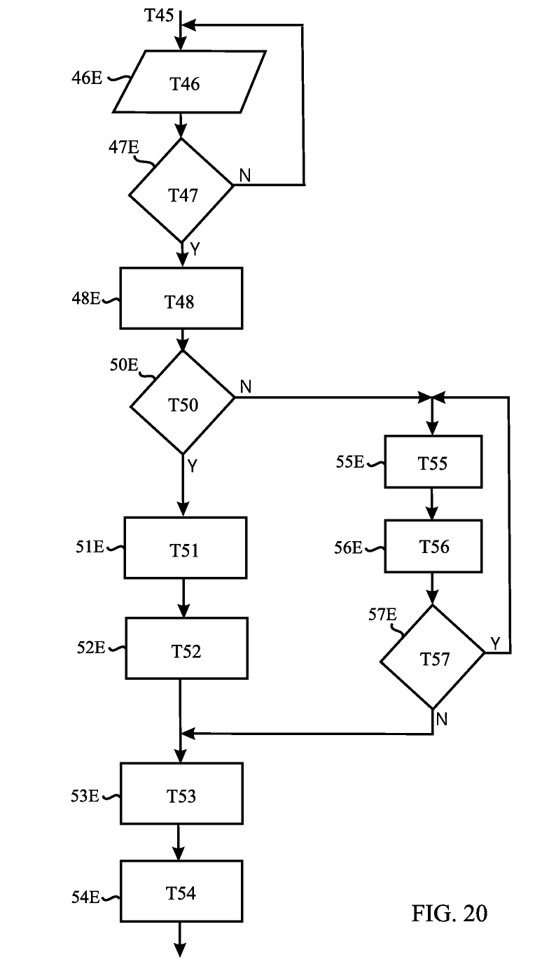

FIG. 20 illustrates a flow chart describing a method invention, wherein: forward path includes components 46E, 47E, 48E, 50E, 51E, 52E, 53E, 54E another forward path includes components 46E, 47E, 48E, 50E, 55E, 56E, 57E, 53E, 54E

human-machine interface block 46E

decision blocks 47E, 50E, 57E

processing blocks 48E, 51E, 52E, 53E . . .

Structured Text Description Method R7

The Structured text aspect of the “Invention description method” includes part or all of the following:

1. alphanumeric or formula or empty. For each single word or words group in each location: type for each figure, location in that figure. Searchable.

2. Structured text: The text in the drawing is entered as related to the layout of the drawing, that is the text also includes info related to the location in the drawing of various blocks of text, for each drawing.

3. use a standard vocabulary. Translation of non-standard terms if required. The components of the invention are described using the standard vocabulary defined above. Where non-standard terms are used, a translation dictionary may be prepared, ie “Method for developing a Standard vocabulary”.

***End of Method***

Method R8 for Developing a Standard Vocabulary

This method may be used to define and use standard terms in inventions. It is important if inventions are to be compared—if different patents use different terms, a comparison is useless.

1. Use standard terms. Every scientific discipline has standard terms, accepted and understood by scientists worldwide. In Patentics™ also, each term will be that used in the scientific discipline relevant to the invention, with a reference to an accepted document defining it. Preferably, the disclosure will include, for each component of the invention, a reference to literature with its technical description.

2. Use the standard terms to describe the invention. These terms are the building blocks for describing the invention clearly and unambiguously.

3. Eliminate ambiguous words and synonyms/antonyms; strive to achieve a one-to-one correspondence between real world things and words defining them. There are ambiguous terms in every language. For example, the words Mixer, file, disk, plane, seal, draw in English. In these cases, the words may be modified to indicate a specific meaning, for example:

Mixer.a for the electronic instrument for mixing audio signals

Mixer.b for the mixer truck used in the building industry

Mixer.c for the communications component used in frequency translation

Mixer.k for the mixer utensil in the kitchen

A standard vocabulary preferably includes only terms each having one specific meaning, and just one term for each meaning (no synonyms allowed).

For example, in computer programs, there may be several commands to achieve the same function. For example, in Assembly, the following commands have the same meaning, to clear the register AX:

MOV AX, 0

AND AX, 0

SUB AX, AX

XOR AX, AX

MOV AX, ZERO

MUL ZERO

IMUL ZERO

A vocabulary for computer programs may identify functions having different names in different computer languages or as provided by different vendors.

4. Novel or non-standard terms may be defined using the above standard terms. For example, assuming a novel element is used, it can be defined unambiguously by the number of protons and neutrons in its nucleus.

5. A standard vocabulary may be developed gradually: Starting with each inventor or patent agent office, then adopted by the Patent Office of a country, then defined in an international system with one-to-one official translations into all the languages, for each of its terms.

6. If the various standard vocabularies are developed systematically and using accepted scientific terms, it is likely that there will be a one to one translation between their terms, and that automatic means (computers) can be used to translate from one into the other, to ultimately unite them all into a multi-language, global patenting vocabulary.

***End of Method***

Method R9 for Indicating the Relative Importance of Invention Aspects

a. Various aspects of the invention may be stressed (given more relative weight) to adapt the search to the particular features of each invention. Thus, in addition to the layout and structured text description, an invention description also includes a set of numbers, indicating the relative weight of each part of the description, that is the relative importance of each part in that invention or inventive concept.

b. According to the invention in case, the layout or the text may be more important, for example, or the specific sequence of operations, or a special feedback using a new component, etc.

Relative importance weights may be assigned at a higher level (to layout vs the text, etc.) or at a lower level—to the specific layout of a drawing or a part thereof, a specific path and the text (technical terms) there, etc. In a claim, each component or step may be assigned a priority, to indicate the importance of various parts of the claim.

c. The relative importance or weight may be indicated as a real/fractional number indicating the weight to attach to a match of that component (for example a number between 0.00 and 1.00), or as an integer indicating the relative importance of each part: number 1 indicates top priority, parts which must be present in a minimal representation of the invention; number 2 indicates parts to be added for a next level embodiment, etc.

d. The weights, relative importance of the above in the invention description preferably comprise a distinguishable part of the description.

During an inventions search, this part may be taken into account or not, as desired by the person performing the search.

This may facilitate searches each having a different set of parameters or priorities or weights. Thus, during a search:

A. the original priorities or weights are taken into account to define the invention, or

B. the above values are overridden with other parameters, or

C. a search is made for the priorities/weights themselves.

***End of Method***

Multipriority Claim Method U8

a. One claim in a patent application may include a plurality of claims, all in one concise representation. For example, an independent claim and a plurality of claims depending from it may be described in a precise, concise form. This may prevent verbose claim systems which may obfuscate the actual issues which may be present there.

b. Each component of the claim is assigned a relative priority number. This is an integer indicating the relative importance of that component:

number 1 indicates top priority, parts which must be present in a minimal representation of the invention, that is the components of the first, independent claim;

number 2 indicates parts to be added for a dependent claim from the first;

number 3 indicates parts to be added for a dependent claim from the second, etc.

### Example 1

Five components with the designation [2] indicate five claims depending on the first claim, each dependent claim including the independent claim and one of the components designated with [2].

### Example 2

Two components with the designation [3] indicate two claims each depending on one of the dependent claims with designation [2], each dependent claim here including the independent claim, one of the possibilities indicated [2] and one of the components designated with [3].

In the case of Example 1 and 2 together, there will be 5+5*2=15 dependent claims.

c. A bi-dimensional claims structure where there are groups of components to be added together for dependent claims:

One dependent claim is formed from the independent claim and all the components marked with [2A];

Another dependent claim is formed from the independent claim and all the components marked with [2B], etc.

A next level dependent claim, where components may only be added to the group of [. . . A], may be so indicated with [3A], etc.

d. Thus, one textual structure may define and describe a plurality of claims in a precise and concise way. Either a one-dimensional or a two-dimensional structure may be described, as need be.

A bi-dimensional claims structure may be indicated with numbers and letters.

***End of Method***

Drawings Comparison Method P2

a. A method for comparing drawings relating to inventions is disclosed. The method refers to features of both the layout/structure and the text. It takes into account the location of the text in the drawings. For example, the blocks of text searched should be in one drawing, or in a specific part of the drawing.

The method is suitable to be performed by computer.

b. Compare using various parameters—various aspects of a drawings may be given more weight versus others, as the spirit of the invention dictates.

For example, in one invention it is important there is a feedback path; in another, a feedback with a block with text “counter” therein. In another invention, it has to have two feedback paths. In each case, one will want to compare with similar drawings.

c. In another case—a system with 3 inputs and 4 input/output channels

d. In one—most important is the layout of the flow chart, in another—more important is the sequence, the text in the various blocks

Thus: in the same DataBase, including the same drawings, various searches may be performed, each with different parameters.

***End of Method***

Structured Text Comparison Method P3

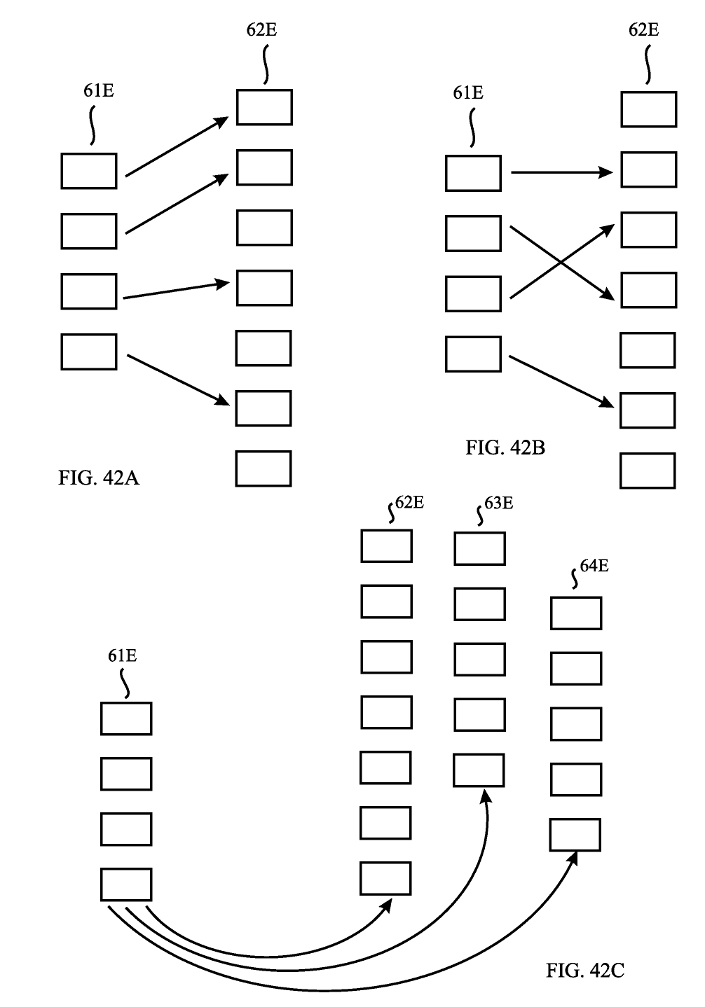

FIGS. 42A, 42B and 42C illustrate methods for comparing structured text in drawings.

FIG. 42A: text groups in consecutive blocks of a path 61E are compared, in the same order of execution, with text groups in a path 62E belonging to another drawing. The comparison may allow for matches in non-adjacent blocks, as illustrated.

FIG. 42B: text groups in consecutive blocks of a path 61E are compared, maybe not in the same order of execution, with text groups in a path 62E belonging to another drawing. The comparison may allow for matches in non-adjacent blocks, and/or not in the same order, as illustrated.

FIG. 42C: text groups in consecutive blocks of a path 61 are compared with several paths 62E, 63E, 64E . . . in another drawing.

For each of the paths 62E . . . , the methods of FIGS. 42A or 42B may be used.

***End of Method***

Structured Text Comparison Method P4

Using for example the methods as illustrated with FIGS. 42A, 42B and 42C, structured text may be compared:

1. Define structured text to search. This may include a plurality of words and/or words groups, and their relation to the drawing. The relation may include for example:

a. these words are to be searched in a forward path

b. these words are to be searched in a feedback path

c. these words are to be searched in input signals

d. these words are to be searched in output signals

2. Define what is the relationship between the words/words groups, and the search strategy used, for example one of FIGS. 42A, 42B and 42C.

What is the tolerance to individual differences/mismatches in deciding whether the drawings to match or not.

3. Define Relative importance or weights of the various words/words groups.

4. Perform the search as per the above inputs. The comparison is performed with one drawing at a time (the terms searched cannot be divided among two or more drawings).

5. Perform the search as per the above inputs, in several drawings at once, if the drawings are hierarchically related—that is, one or more drawings present details of a first drawing.

That is, several drawings may be searched simultaneously and part of the terms may be permitted in each, when functionally the several drawings represent just one drawing.

***End of Method***

Drawings Comparison Method P5

A method for comparing drawings relating to inventions includes:

1. search structured text—text words all in one drawing, or in a specific part of the drawing

2. compare, search main features, more important features

3. compare same type items: in with in, out to out, signal processing to same

4. tries to find a match by ignoring, replacing words or connections—within the allowed parameters of the search. Then displays the processing which was performed to achieve the match

5. parameters to search—adapted to each invention and its peculiarities

6. weights to various parts of drawings or text—different for each invention

***End of Method***

Method P6 for Searching Inventions

a. Define the invention, ie by using the abovedetailed “Method for defining inventions” and the terms therein. The definition may include:

1) Prepare a list of standard terms in use, that is the list of relevant terms for describing the invention.

2) Structure (layout) description, including the components and the interconnections between them.

The components are described using a standard vocabulary.

3) Description of the use, application or benefit of the above structure/embodiment.

4) The advantage over prior art. An invention has to advance the state of the art in some way, to do it better, faster, more precise, in a structure which is smaller, bigger, sturdier, lighter, softer, etc.

5) the relative weight (or importance) of the various aspects of the invention or drawing relating to the invention.

An invention is defined as a three-dimensional vector comprising the variables of Structure description, Use/application and Advantages over prior art. This definition answers the requirements of Patent Law regarding Novelty, Utility and Non-obviousness, respectively.

Each of the above variables is defined using standard terms with mathematical terms defining the interconnections between the terms.

b. Perform a search of prior art databases, using prior art methods: keywords with Boolean relations between them, class/subclass, inventor, applicant, etc. Other methods may also be used to find documents which disclose possibly related prior art.

c. Manually review each drawing found and, if possibly relevant, compile for it an invention definition (for one or more inventions therein) using the tools in step (a) above.

An invention is defined as a three-dimensional vector comprising the variables of Structure description, Use/application and Advantages over prior art. This definition answers the requirements of Patent Law regarding Novelty, Utility and Non-obviousness, respectively.

If the drawing uses non-standard terms, compile a translation dictionary (a cross-reference between terms used there and the standard terms), and define the invention(s) in standard terms as per step (a).

For the non-standard terms, preferably prepare the following files:

1) a glossary of terms, describing them in term of standard terms

2) a dictionary to translate from non-standard to standard terms

3) a dictionary to translate from standard to non-standard terms

4) a table indicating where, in the cited document, are the non-standard terms defined and used.

d. Compare the present invention as detailed in step (a), with each of the corresponding vector components as defined in (c). The comparison can be done automatically by computer, since the equations or mathematic terms or text strings prepared above are machine readable. The search may find identical or similar inventions. If similar, the degree of similarity (overlap in identical features) is precisely measured.

e. Using the mathematic/vector representation, absolute distances between inventions can be computed. These may be used for indicating Novelty or Non-obviousness in an objective manner.

The distances may include all, or each of the three components of an invention vector, and the specific elements of each component (specific to each invention).

“Distance”—as defined in mathematics for multi-dimensional spaces.

Optional: use numerical weights to set different priorities to each of the components of an invention. Some may be more important than the others.

Optionally, a priority assigned to each element may be used, and taken into consideration as an additional factor or numerical weight.

f. Comparing distances between allowed applications and cited references in prior cases may set a precedent for the present search—a scientific, objective criterion for what is different and what is not, with respect to prior art. That is, prior decisions at the Patent Office may be measured mathematically to set a precedent or threshold, regarding what is considered a large enough difference/distance to be eligible to a patent. A different threshold may be used in each class and subclass.

g. Comparing distances between cited references, maybe with a higher weight for Use/benefit and Advantage, may indicate to what degree it is advisable and fair to combine references against a new invention.

h. display the results to user.

i. where relevant, repeat the process for several inventions there.

Where relevant, use a bi-dimensional description.

***End of Method***

Notes

1. The method may be used to search for system or method inventions.

2. A system or method may have a bi-dimensional description, as detailed elsewhere in the present disclosure: one dimension for the interconnections between blocks, the other for the component/function/method step in each block.

3. The method may be used to measure conformity with UK IPO requirements for patentability. For example, step (a) of Defining the invention, corresponds to step (1) of the “four step approach”, that is “(2) Properly construe the claim;”.

Benefits:

1. Search for inventions, rather than meaningless strings of words.

2. Fast, automatic search replaces slow, tedious manual reading, understanding and opinion forming for each cited document.

3. The investment in coding prior art in Step (c) is worthwhile, since the results may be used by other examiners or patent agents, in other searches, or by the same person after a prolonged time period.

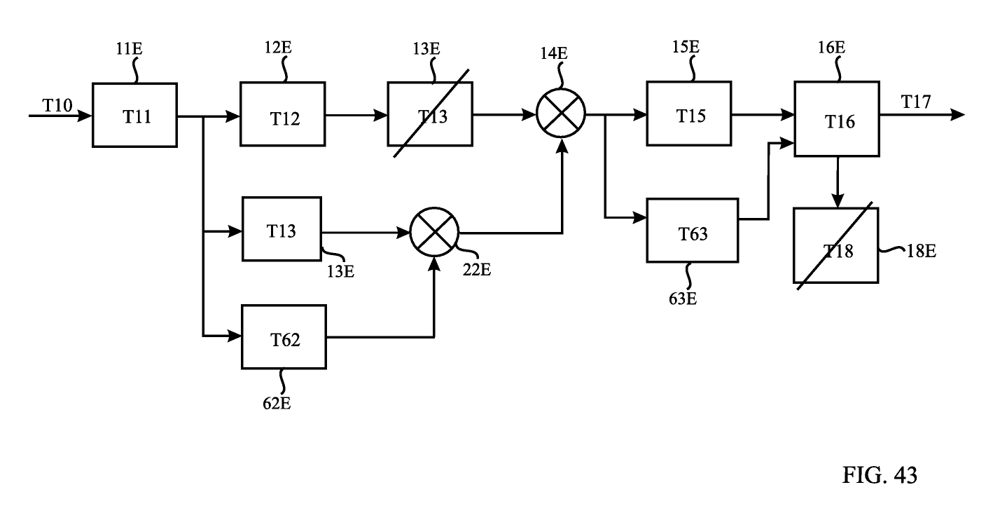

FIG. 43 illustrates an example of highlighting difference between two drawings crossed blocks 13E, 18E are missing in the second drawing difference blocks 62E, 63E (preferably in another color) indicate blocks in the second drawing which are missing in the first.

The final decision, as to the importance of these differences, is preferably made by a human, an examiner or a patent agent, who understands the invention.

Method P7 for Processing Drawings

a. Automatic: scan drawing, rotate to normal orientation pattern recognition of typical shapes: inputs, outputs; functions, blocks; or: in/out, processing, decision in flow chart pattern recognition of text in blocks

b. Manual: manual finish, ensure correct shapes, text, direction of flow, in or out . . .

c. extract distinguishing features, gist of it

Rendering/Defining the above understanding of the invention in a standard, mathematic form—the Invention formula™, which can be easily used by other such Experts, and is also computer readable, to allow automatic processing of inventions. Such a formula may include for example a connectivity list as detailed with FIG. 10. Store the results.

d. In one embodiment, the description is allowed to be ambiguous, it is not a complete and precise representation, but it gives the gist of the functional drawings so as to facilitate efficient comparison of drawings.

It recognizes the fact that absolute precision is irrelevant, since the human rendering of inventions into drawings is also not precise. In another embodiment, predefined rules are used to achieve as complete and precise representation as possible.

e. compare with text of the disclosure. Preferably, convert text to a standard vocabulary where necessary. Alternately, a local common vocabulary may be used, prepared to analyze just this patent/application or a group of similar patents. The vocabulary is used to translate relevant words and/or expressions in all cited references to the terms used in the examined patent or application. A common basis for text comparisons is required to perform meaningful comparisons.

f. display common areas, points of difference.

g. Allow for a human final decision—manual, an operator/expert in patent law.

***End of Method***

Method P8 for Data Entry of Drawings Information

The method enables to enter data of drawings information. A Data Base can thus be updated with drawings-related info entry into the computer:

1. automatic

2. automatic with manual review

3. manual finish

4. manual entry

***End of Method***

Method P9 for Extracting Distinguishing Features

A Method to extract distinguishing features, the gist of invention, includes:

1. a description of a drawing is compared automatically with drawings in other patents or patent applications.

2. Structured Text may be compared with corresponding text, taking into account the location of text in the drawing: for example text in forward path blocks, in feedback paths blocks, in input blocks, etc.

3. compare with text of disclosure. The text is converted to a standard vocabulary. Then scan, search text in description pertaining to structured text of each figure.

4. The various aspects of the invention are given relative weight as indicated in each invention or as defined during the search by the operator.

***End of Method***

Multidimensional Classification of Patent Applications

A method is provided for classifying a product or a manufacturing method; either in a patent application or in a registered patent. The method may be applied to new applications as well as to existing applications and patents. It may be implemented onto a photo or sketch provided by entrepreneur or inventor, and/or on a text document.

The method allows for more precise classification of inventions using multidimensional vectors whose elements include each a list of classes. Thus a mathematical representation of a class for an invention is achieved. In prior art, an invention may was not defined mathematically but only by text and drawings. There may be one or more classification numbers for defining the field of the invention.

This aspect of the invention pertains to Patentics™, supporting a quantization and mathematical expression of inventions.

Applying one or a few classification numbers may not define inventions efficiently. Furthermore, upon performing a prior art search, one cannot rely on classification definitions completely, since inventions may be considered belonging to other classifications as well.

The new method allows better definitions of products and patents, faster transfer to manufacturing, efficient comparing and searching mechanism, clearer definition of claims, easier adjustment and understating of the invention upon examination and better definition and uniqueness in an infinite vector space.

The method can be implemented for new inventions as well as for existing documents and products easily. This is a relatively low-cost investment, which will save enormous amounts of tedious human work.

The method may be advantageously used in a multi-language environment to adapt the scope of words to the exact meaning the inventor intended for them.

Multidimensional Classification Method G10

The method comprises:

1. Define the components (of a device) or stages (for a method). These definitions may be general. It may be possible to mention alternatives and it may also be possible that some stages or components may be used instead of just one other component.

Ideally, drawings or photos can be analyzed to derive main components and possibly their numbering or text can be gathered together with additional text or description, mainly for finding keywords and equivalent keywords for describing components and also for finding relations between components.

The gathered and concluded information can be ordered, for example a matrix or table can be formed:

Stage/Component/Feature—this may relate to a part in a photo/drawing, and/or for its textual description, such as in a patent document. This may relate to any kind of component of a device or a step of a manufacturing method. Also relations between parts and connections can be further treated as parts or functions of the invention. These will be referred to as “components”.

Components may be numbered such as: “1”, “2”, “3”. . . according to the purpose or function they are implementing, or by order of appearance in text and/or drawings; this may form a rather general description of a component.

A specification of the components, which explicitly defines elements or explicit examples for implementing these components, can be described by letters, such as: “A”, “B”, “C”.

Thus, in order to implement a described product, certain numbered components are required, wherein for each such component there may be one or more alternatives from the components that are described by letters.

Option—the purpose is to find and define ways for implementing the invention, using the numbered components.

There may be more than one option of using the components, such as “option 1”, “option 2”, etc.

If a numbered component is used, possible letters are mentioned for usable components in that option, as it may be likely that not all components may function in all options.

Component/
Stage/Feature

Option 1
Option 2
Option 3
Option 4
1
A
E
A or E or I
A
2
A
F
A or F
A
3
B
B
H
B
4
C
G
G
G
5
C
C
*
End
6
D
D
*
End
End
End
End

Thus, it is possible to implement the invention using A-B-C-D, E-F-B-G-C-D or for a partial implementation just A-B-G.

Asterisk (*) may indicate that a component is not required in an option, such as for implementing a simpler system having less features.

2. Each of the components described by letters, described herein as a symbol A-G, should be defined according to a known method. For example each can be described by a patent number/application number which implements that component, by a classification number, or by any other classifying method.

It is easier to define a classification for a certain component or step of an invention, since it is likely to perform a specific or a more narrow operation, rather than the whole invention method or product.

It can be possible to define more than one classification or number for each symbol.

Preferably, each symbol should comprise several classifications. It can be understood, for example, that a classification that is not mentioned, does not relate to that component. It may be also possible to define a novel component, which is not described elsewhere, in such a case it may also be agreed that the invention aims for using a novel component in that symbol, or maybe that symbol can be further defined.

In case a symbol is too complex, or involves additional components, then it can be further analyzed recursively, in a similar manner described herein. Thus, that symbol would be regarded as a whole invention (or sub-invention belonging to the main invention), and be further sub-divided to smaller components, each of which further described, etc.

3. Descriptive vectors can be formed, which define the invention mathematically. This will make it possible to perform a vectored search, for example to search for a device with an engine and a wheel, but more effectively. Since each symbol preferably includes all relevant (similar) classifications it may be easier to make a more specific search and yet have better results, this will be explained:

Since each invention is described with several classifications for each of its components—more descriptive information is available regarding the invention. Since each component is widely defined—it is easier to find it, even if a similar component is searched rather than the exact one.

Yet since several components are defined and searched for, the Boolean “and” requirements make a Vectored search, which yields a result that should be more accurate.

4. Definition and adjustment of the invention is more precise.

It is easier to define options and alternatives. It is also simple to change options, to limit them, or to give up on some. Options of one invention can be compared to options of another.

It will be more likely that the symbols of different inventions are similar or identical, since each of them mentions several classifications.

If each mentions different classifications—then they can be treated as different. When the patent application is examined, it is simpler to compare the invention to other applications or patents, and also to adjust the invention in order to have a patent.

Using this method it may become easier to compare the invention to foreign applications without translating them.

5. Invention and claims can be better defined:

The claims should be based on specific predefined symbols, rather than on any mentioned concept or a vague definition.

If a component is widely defined as belonging to many classifications—more search occurrences will appear. On the other hand narrower definition of the components may allow granting more patents, which can be adjacent or have common areas in a vectors space, and not infringe each other.

It may be more clear do define different options, and also to rely on must have components which form the product, which is safer for production and marketing as well—since it is better defined and provide a more specific definition of the invention and product.

6. Adjust existing databases

Existing patents and databases, preferably wherein the documents comprise text and drawings, may be adjusted using this new method to comprise additional vector definitions. This will help comparing them more efficiently with new applications and products. This method may be implemented for other product descriptions as well, for taking them into consideration as well.

It is possible to use the USPTO or the international classification for defining the components, as these classifications include most inventive aspects, they can also be related to components. It is possible to search for keywords in the classifications' databases, allowing to adjust the correct classifications to each component.

This can be implemented to foreign applications as well, since all is required is to translate the application's components to the correct classifications.

7. Faster transfer to production

The description by vectors allow to turn a sketch or a general planning into a working product, described and defined by its components—which allow implementing each component of the invention, designing it to be compatible with other components of that option and faster manufacturing since the component and possibly its characteristics are defined. This may help industry turning inventions into working products, and also using existing known patents or components for implementing the new product.

***End of Method***

The multidimensional classification relates to components, groups of components or subsystems and whole inventions (ie an invention as defined in a claim). A problem with prior art claims is that the scope of words

Multidimensional Classification Method G11

a. Assign a class number or a group of class numbers to significant parts of an invention. The parts may include elements (capacitor, lens, solenoid), groups of elements (i.e. a subsystem) or a whole invention (i.e. a patent application claim).

b. During examination or when required, eliminate part of the classes of some of the elements, to better distinguish from prior art, etc. A word may have many meanings, a part—many uses. The words of a language may not be ideally suited to define an invention. For example, diaphragm may be a medical device or part of a photo camera. Distinguish a box in a computer menu from a box for storing cabbage. Thus, by limiting the number of classes relevant for various elements, it is easier to distinguish from prior art using the same words.

c. In a multi-language environment, translate words so as to retain the same class or group of classes. A problem with translations is that each word may have several meanings, but these are different in each language. Expressed mathematically, if the meanings of a words in Language A are represented as points M1, M2, M3, M4. M5. M6, then in Language B the meanings may be M0, M1, M4, M8. Indeed, there is overlap in meaning M1—this is the intended meaning; but in the other meanings there may be totally different. There is partial overlap of the sub-sets. Attaching one class to the word in each language (or just a few relevant classes) allows to adapt the scope of words to the exact meaning the inventor intended for them.

Using the same classification number in both languages A and B, one desired meaning may be selected, i.e. M1 in both languages—i.e. barrel for a naval anchor—not a barrel for beer or in a revolver.

***End of Method***

Multidimensional Classification Method G12

a. Assign a class number or a group of class numbers to significant parts of an invention. The parts may include elements or words (capacitor, lens, solenoid) and/or groups of elements (i.e. a subsystem or part of a claim).

Thus, each word has one or more classes attached to it.

The invention may be a patent application claim or a concise definition of an invention, such as in Patentics™. The assignment may be done in stages:
1) initial assignment may be automatic—using a database for example, with all the classes for all the words in a language.
2) automatic algorithms may be used to automatically eliminate irrelevant classifications, i.e. using AI rules that specific combinations of words have a meaning in one industry or class, but not in another.
3) the inventor and/or agent may manually eliminate irrelevant classifications.

b. Compute an aggregate class, or a class for the whole invention thus formed.

For example, assuming a claim has four words A, B, D, C:

word A has classes n1, n2, n3, n4; word B has classes n2, n4, n7, n9;

word C has classes n1, n3, n8, n11; word D has classes n0, n6, n27, n39.

A sentence or claim with the words A, B, C, D will have the class according to the formula:

(n1 OR n2 OR n3 OR n4) AND (n2 OR n4 OR n7 OR n9) AND . . .

(n1 OR n3 OR n8 OR n11) AND (n0 OR n6 OR n27 OR n39).

c. The assignment of classes to words may be modified, to adapt to inventor's concept—what the inventor meant.

d. The result of the process of steps (a)-(c) is a mathematical definition of the invention according to Patentics™. The process may be easily performed using computers/automated tools. This will allow to more precisely define inventions and compare them. The importance of each word can be measured in narrowing or defining the class of the whole invention. This may be used to define novelty or a contribution in an excluded class, usable for Methods K1 or K2 for example.

e. When translating from one language to another, verify that the translated word has meaning in the same class as the original—this is the intended meaning; then

f. During examination or when required, eliminate part of the classes of some of the elements, to better distinguish from prior art, etc.

***End of Method***

Information Theory Aspects and Random Processes

According to information theory, more data allows a better decision. Since each application will be described by a vector or matrix of classifications, rather than just few general classification numbers—a better decision and search can be made, based on vectors comparing and vectors' distance.

An invention can be described as a Random Process, which may vary to an infinite number of possibilities and may also be modified with time. However, since classifications constantly update and eventually new inventions are based on existing components or products, then it is possible to describe the most of any new invention, using discrete classification values, bounding the invention within known limits of technological knowledge,

Thus, variance of a random process, which can describe an invention, or the evolving of inventions in a certain field, can be adjusted to n-dimensions area including the unknown variance.

For example, a computer should have a power supply and a CPU.

Yet, inventions which do not use one or more common components, which often used for inventions with similar classification vectors, and explicitly suggest novel alternatives, can be easily distinguished from prior art, wherein must-have components in prior art are no longer used.

A new Symbol can then be defined for that component, allowing a new possible value for that vector or matrix component.

It may be also possible to define new classifications as Boolean operations of existing classifications, again bounding even unknown technologies with the boundaries of existing ones.

For example a flying car category may comprise: vehicle transportation, aviation engine and wings, thus bounding the new technology with known aspects or classifications.

Patentability and Infringement Criteria

Fixed values can be defined, such as the number or percentage of symbols violated, in order for Infringement to occur. Also Patentability criteria can be formed, such as the number of new symbols, the type of symbols (such as from not related classifications), new benefits (which can also be described by classifications), etc.

This will allow a more productive approach for industry and a clear cut protection, with fixed definitions whether it is possible to operate, and to have a patent. Patentics™—The Science of Patenting

This is an overall approach, system and method for the present invention. Of course a scientific discipline is developed by many people, this may be just a beginning of something which may develop if found worthwile.

The patents protect technologies based on scientific basis—electronics, mathematics, communications, physics, optics, mechanics, etc. The patent structure and the processes relating to patenting should also have a scientific basis and methodology—this is Patentics™.

Characteristics of a scientific discipline (as found in the present novel approach):

a. Uses standard terms, for example, in optics—focus, diffraction, reflection, interference are terms recognized and interpreted precisely the same way by professionals in that field, worldwide these terms are unambiguous and translate unambiguously into other languages

b. Uses mathematics or concise, commonly accepted expressions to present precise relationships among the standard terms, for example F=ma in mechanics

c. Allows for objective measurements and provides quantitative results where possible

d. Allows cooperation and disemination of results among practitioners in the field, using a, b above.

Researchers can further advance the field building on other's work.

For example, when an astronomer discovers a new meteorite, she can communicate its findings using precise data such as coordinates in space, computed orbit and location in that orbit at a specific time, etc.—so other astronomers can easily find that meteorite as well.

When a chemist performs an experiment which results in an interesting new compound, the info can be precisely communicated to others (including for example the type and quantity of materials used, temperature and pressure in the process vs. time, etc.).

Then the same experiment can be precisely reproduced by chemists around the world, and with precisely the same results.

e. Adapted for automatic (computer) processing—for design, simulation, comparison, processing of results, etc.

Which scientific discipline is presently practiced using manual labor?

Application of the above principles to patenting, the new method Patentics™:

a. Use standard terms—Where the applicant used non-standard terms demand from him a translation into, or a definition based on, standard terms. Otherwise this is Incomplete disclosure, or—translate to standard terms “as best understood . . . ”.

As the situation demands, additional terms may be added to the collection of standard terms.

Where there is a definition of non-standard terms, use an expression comprising only standard terms to define the non-standard term.

Different Technology Centers may have each a different collection of standard terms.

b. Use mathematics or a concise expression to define an invention, using relationships among the standard terms. The specific form of the expression may differ according to the characteristics of the field of the invention. It can use a mathematical expression, a mathematical-like expression, a table, special characters specific to that field, etc.

For example, an invention may be presented as a vector in a multi-dimensional space, with each feature of the invention as one component (one dimension) of that vector. Features may include analog/digital implementation (two possibilities, a binary value), wireless type RF-IR-US, etc.

Prior art technologies can also be brought into that form, by translating the terms therein into standard terms and using concise expressions to describe the inventions there.

c. Objective measurements and quantitative results—For example, when presenting an invention as a vector in a multi-dimensional space, the distance between two vectors may be computed. This is a quantitative indice of the similarity between the inventions.

The presence or absence of a specific term can be measured (a binary quantitative value). Since only one term is used for each part (there are no synonyms in the standard terms collection) the measured value has a practical meaning and significance.

d. Allow cooperation and disemination of results among practitioners in the field—the definition of standard terms may be shared among examiners, patent attorneys, applicants; they all understand the invention definition, using a, b above.

One examiner, when reviewing prior art, can use the “translated” version of a patent rather than the original patent itself. That version, comprising concise expressions using standard terms, may have been prepared by the same examiner or another examiner, or submitted by an applicant for example.

e. Adapted for automatic (computer) processing—the standard terms and the standard, concise expressions can be read and processed by computer, for example to compare with other inventions. The results may include an indication of similarities and differences between them, or a quatitative indice of the measure of similarity between the patents. The examiner can then review only the closest prior art, and the most similar parts therein—a better use of examiner's time.

**End of Method**

2. Achieving a Quality Patent

a. A definition of the Quality Patent

A Quality Patent may be defined to answer three requirements:

1) For the applicant: To draft a patent application which clearly and completely defines the invention, having such a form and content as to confer a high chance of getting a patent approved, if external factors permit (i.e. if there is no similar prior art); that the patent granted protects the invention from infringement, and the patent stands a good chance against cancelation proceedings in court.

2) For the Patent Office and Courts: The application and the granted patent are so drafted as to allow efficient processing during examination and court proceedings. Not to force these Authorities to glean information which could be provided by the applicant; rather, to present the information in such a clear, precise and concise form so as not to waste time or cause misunderstandings. Also, for the application/patent to be an easy to use prior art item.

3) For the society at large: To allow others to use the invention when the patent expires, if there are no other IP protection means preventing this. The applicant is granted a temporary monopoly in return for disclosing the invention to the society, so others can use it (among other reasons).

A Quality Patent may use the above Scientific Definition of Inventions (1) and additional innovative features.

b. Drafting a Quality patent application

1) Method for drafting a Quality patent application using high tech tools and Patentics^{SM}. The new structure includes the parts required by law and an additional part, a computer file. The additional part helps to better define the inventive concepts and facilitate the examination. The electronic file is attached to regular application, with links to show support for the claims in the description and drawings, relations to benefits and prior art.

2) Method for drafting a Patent application as an electronic document, having a structure adapted to the requirements of Patent Law; also a suitable Text/Graphics Editor tool.

3) Electronic document attached to a patent document to better detail activities performed such as amendments, divisionals, translations, multiple applications, etc.

4) Fast (one week) patent filing method. Fast drafting and filing is achieved where required, although at the cost of possibly reduced performance in a controlled way. There is quality in achieving IP protection fast.

5) Drafting an application answering the requirements of patentability set by the relevant Patent Office.

In the USA, there are the requirements per

In UK, there is UKIPO's method referred to as the “four step approach” defined by UK IPO and approved by Jacob U in Aerotel/Macrossan. The novel methods in this invention can be used in a structured approach as required by the Patent Office.

Method for Drafting a Quality Patent Application

A new method uses the novel Scientific Definition of Inventions to describe the invention in an unambiguous and concise manner.

The various parts of the application are so devised and organized, to support the applicant's claim for patentability and to facilitate the examination.

The novel approach can also be used to improve the cited prior art, so as to level the field—all the documents being considered use the same standard terminology and concise description, thus are easy to compare—either manually or using automatic tools (computers).

The improved, “translated” prior art documents may be used by other examiners or applicants, to improve the efficiency of the proceedings.

Thus, a correcting mechanism is created and activated on the prior art patents: whereas until now the prior art problem only grew bigger and bigger, now there is also a correcting mechanism which brings prior art into a standard form and makes it capable of being processed automatically.

**End of Method**

Method CC18 for Drafting Claims

Goal: To define inventions more precisely and unambiguously. The contribution relates to two issues: Solving alternative language inherent in commonly used words in a language, and a new claims structure which is precise, concise and suitable for automatic processing.

1. We found there is ambivalence inherent in the English language, and indeed in any Language. A word may have several meanings. A patent claim containing one or more such words may render the claim ambiguous.

The patent system is now international, and should take into account patents in other languages such as Japanese, Chinese, Russian, German, Korean, etc. This is important in translations filed with new applications, and also in patent searches. It is difficult to preserve the precise meaning of words in a translation; some meanings may be lost, new meanings added.

Also problematic is the ruling that “applicants are their own lexicographers” per MPEP 2173.01. This goes as far as permitting “Terms used contrary to their ordinary meaning” per MPEP 2173.05(a)III.

From our experience, such license causes much unnecessary work to Examiners and Agents. Each time a claim is evaluated, it should be read together with the disclosure, to ascertain the meaning of the terms there.

How can a patent search be performed, when each patent uses different terminology? How can automatic tools be used?

The novel method:

A. Applicants should be required to use standard, accepted terms, preferably with reference to accepted standards, i.e. in English—Webster's or Collins. A scientific approach should be taken in patenting: in science, every term is precisely defined. All the scientists and engineers in a field, worldwide, recognize the meaning of such terms as voltage, permeability, mass, gravity.

Rationale:

a. USPTO has determined that only a reasonable number of cited prior art references should be filed; filing too many references is an attempt to obfuscate matters, to hide the actually relevant prior art. Similarly, it can be argued that using special rather than standard terms is an attempt to present an invention as special, when in truth it is not.

b. If the terms are not clear and exact, the applicant fails in his duty to disclose the invention. 35 U.S.C. 112 does not permit the applicant to invent new words, but requires that “The specification shall contain a written description . . . in such full, clear, concise and exact terms . . . ”.

c. Indeed, this is to break with the past, but Patent Offices are paying now a heavy price for this license; it may have helped inventors in the past, when there were not libraries available nor the Internet. It is not fit in the information age, and considering the multitude of prior art patents.

d. In the UK IPO new Test for Patentability, backed by the Court of Appeal, the first step is to properly construe the claim. Indeed, how can the invention be evaluated if the claim is unclear? And how can it be clear when the words' meaning is ambiguous?

B. For non-standard terms in evolving new technologies per MPEP 2173.05(a)II, the applicant should try to use terms from other patent applications, technical literature, etc.—and to show such attempts in the application. Each new term should be clearly and precisely defined using standard terms. Rationale: In the unlikely case that a new word has to be coined, the applicant can still look in a dictionary and use standard words to define it.

C. Each significant term in a claim should also be given a classification number. For example, “barrel” as a nautical term, to distinguish from its use in drinks or weapons. The assigned number accompanies each term during translation, so there are no meanings lost nor added. If necessary, a term may be assigned a plurality of numbers.

Rationale: The meaning(s) of each term can be precisely controlled, despite peculiarities in any specific language. The system is international.

D. Compliance with the above requirements should be checked at filing. If found lacking, the applicant should be required to file corrections. Rationale: Patent applications which are not true invention disclosures should be filtered out at an early stage, to save work and resources in filing, managing, searching, examination, correspondence, etc.

E. If the applicant claims there is no prior art: when reaching examination, the applicant should be required to correct the terms he uses, referring to the prior art found by the Examiner. To amend “the examiner . . . is encouraged to suggest alternatives that are free from objection” in MPEP 2173.05(a)II. Rationale: It is applicant's, not Examiner's, duty to clarify the invention. This will level the field to facilitate the examination using standard terms.

F. Applications which do not comply with the above requirements should not be published and should not be cited as prior art.

Rationale: Only actual invention disclosures are prior art. A scientific approach—Technical articles are also being reviewed prior to publication. Accumulating unclear prior art only adds Sisyphic work at the Patent Office.

G. USPTO may help inventors find the suitable terms in each field, providing for example a dictionary or a visual dictionary online—a worthy investment.

**End of Method**

Method CC19 for Drafting Claims

At present, patent claims are drafted in a storytelling approach, to tell a story in the author's own style, more concise or verbose as he may seem fit. No automatic means can be used to compare claims, only a human can read the sentences there and possibly understand their meaning.

The proposed solution:

A. An addition to the claim should be written in a concise, commonly accepted form, akin a mathematical formula or table. It can define the parts comprising a new system, and the interconnections between them.

Rationale:

a. Such a description may be easier to read—it separates the essential components from ancillary wordage.

b. Sentences may have different structures in various languages. Some changes in meaning may occur in the translation, even when each word in itself is translated correctly. A mathematic formula is understood worldwide.

c. The new method will allow automatic processing of claims, to compare a multitude of claims in a multitude of patents, very fast.

Quantitative results may be obtained, to indicate the measure of likeness, or difference, between different inventions.

B. The description itself may also contain such a concise description, in addition to the regular parts. This creates clear, precise, well defined links between the description and the claims.

C. A system drawings may be made to also contain such a concise description. For example, a block diagram may be described in mathematical form as a bi-dimensional table, one dimension detailing the topology and the other dimension—the text in the blocks there.

D. A method drawings may be made to also contain such a concise description. For example, a flowchart may be described in mathematical form as a bi-dimensional table, one dimension for the topology and one for the text.

**End of Method**

Benefits:

a. This is an attempt to overcome peculiarities in a language, relating to sentences building and understanding. Such sentences may be ambivalent or unclear. Claims may be verbose. The new concise claim form is international.

b. The new approach will pave the way to using automatic tools to aid in the substantive examination process, now performed manually. Automatic comparison of claims, description and drawings can be performed.

c. A concise expression can be used together with well-defined terms, to expedite the examination, reduce the backlog and achieve higher quality patents. Examiners can exchange results to prevent a duplication of efforts.

Method CC20 for Drafting the Claims

Experts say, and it is common practice, when drafting the claims:

1) to draft the claims as a story, each author in his personal style, a free text describing the components, structure, method steps, structure of matter, for the invention.

2) there is no reference to the specific text and drawings supporting each claim.

3) there is no indication how the claim complies with all the requirements for patentability. The examiner has to glean this information by reading, once or several times, all the patent application while studying the accompanying drawings.

4) sometimes the applicant defines his own vocabulary, giving unusual meaning to terms used, or even assigning to terms a contrary to usual meaning.

A novel claim structure—places all the info relevant to patentability of that claim, right in the claim itself.

The method uses the definition of the invention itself, or info related thereto, to draft the claim, see above—Invention definition.

Rationale:

it is applicant's duty to disclose info relevant to examination

the applicant has this info at his disposal

it is in applicant's interest to present the invention in a clear form to facilitate the examination.

**End of Method**

(8) Method for Drafting a Quality Patent Application

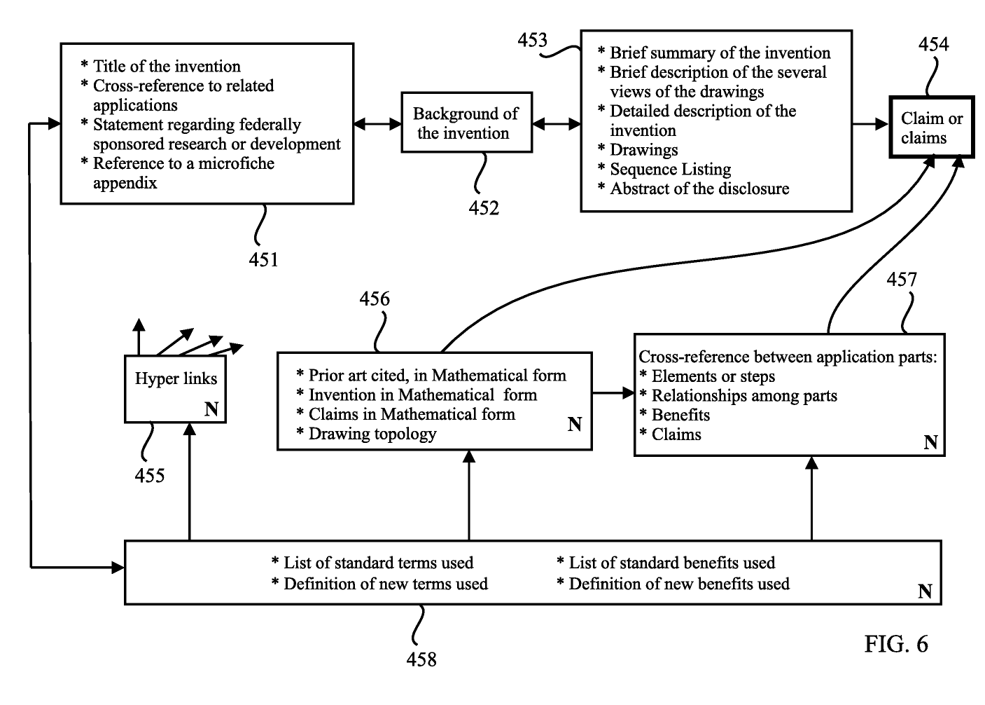

FIG. 6 details an embodiment of a novel Patent application system—the structure of the new patent application and the interrelation between its parts.

Note: Various mathematic means or terms may be used to describe relationships among parts of a system or method, etc. Whenever the term “Boolean logic” or “Boolean equation” is used, it is just an example; other mathematic means may be used instead, as will become apparent to persons skilled in the art upon reading the present disclosure.

Why add cross-references, mathematical tools, concise summaries and other help means in a patent application? The Reasons may include, among others:

1. These tools may help in the substantive patent examination and, if the application issues as patent—it is easier to use as a cited document. There is a proliferation of patents, with tens of millions to consider and the number growing fast. An efficient method to handle them is desirable.

2. Some patent applications are not professionally drafted—for example preliminary/provisional applications filed by the inventor. Comments, glossary and cross-references, etc. may be later added, to clarify matters, and as permitted by law. This will preserve the valuable invention in such applications, whilst facilitating their handling for various purposes.

3. Patents tend to be more complex nowadays, as inventions are complex and computers allow to draft voluminous applications. We have read patents featuring over 3,000 pages.

4. Science and technology have greatly advanced; large systems, sophisticated components and software and novel materials are part of everyday life. These and other factors contribute to the complexity of patents.

5. The world is more connected today. It is required to evaluate, use or object to patents/applications from other countries, which may be drafted according to different standards.

6. Patents and applications may undergo various transformations during their lifetime: amendments, combining of several filings, translations, etc. These may, or may not, introduce new matter and/or change filing dates.

It is required to monitor all these transformations in order to grant the owner all he/she/it deserves, but no more.

7. Patents are powerful IP instruments. Infringements may result in injunctions, large compensation amounts, etc. So much depends on patents. It may be desirable for all the parties involved, to make patents more clear, concise and precise in defining the invention and its claimed protection.

8. The technology to assist in the task is available now: Powerful, low cost computers with huge memories, simulation/emulation software packages, information science, artificial intelligence, communications/Internet, well defined terms in every scientific discipline.

These resources may be used as building blocks in the new system and method.

A unified standard representation of inventions may assist in evaluating patents and comparing them. It may use a precisely defined Vocabulary and concise, precise Mathematical Equations to define the interrelationships among terms in the Vocabulary and across the Background, Disclosure and Claims in the patent.

Today, much effort is wasted as many examiners, courts, patent attorneys and agents study the same patent, time and again. If such parties will contribute the results of their research to a common library/repository of analyzed patents, then a growing resource will be formed, to the benefit of all.

Alternately, a private repository according to the present invention may be developed by a company, to allow it a better insight in patents, to gain an advantage in patents protection and in infringement cases.

Computer means may be used to assist in evaluating and comparing patents, to pinpoint possible conflict areas for subsequent analysis by patent agents, examiners or inventors.

Method Q1—Quality Patent Application

A new patent application structure helps to better present the invention, as an improved vehicle for communication between inventor and patent attorney, communicating with the Examiner and/or patent agents in other countries, the courts of law, etc.

The new system structure (see FIG. 6) includes all the parts required by law (parts 451-454), and also additional parts (455-458) which, in various combinations thereof, may help achieve the added benefits.

The following may be generally used to achieve a quality application:

a. A multi-layer systematic approach and method, relating to the structure of the application and the method for drafting it, ie Method M1.

b. A new, hierarchical method for numbering the parts in the drawings, see for example Method 5 for Quality patent application—parts numbering.

c. Presenting the drawings in a precise form which can be reduced to a set of mathematical equations or terms. A computer can then “understand” the structure:
1) to verify its correctness
2) to simulate its operation and performance
3) to automatically compare it with other drawings in the present application/patent and/or with drawings in other patents and patent applications.
4) to correlate with inventive concepts in the text and with the claims.

See for example Method 4 for Quality patent application and FIG. 10.

See also “Structure definition method” and “Arbitrary shape standard description method” above.

d. A mathematical representation of each of the prior art, the inventive issues disclosed and the claims, using for example Boolean Logic. Other mathematical terms or means may be used. The result: an Invention formula™ for each such invention.

e. Cross-reference between the parts of the application, using mathematical and/or other tools.

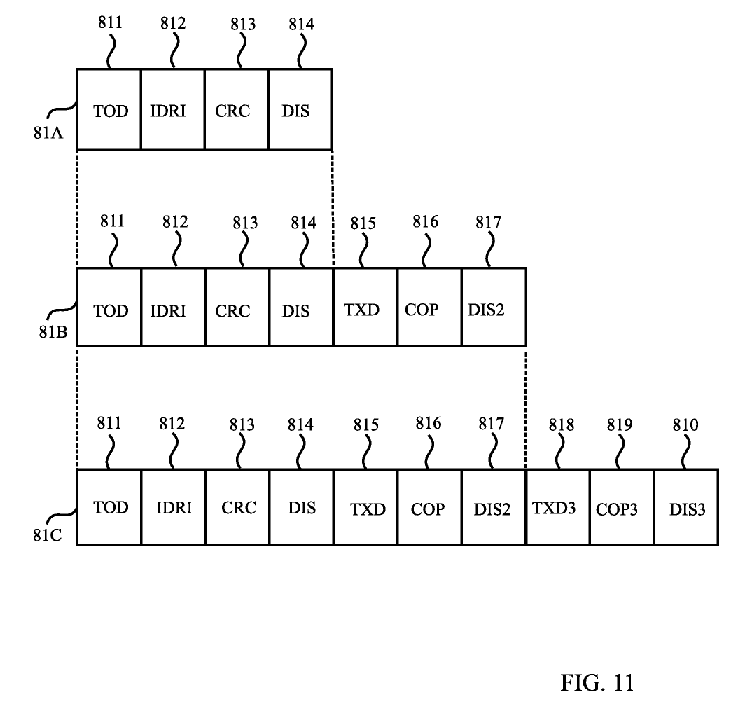

f. Use of a specialized electronic document to contain the patent application, and an Editor suitably devised therefor, ie FIGS. 11-15.

Alternately, all or part of the document may be printed, a hard copy.

**End of Method**

Other examples of embodiments of methods for achieving a Quality patent application are detailed in Methods Q2, Q3.

The above means/method steps are further detailed in the present disclosure, for example:

Multi-layer, multi-stage, multi-file methods: Methods M1-M3.

Numbering of sentences in text and of parts in drawings: Methods N1-N3

Improved drafting of the drawings: Methods D1-D4

Use of mathematical models, Boolean Logic etc: Methods B1-B4

Electronic documents, structure and use: Methods U1-U5

Bonded Editor for patents/applications: Methods E1, U1

Search methods, menus: Methods S5, S6.

Method M1—Multi-Layer Patent Application Drafting

The method involves a multi-layer systematic approach, including the following layers/steps, to be consecutively built on top of each other to draft the patent application:

a. Preparing a List or Glossary of the terms used in the application [458] (see FIG. 6). The List may include a separate listing of standard terms and another of new terms. The standard terms may include the terms accepted in a specific scientific discipline relevant to the invention, the terms in a patent which was upheld in court to form a precedent, an accepted dictionary such as Webster's II Dictionary or Oxford's, and/or terms from the Class/Subclass patents classification.

Special attention should be paid to new (non-standard) terms, which should be carefully defined; preferably, an effort should be made to eliminate or minimize such terms.

The terms may include parts of a system, interrelationships between parts, steps of a method, benefits (either general or specific to a scientific discipline or patent class/subclass), etc.

See “Method for developing a Standard vocabulary”.

b. Describing the structure and/or method of operation of the invention, using the terms in (a).

See “Structure definition method” above.

c. Detailing the benefits, advantages of each of the novel structures and/or methods of operation in (b), over prior art.

See “Method for defining inventions” above.

d. Drafting the legal protection claimed (the Claims portion of the patent application), whilst referring to (b) and (c) above.

To prove that:

The claims are fairly based on the disclosure, and Completeness of description,

there may be pointers from each claim to the description, indicating where there is support for the claimed structure, its operation/use and the advantage claimed. Pointers may be to text and drawings.

e. Compiling additional information which may help to understand the patent application, as detailed for example with parts 455, 456, 457 in FIG. 6, and appending the parts 455-458 to the patent application.

***End of Method***

The improved structure of the application strives to convey a precise description of the invention in mathematical equations using a controlled vocabulary of precisely defined terms.

It better relates to the wealth of prior art knowledge—science, patents and commercial products.

The application may further include a mathematical linkage of the background, disclosure and claims into an integrated package. The new patent application structure is compatible with the new method of cooperation with the patent agent.

For each claim in the application, it is concisely and clearly shown:

1. Pointers to indicate where in the application is described each element in that claim, as well as a structure comprising these elements and the operation of that structure. Use page number and line, or sentence numbers, etc. IN another embodiment, or in addition to the above, a minimal group of elements defining the broadest claimed invention is defined; this group is then linked to prior art, not any element alone. This may be preferable as each element may bring a flood of citations, which is actually meaningless—only the specific combination is relevant.

2. Pointers to indicate which may be the closest prior art citations, and the most relevant part thereof.

3. Pointers to proof of technical utility, ie links to technical references or handbooks and specific pages/paragraphs there.

The new application structure (see FIG. 6) includes the prior art parts 451 to 454, and the new parts 455 to 458.

As known in prior art, a typical patent application may include (the following example conforms to the requirements of the US PTO):

1) A formal information part 451, including:

Title of the invention

Cross-reference to related applications

Statement regarding federally sponsored research or development

Reference to a Microfiche appendix

2) Background of the invention 452

3) Detailed description of the invention 453, including:

Brief summary of the invention

Brief description of the several views of the drawings

Detailed description of the invention

Drawings

Sequence Listing

Abstract of the Disclosure

4) Claim or claims 454

The novel parts of an application may assist in the examination of the application, in patentability searches, infringement searches, etc. These parts may include part or all of the following:

1) A List of terms used in the application 458

a. List of standard terms used—such terms may be taken from precise definitions in the scientific discipline the application relates to, from accepted patents (maybe those upheld by the courts), the terms in the Standard Classification System or a specially devised Vocabulary for Patents. The words in an accepted dictionary like Webster's or Oxford may be included.

b. Definition of new terms used—each new term in an application should be define as a combination of standard terms, possibly with precise qualifiers, such as “wherein made of non-ferrous metal and galvanically coated” or “wherein the traffic speed is above 2 GHz”.

c. List of standard benefits used—these may be accepted benefits which may justify the grant of a patent, or benefits specific to each Class/Subclass.

d. Definition of new benefits used

2) Hyper links 455—the text may contain links to references in the text or to the drawings, for easy access. The numbers in drawings may themselves be links to the related text or to other drawings.

3) The text and drawings of the disclosure 456:

a) Prior art cited, in Boolean Logic form—using mathematical equations with precisely defined terms and the interrelationships therebetween. A cited document may include a multitude of such equations, each addressing one system or method disclosed there.

b) Invention in Math form (ie Boolean Logic, Mathematical Models, table) A plurality of “Inventive concepts” may be disclosed, each relating to one embodiment of a structure/system or a method

c) Equations in mathematical form (understandable/usable as equations by the present methods).

d) Claims in Math form

e) Drawings description using text, ie using mesh topology equations of a system in mathematical terms, ie FIG. 10 and related description.

4) Cross-reference between application parts: 457

Elements or steps

Relationships among parts

Benefits

Claims

There is, or should be, an underlying concept and logic to an invention, from which stem the various parts of the patent application. This concept and logic, and how the various parts of the application relate to it and to each other, can be precisely defined in mathematical and/or tabular form.

Attention should be paid that such information contribute to an understanding of the application without limiting the scope and spirit of the disclosed invention and whilst preserving an inventor's right to subsequently review said information.

Method Q2—Quality Patent Application

Method of achieving a quality, easier to examine and protect patent application:

1. Building the patent application in layers, one atop the other:

a. Definition of field of invention and terms used to describe the invention

b. structure and operation of the invention, using the terms in (a)

c. benefits, advantages over prior art of the structures in (b)

d. legal protection claimed, referring to (b) and (c)

2. Resolving ambiguities, uncertainties, unknowns at a lower layer before proceeding to a higher layer. The invention cannot be described before the precise terms to be used are defined. The benefits cannot be shown before the structure and operation of the invention are settled. The legal protection cannot be claimed before it is clear what is to be protected, and what good it does (the invention describes a triangular cup—so what?).

Reversing that logical order only obfuscates things, is a waste of effort, and—once an incomplete, unsatisfactory layer is buried under other layers, it is much more difficult to correct things.

3. Strictly reviewing the terms used in an application. These terms are very important, as they are actually the building blocks of the whole application.

The terms thus defined have a double importance:

a. for understanding the present application during its examination, the protest and interference proceedings, etc.

b. once the application issues as a patent, these terms may haunt the patent office, the courts of law and the industry for a long time. An unusual term may prevent a patent from being found during a patent search or may make more difficult the interpretation of a cited patent.

4. Using mathematical tools to precisely describe inventive aspects of the invention, using mathematical equations to define interrelationships among precisely defined terms, and cross-references among the parts of the patent application. The terms in use may be linked with precise accepted definitions in a scientific discipline or a dictionary.

Each claim may be linked to a specific structure and benefit thereof. Each claim may be linked to a specific Patents Class or Class/Subclass.

5. Involving the inventor(s), to the largest extent possible, to cooperate in precisely defining the invention, to contribute and/or approve activities performed in steps 1-4 above. During the process of drafting the application, it may become estranged from the inventor, possibly because of inclusion of unfamiliar technical and/or legal terms. Yet, if the inventor is not involved in the process, errors or misunderstandings may occur which may damage the patent application. It may be technically and legally correct, but may lack some of its original inventive spark.

An Inventor's intuition is very important. Preferably, the inventor should have the final say in drafting the patent application.

Is it fair to ask this extra effort of the inventor? The population in general is more educated today. It is easy to get information on any subject, using a free library maybe also assisted by a librarian, free resources on Internet, free help and advice from the Patent Office, etc.

By relating the invention to reality, the inventor may greatly contribute to the examination and protection of the invention.

**End of Method**

Note: In including an interpretation in the application, there is a dilemma: On the one hand, it is only fair to ask the inventor to help the Examiner, by explaining the application;

On the other hand, the interpretation may be mistaken or incomplete, in which case inventor's rights may be infringed upon or unfairly limited.

To make the new method practical, it is respectfully suggested not to see the interpretations and additions to an application as limiting factors; to allow the inventor to change, delete and add to such interpretations without affecting the priority date.

Method N1—Numbering the Sentences of an Application

a. It may be advantageous to assign a unique number to each sentence in a patent application, preferably in an increasing order, maybe consecutive numbers. These numbers may be used in cross-references 457 to be added to application, in tracking changes in the application, etc.

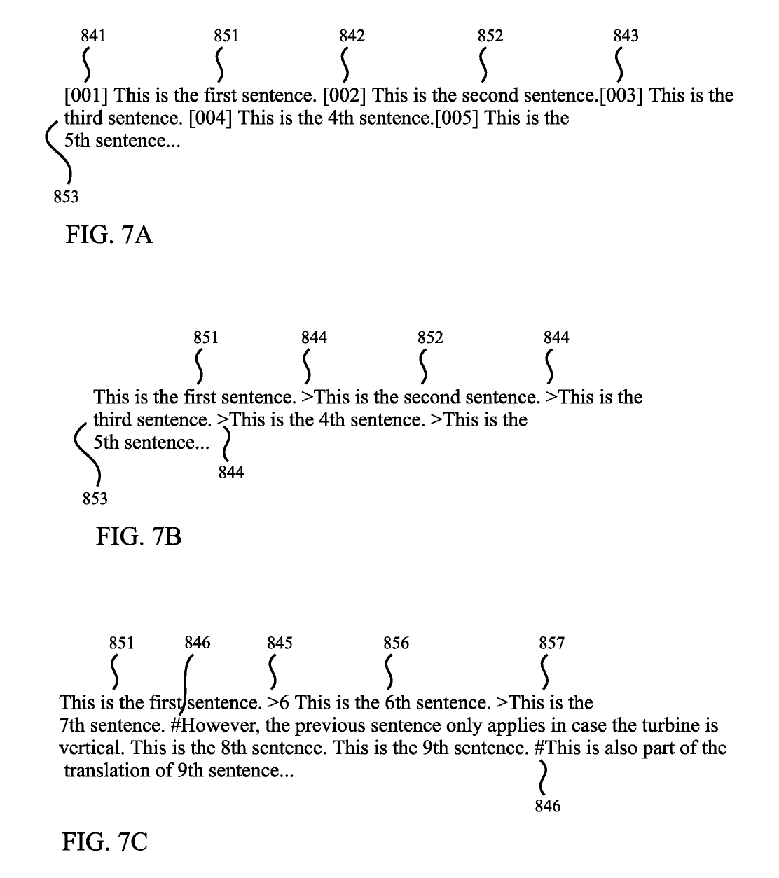

b. FIGS. 7A, 7B and 7C detail, for example, three preferred embodiments of a method for numbering the sentences in a patent application.

c. In FIG. 7A, sentences 851, 852, 853 are separated/annexed with delimiters 841, 842, 843 respectively. Delimiters are consecutive numbers, in this preferred embodiments in a Unicode UTF-8 representation of one byte per digit the numbers may be between square brackets, which in this embodiment should be reserved by the editor for only this specific use.

d. In FIG. 7B one type of delimiter 844 is used, the character “>” in this example. Whenever the editor encounters this character, it indicates a new sentence. When the user so desires, the Editor will insert and display the serial number of each sentence (usually these numbers should be hidden, to more clearly present the text of the patent/application).

e. FIG. 7C includes Natural text, interpreted by Editor so that each period or semicolon for example “. ;” will be a new sentence, unless special control characters are inserted, for example a delimiter 845 to indicate a discontinuity/jump in the numbering, or a control character 846 to indicate that the last period should not indicate a new sentence—the following sentence is logically/semantically tied together with the preceding sentence and should not be separated therefrom.

f. Claims may each be considered a sentence and numbered accordingly.

g. Sentences in each page may be numbered anew (starting from 1 in each page). A sentence may be given a composite number [page No.] [sentence No.] for example 02433 for the 33th sentence in page 24.

Where there are several documents in an electronic document, each document may be assigned a serial number, then a sentence number may appear as: [document No.] [page No.] [sentence No.], with a given number of digits each.

***End of Method***

Note: Preferably, each sentence should be completely contained in one page, (not to be divided between two pages). Where two or more sentences are semantically linked (each does not have a semantic meaning alone) they all should be in the same page.

Method Q3—Quality Patent Application

FIG. 8 details a Patent application drafting method—steps for drafting the new patent application, including:

a. Define the invention 41 and File an urgent preliminary patent application. It may be defined in the inventor's informal language and form, may include computer program lists, draft drawings, pictures, etc.

Benefit: to establish an earlier priority for patent and copyright rights.

b. Patents search 43

A prior art search may include patents, applications, technical info, etc.

c. Preparing a List of terms used 458. After the patents search and other research, it may become apparent that other terms need be used. These may be implemented as an amendment of the application, preferably with tables or cross-references to indicate the precise locations where changes were made, to ensure that no new matter was added and no change in the invention made. See “Method for developing a Standard vocabulary”.

d. Hyper links 455 may be added between the parts of the application. Multiple links may be used.

They may indicate links between claim elements and their corresponding description in text and drawings, the operation of the claimed system or method, the benefit thus attained and advantages over prior art.

e. Defining the application in Boolean Logic form 456

or other mathematical equations, ie for drawings.

See “Method for defining inventions” above.

f. Cross-reference between application parts 457

May indicate in a precise, concise way using mathematical terms and standard vocabulary, the inventions presented and distinguish them from prior art.

May answer the requirements of the new Accelerated Examination instituted at the USPTO starting 25 Aug. 2006 such as:

1) results of a preexamination search of patents, applications and non-patent literature;

2) IDS citing references most closely related to the invention and, for each reference, identifying all the limitations in the claims that are disclosed by that reference, and where;

3) An explanation of how each of the claims is patentable over the references;

4) A concise statement of the Utility of the invention;

5) To indicate where each limitation of the claims is supported in the written description;

6) To identify any cited reference that may be disqualified as prior art under 35 U.S.C. 103(c) as amended by the CREATE Act.

g. Summary of formal information 451

h. Background of the invention 452

i. Disclosure of the invention 453

Text and drawings

j. Claim or claims 454

k. Integration and compilation 459

The stages 451-454 may be prepared manually using prior art methods; stages 455-458 may be done using computer-assisted methods as detailed in the present disclosure. In stage [459], the results of the above processes may be compared, adjusted and combined if possible into one coherent presentation.

m. Ready? 450

Are the various parts of the application in agreement with each other, to present and support the various aspects of the invention or collection of inventions under one inventive concept?

n. Filing a complete patent application 45 as an electronic document, for example as illustrated with FIGS. 11-15.

Otherwise, a printed document may be filed, to include an application in the presently standard form and an Appendix with the required information.

***End of Method***

Note: In one embodiment of the above method, the steps 458, 455-457 are performed concurrently with drafting the application steps 451-454.

Method M2—Multi-Stage Patent Application

The method of FIG. 8 for drafting an application may be implemented in a procession of stages:

a. Defining the invention and the desired protection for it 41

b. drafting the description of the invention [451-454]

c. searching of patents and other prior art 43

d. distilling the information in the invention description and prior art results, into Concise Boolean equations 456 and Cross-references 457. These may offer a broader, deeper insight into the invention, and may stimulate improvements in the description [451-454]

The result: one or more Invention formulas™.

e. repeating the above steps (a)-(d) to improve the interrelated parts of the application, until the application is ready for filing or other considerations cause the application to be filed.

f. completing the patent application, including hyper links 455, CRC, digital signature etc (in case of filing as an electronic document) and filing it 45.

***End of Method***

Method M3—Multi-File Editor

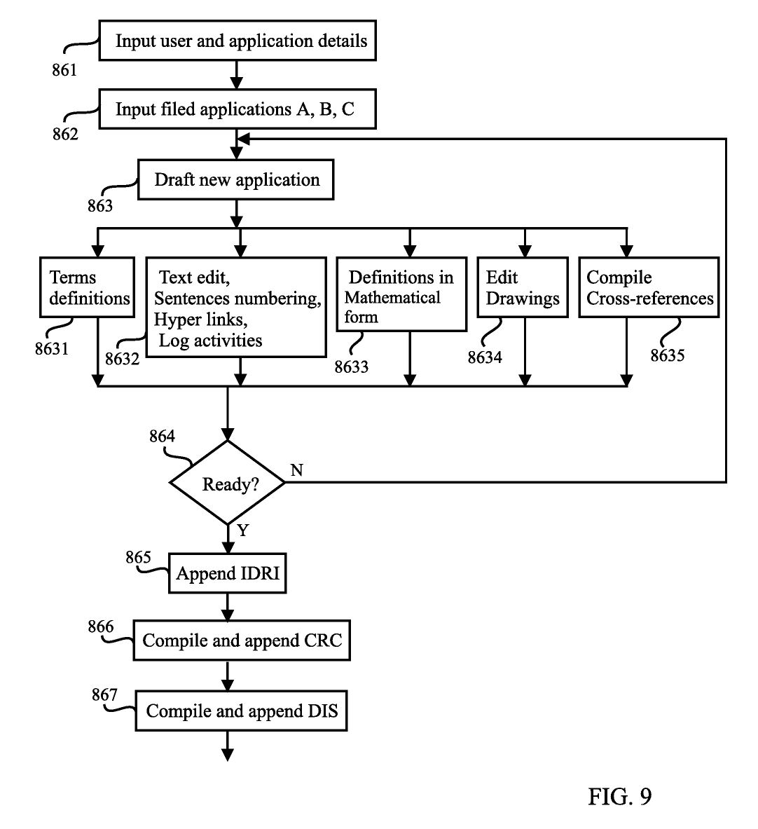

FIG. 9 details a multi-file editor PatEdit™ method suitable for processing electronic documents, adapted for use with patents and patent applications:

a. Input user and application details 861

b. Input filed applications A, B, C 862

These applications or patents or parts from them, may be used to draft a new application.

c. Draft new patent application 863, including part or all of the steps 8631-8635.

d. Terms definitions 8631

e. Text edit,

Sentences numbering,

Hyper links,

Log activities 8632.

The Activities Log may include entries such as:

append sentences No. 32-77 from application A

append sentences No. 11-137 from application C

append sentences No. 3-230 from application B

append sentences No. 1-27 from application A

append new sentence: <Text>Type: supporting data, prior art

append sentences No. 244-246 from application B.

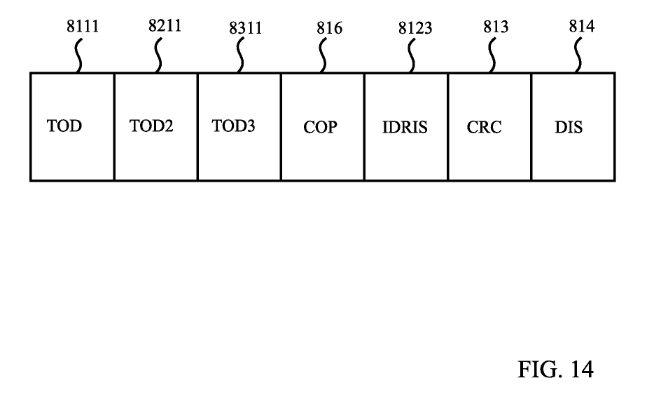

The Activities Log may be implemented with the block Change Operations Performed COP 816, see FIG. 14, which is appended to an electronic document representing a patent/patent application.

The block Change Operations Performed COP 816 indicates where to insert each sentence or paragraph of the text 815, and what other edit operations were performed.

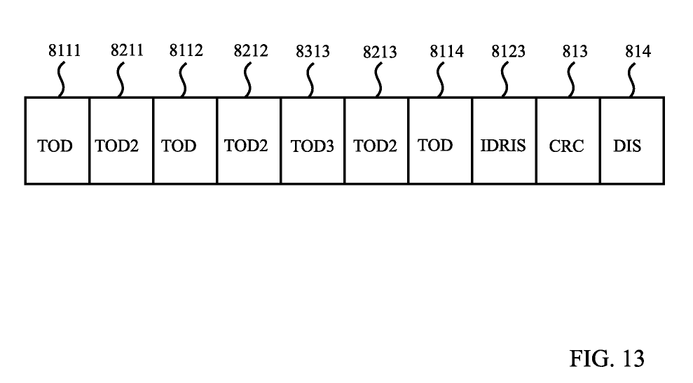

In one implementation, the relevant sentences are copied to the target application, ie as in FIG. 13.

In another embodiment, only the user's commands (what to do) are recorded into the output file, together with the source files A, B, C. Using this data, the Editor can assemble the resulting text for display or printing, whilst preserving the source texts intact for further checks.

f. Definitions in Boolean Logic 8633

These are concise, precise statements based on precisely defined terms and the relationships between them. Other equations or Mathematical Models may be used.

g. Edit Drawings 8634

h. Compile Cross-references 8635

Cross-references may refer to sentence numbers in the text, to the claims and to references.

i. Ready? 864

The user evaluates the application drafted thus far, and decides whether to continue the process. If finished—proceed to step (j).

j. Append IDRI 865, see details with FIG. 11 for example re parts 865-867.

k. Compile and append CRC 866

m. Compile and append DIS 867

May use public key encryption to encrypt the file or to authenticate with a digital signature. This adds further protection against computer viruses and errors in the file.

***End of Method***

Method D1—Drafting of Drawings

FIG. 10 details an example of a drawing in a Quality patent application, using a mesh topology description of a system in mathematical terms. An unambiguous, clear and precise description of the invention is achieved:

a. The parts of a drawing are assigned numbers in a hierarchical way. Thus, the main parts of a system are assigned one-digit numbers such as 1, 2, 3 . . . The components of part 1 are assigned the numbers 10, 11, 12, 13 . . . Thus, when one encounters for example part number 3142, he understands it belongs to part 314, and ultimately to the main part 3 of the system. In this example, all the parts in the drawing belong to unit 458. Further details on parts numbering—see below.

b. The inputs/outputs of each component may also be assigned a number or letter each. In a preferred embodiment, letters are used, so chosen as to convey a meaning, for example:

inputs: the letters A-I

outputs: J-O

i/o: P-W

special: X-Z

c. The links between the parts may also be numbered. These links may be just connections, or may convey a meaning, for example:
1 Placed above
2 Placed under
3 Attached to . . . by glue
4 Coupled using detachable tube
5 Coupled using high pressure tube
6 Coupled using metallic tube
7 Connected using a rotary joint
8 Connected using electrical wire
9 Connected with high frequency wire
10 Connected via fiber optic
11 Connected through waveguide
. . . no direction indicated; unidirectional; bidirectional

c. The drawing can now be described as a set of connectivity equations or a table:

| From | To | Connection | Bidir |
|---|---|---|---|
| 4581.J | 4582.A | 4571 | 0 |
| 4582.J | 4581.A | 4570 | 0 |
| 4582.K | 4583.A | 4572 | 0 |
| 4584.M | 4582.B | | 0 |
| 4583.P | 4584.R | 4573 | 1 |
| 4583.M | 4587.I | 4574 | 0 |
| . . . | | | |

The first line, for example, indicates: output J of part 4581 is connected to input A of part 4582 using the connection 4571 (this may be a specific function or type of relation between the parts, to be detailed elsewhere). The connection is unidirectional (NOT Bidirectional).

d. A table indicating the type of each component may be prepared, for example:

| No. | Type |
|---|---|
| 4581 | Fuel tank |
| 4582 | Pump |
| 4583 | Engine |
| 4584 | Computer |

Thus, the Fuel tank 4581 is connected through the Pump 4582 to the Engine 4583; the Computer 4584 controls the operation of the pump 4582, etc. A new component may be defined and detailed in terms of known components or mathematic equations.

e. Analysis of the drawing in the system. This, assuming the system has a list of terms (component types) used in various applications.

For each such part, the system may include a mathematical description of its function and can use mathematical simulation techniques to analyze it. The system can then “understand” the drawing, and use it in various applications: to check the correctness and completeness of the drawing, to search for similar drawings in prior art, etc.

A Provably correct structure may be achieved—provable by computer simulation to prove its operation as claimed, for example.

f. Functional link of the description and the text, using a concise description in the text relating to the drawing.

***End of Method***

Notes:

1. The above method may be used to describe a system or a method. For a method, the blocks of a flow chart and the interconnections between them can be described the same way as the blocks of a system.

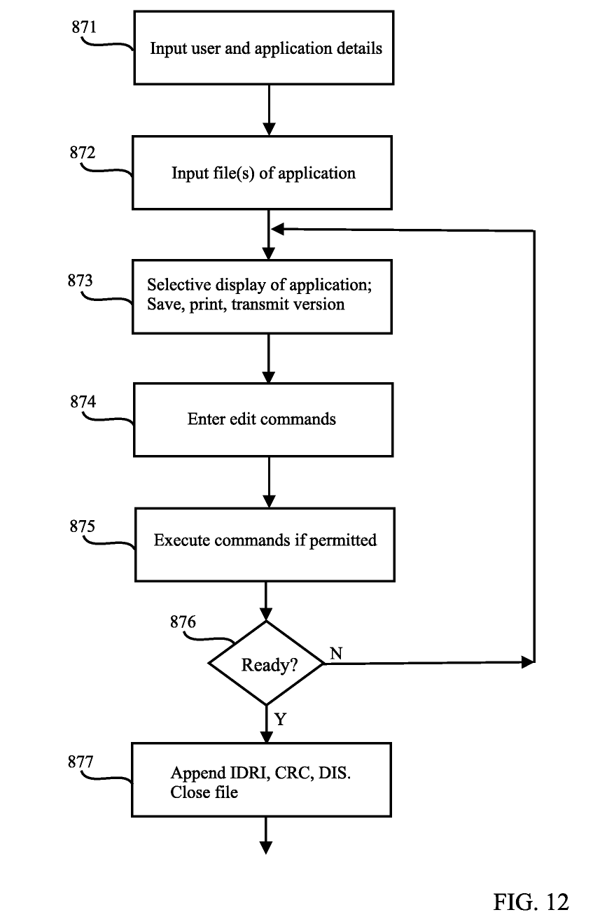

For example, the blocks in FIG. 12 can be described as (partial list):

| From | To | Connection | Bidir |
|---|---|---|---|
| 871 | 872 | | 0 |
| 872 | 873 | | 0 |
| 875 | 876.1 | | 0 |
| 876.2 | 876 | | 0 |
| 876.3 | 873 | | 0 |

2. A system or method may be described as a bi-dimensional entity, with one dimension being the structure: the parts and their interconnections, and the other dimension—the component or step contained in each part. This allows for a bi-dimensional search for prior art inventions, one of the dimensions being the structure, the other—the components in the blocks of the structure.

Method N2—Parts Numbering

In prior art, the numbers attached to parts in a patent are a wasted resource. Despite their proliferation—in the drawings, the text, the claims—they are not used to convey additional info to the reader. The numbers may be in increased order 2, 4, 6, 8 . . . or 10, 20, 30, 40 . . . or at random.

Parts in a drawing or a set of drawings may be numbered as follows:

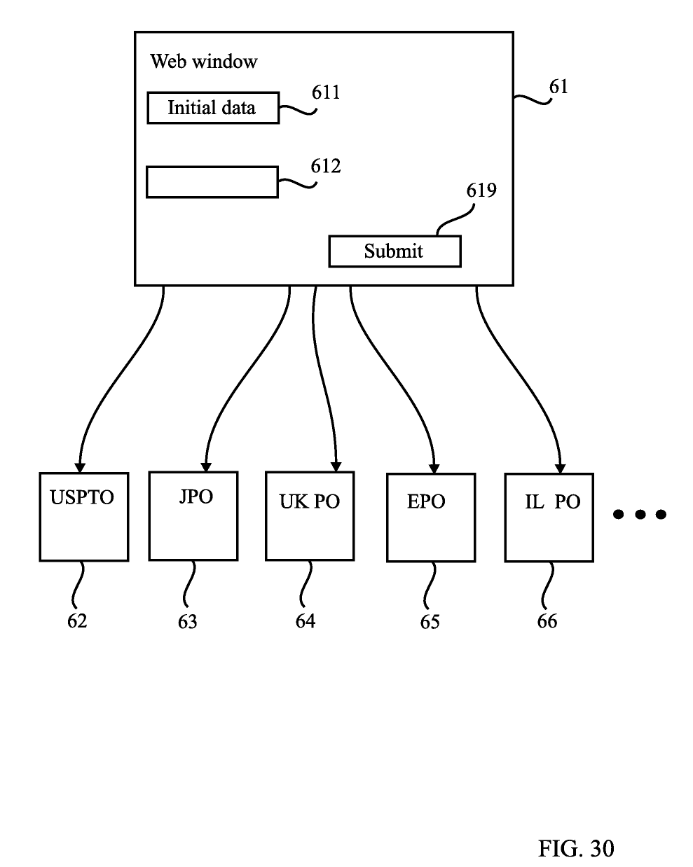

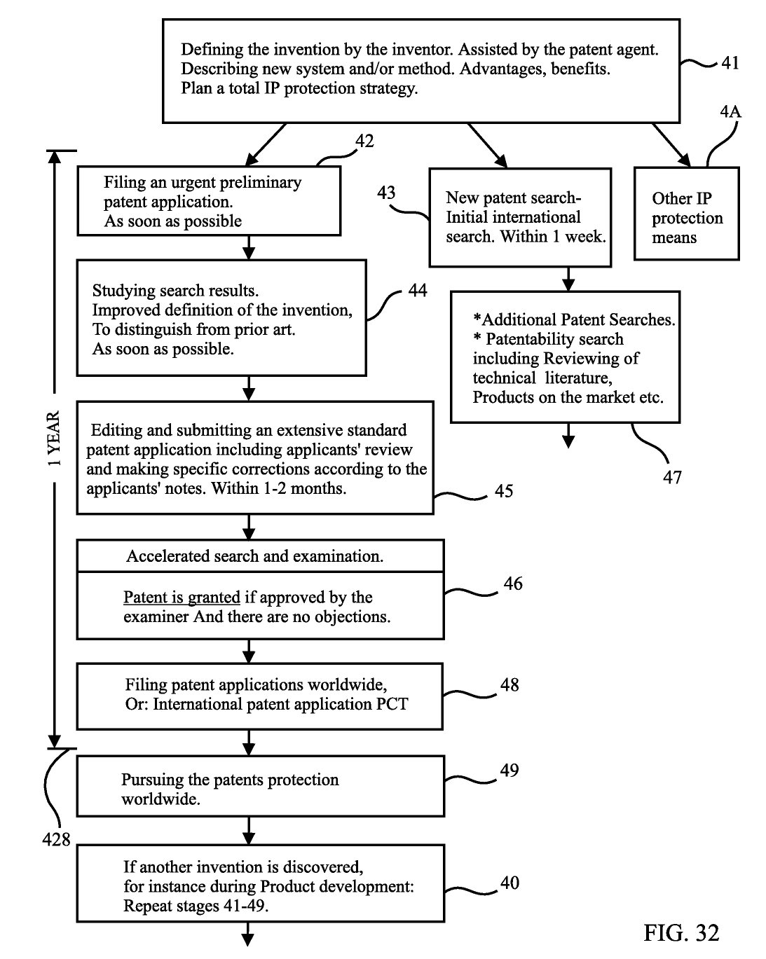

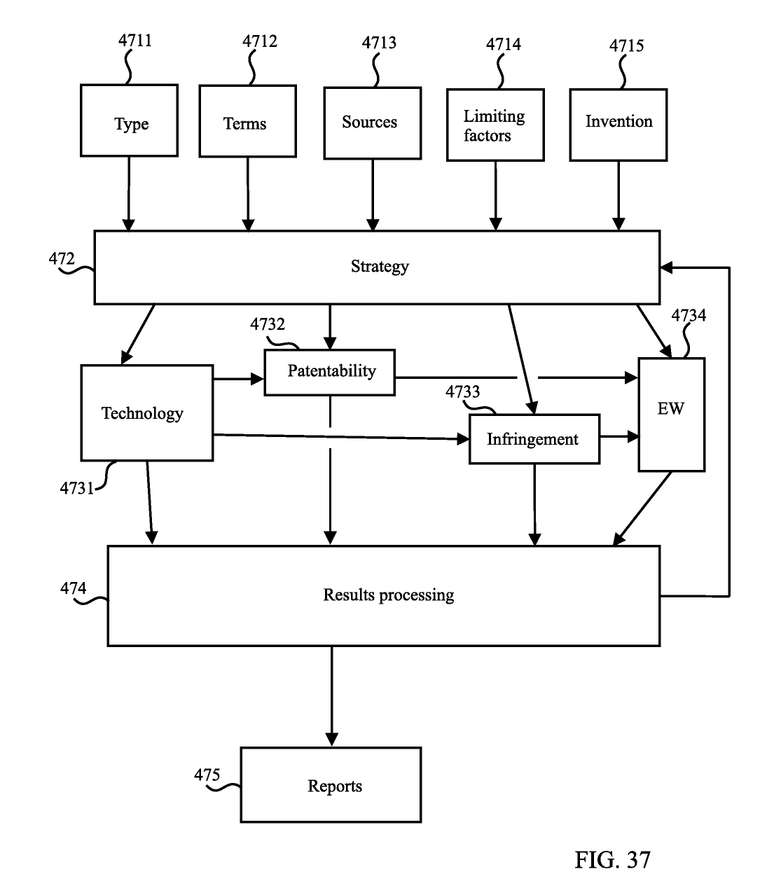

a. The parts of a drawing are assigned numbers in a hierarchical way. Thus, the main parts of a system are assigned one-digit numbers such as 1, 2, 3 . . . The components of part 2 are assigned the numbers 20, 21, 22, 23 . . . The parts of a menu 61 are 611, 612, 619 (FIG. 30). The parts of Search module 47 (FIG. 32) are modules 4711, 4712 . . . 473, 4731 . . . , 474 . . . (FIG. 37).

b. The order of numbers in (a) is according to the functional signals flow, or the order of execution in a method. OR:

The order of numbers in (a) is according to the location of the components in the drawing, to facilitate locating each component. OR:

The order of numbers in (a) follows the order of disclosure in application.

c. Where there are only a few components, only numbers may be used; OR a mnemonic letter or group of letters may be used to facilitate understanding

of the invention. For example, use E for engine, T1, T2, T3 for tubes there, FIL for filter, etc.

d. Where there are many components, also use letters for a more concise representation, avoiding repeat use of large numbers in drawings and text. Thus, for example, three numerical digits may represent 999 parts, whereas three alpha-numeric digits—42,875 parts.

Only 25 letters were considered, for example only capital letters and excluding possibly ambiguous letters such as I, O.

e. Where there are between 10-16 components in a part, use letters with a numerical meaning—the hexa numbers (A-F), after the numbers 0-9.

f. A Set of parts corresponding/relating to a second set of parts, may be allocated a corresponding set of reference numbers. As illustrated in FIG. 6 the links 4571, 4572, 4573 are related to the parts 4581, 4582, 4583 respectively. Thus a bidimensional functional correspondence between part numbers assignation is achieved, which is easier to follow by the reader and easier to write and verify.

***End of Method***

Method D2—Drawings in an Application for a Method

The method refers to improved drawings for a method.

A method may be precisely defined in a way similar to that in FIG. 10.

There are standard symbols in computer science, used in programs flowcharts for example:

Terminal, Processing, Decision, Connector, Input/Output, Manual input, Printer, Storage.

Each type may be filled with specific terms detailing the process, decision etc. The above elements are connected by lines indicating the direction of flow.

***End of Method***

For background on digital machines, the representation of their structure and their states (method of operation), see the book: Switching and Finite Automata Theory by Zvi Kohavi, McGraw Hill Book Co.

Method D3—Mechanical Drawings

The method refers to improved drawings for a mechanical device or system, in a way similar to that in FIG. 10. There are no signals, however, so the equations may include specific shapes (rectangle, circle, triangle, line, text, etc.) and their location, size and orientation. The parameters may be relative, to achieve a description which is independent of the size (scale) and orientation (rotation) of the specific drawing.

Drawings describes as per above may be compared by computer means, to determine the likeness and differences therebetween.

***End of Method***

Method D4—Mechanical Drawings

The method refers to improved drawings for a mechanical device or system, where there is just a pictorial drawing which is difficult or impossible to represent as a combination of primary forms.

In this case, a bidimensional Fast Fourier Transform FFT or another bidimensional transform may be performed, to compute the spectrum of the drawing. This spectrum may be easier to compare with other drawings.

***End of Method***

Method B 1—Use of Boolean Logic and Mathematical Models

Various mathematical tools may be used to achieve a concise, precise description of an invention, an inventive concept or a claim in a patent or application. Mathematical models may be used, which include Objects and Relations between the objects. The Models may be implemented with Boolean equations, matrices and/or other mathematical equations.

Whenever the term “Boolean Logic” or “Boolean Equations” is used in the present application, it should be understood that it may also refer to other mathematical tools.

***End of Method***

Method B2—Mathematical Equations to Enhance the Disclosure

The method of using mathematical tools to describe an invention, an inventive concept or a claim will now be detailed by way of example:

| Structure | FIG. | Resulting benefit | Claim No. |
|---|---|---|---|
| A and ((B or C) not E) | 6 | 22 | 18 |
| (A or F) and ((B or C) not E) | 7 | 23 | 19 |

Wherein:

A, B, . . . F are components of a system or stages of a method in the application

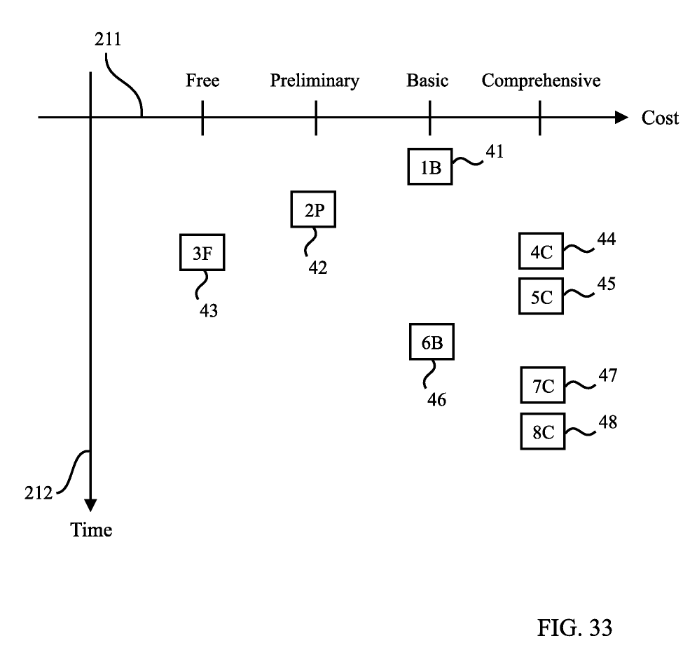

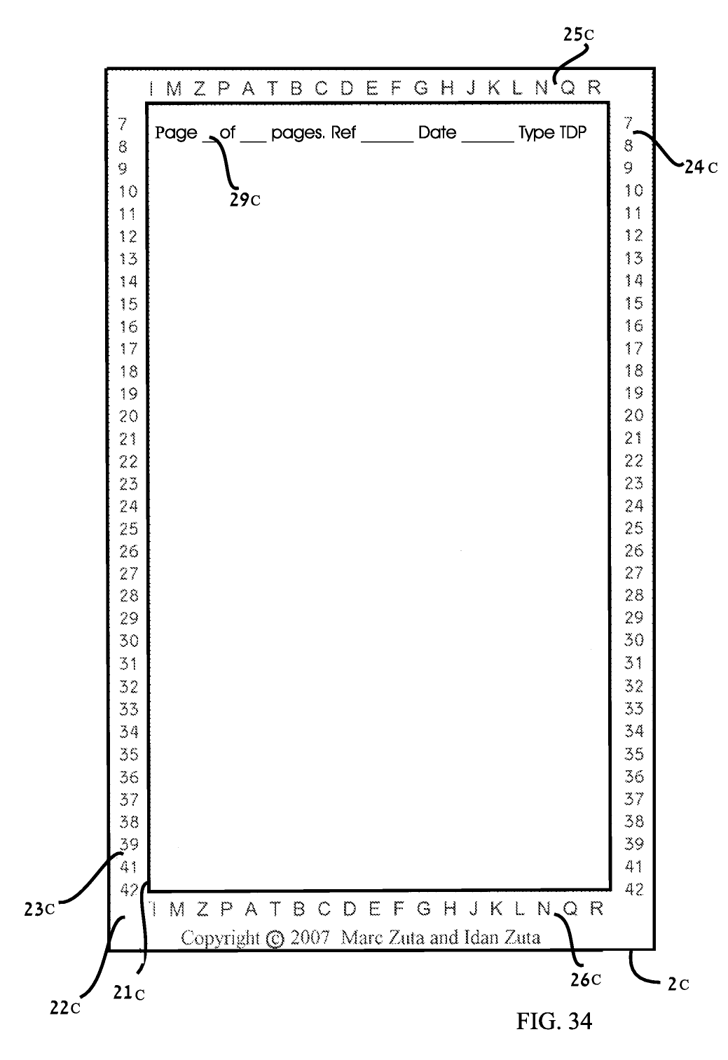

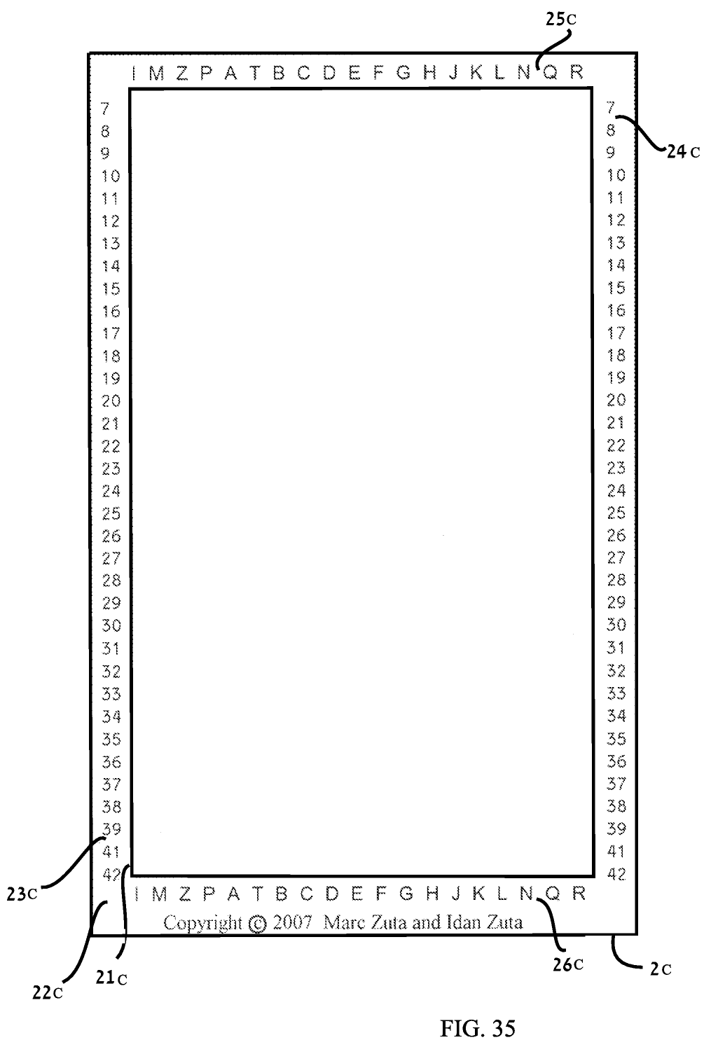

FIGS. 32, 33 is the drawing number where the structure is detailed. The equation may also include reference to text where the specific structure is detailed.

22, 23 are benefits, from a list of standard benefits for example

Claim No. 18, 19 are specific claims in the example application.

***End of Method***

Method B3—Mathematical Description of an Inventive Concept

The method may be used in the detailed description or the claims, to define a novel structure, such as illustrated in FIG. 10.

Set of equations for Embodiment No. 1:

Fuel tank>Pump>Engine

Computer>Pump

Computer<>Engine

Accelerator>Computer
(comment: the components are detailed, with the functional links between them, with an indication of whether the link is uni- or bidirectional)

Set of equations for Embodiment No. 2:

Fuel tank>Pump>Engine

Computer>Pump

Computer<>Engine

Accelerator>Computer

Efficiency control>Computer
(comment: an additional component Efficiency Control is added).

Set of equations for Embodiment No. 3:

Fuel tank}Pump}Engine

Computer>Pump

Computer<>Engine

Accelerator>Computer

Efficiency control>Computer
(comment: different symbols are used for gasoline flow and for control and measurement lines).

***End of Method***

Note: In the above method, the terms are defined in a List of Terms 458 (FIG. 6, or in an accepted, standard reference. Thus, each set of equations has a specific, precise meaning.

Method B4—Matrix/Vector Equations to Describe Inventive Concepts

Matrix/vector equations may be used to describe an invention:

a. Assign a unique number to each sentence in an application. Each equation or special term may be assigned a number as well. In another embodiment, each paragraph is assigned such a number. The numbers may be sequential, starting from 1.

b. Prepare lists of interrelationships between the parts of the application:

for each claim—where is it explained: list the sentence numbers. Each sentence may be assigned a score, to indicate its importance for that claim, for example between 0 and 100, or just a logic value (1 or 0).

for each claim—where is it illustrated: list the drawing numbers. Each possibly with a score indicating its relevancy.

for each claim—what is the benefit achieved.

interrelationships between part numbers in drawings and text.

c. transform the interrelationships in (b) above into matrices equations.

d. the matrices can be subject to various mathematical operations as known in the art, such as matrix inversion, multiplication, addition, etc. to further analyze the invention disclosure and possibly gain a better understanding of the invention.

***End of Method***

FIGS. 11-14 detail, by way of example, various embodiments of an electronic document, as applied to different uses.

At present, a flood of computer files replace the paper flood of the past—hundreds and thousands of computer files, difficult to track and understand.

In the present invention, all the info about an application or patent is included in just one computer file—the file 81A which grows into file 81B, then 81C etc. The file includes the original patent application, each of the amendments performed in a distinguishable way, the Examiner's comments, applicant's answers and comments, etc. If the application is based on several previous applications/patents, they all are distinguishably included.

A user may choose to see any of the original files or any amendment done; the history of the file and its products can be clearly presented for review. Thus, all the activities in a patent application can be precisely and reliably monitored and analyzed, to check for correctness and to assign a proper date to each part of an application or patent.

The structures in these examples may be combined into a more complex structure, to meet complex real life circumstances, for example:

Entering the national stage from PCT, including translation of the PCT application, wherein the PCT application claims priority from several original applications, and wherein some of the original applications have undergone modifications themselves.

A patent agent or attorney will understand how to draft such a complex electronic document, using the methods detailed in the present disclosure and according to relevant legislation, for example Patent Laws and International Treaties.

(9) Drafting a Patent Application as an Electronic Document

Method U1—Electronic Patent Document

a. FIG. 11 details a structure of an electronic document adapted for patents and patent applications use, including changes made by applicant.

New matter may be added to various parts of the original application, for clarification or enhancement.

According to Patent law, various parts of a patent application may have each a different filing date, if they are distinguishable from each other.

If the parts are indistinguishable, all the application may receive the later filing date, an undesirable situation to be avoided by the applicant.

A problem with this definition is how to clearly indicate, for each part of the application, its filing date.

Another problem is how to indicate, for each claim, the text it depends on, so each claim is assigned its specific filing date.

For each claim, a prior art search is performed, up to that date.

Often, an application is also filed in another country; a national application is files as an international application PCT, or vice versa. Such filings may involve a translation of the application document. It is important to relate each part (sentence or paragraph) of the second application, to its corresponding part in the first application, to verify the translation whilst focusing on the important issues.

Often, filing an application based on another also involves changes in format, to comply with PCT or national laws and regulations. The patent agent may slightly modify sentences or move them from one part to another, being careful not to make substantial changes in the application. It is important to indicate the precise changes that were made, to allow a verification that indeed no new matter was added and no substantial changes occurred. Such verification may be required during examination of the application, during protest or review by the public, or in court proceedings.

b. The novel structure of a patent application 81A, 81B, 81C in electronic document form, may solve these problems. The document includes Both the original document And changes performed therein; Changes are indicated in a precise, Provably Correct Form, with proof that the document complies to Patent Law and regulations regarding permitted changes.

c. The electronic document 81A may include:

1) the Text of Original Disclosure TOD 811,

2) additional info such as Inventor and Document-Related info IDRI 812, for example as indicated in the patent application filing forms, and info relating to filing the application, for example filing date and location.

3) a Cyclic Redundancy Code CRC 813 to detect/correct errors, and

4) a DIgital Signature DIS 814 to preserve the integrity of the digital document. It may use for example a public encryption method, with the user's private key as arranged with the Patent Office for example.

This is the original patent application as filed, in electronic document form.

The text TOD 811 is preferably a Unicode UTF-8 code text (one byte per character), in an open structure, completely visible for various software packages. This is important, to ensure that no extraneous matter (things that the inventor did not intend to disclose) are included in the file. A patent document is an utilitarian/functional instrument, so preferably fancy fonts and artwork should be rejected for the benefit of inventor's protection.

Preferably, if the description was initially written using a commercial text editor such as Word or Wordperfect, it should be stripped to preserve only the text itself (and possibly the mathematical equations), and delete all the additional matter (info not written by the author), to form TOD 811.

The IDRI 812 part may indicate whether this is a draft, or an already filed application, ie using a predefined bit or byte there. If it is a draft, the Editor will allow changes to be made in the original text TOD 811; if it was filed as an application, the Bonded Editor will prevent any changes from being made to the text TOD 811. Rather, distinguishable changes will be appended to the text, ie as indicated in steps (d)-(h) of this Method.

When closing the Text TOD 811 part (ie on filing the application) the system may write in IDRI 812 the details of the filing—filing date, by whom, where, etc.

The Cyclic Redundancy Code CRC 813 may use prior art methods to detect and correct errors in the text.

The DIgital Signature DIS 814 may use various encryption methods such as public key encryption, for example with a public key from the Patent Office.

d. After filing the original application (document 81A), the applicant may subsequently desire to add text or otherwise change the original patent application. Steps (d)-(i) here may be used to amend the application after filing, filing a second amendment etc., drafting a second patent application claiming priority from the first, a divisional, continuation, etc. Electronic documents 81B, 81C, etc. are then formed. Actually, there is no need to form new documents, this notation is here presented for clarity; rather, the same document 81A can be changed with the additions of blocks to indicate changes to be performed on prior versions thereof. Thus, files 81B and 81C preferably are the file 81A after being changed.

Additional text is appended to the original file as TeXt of aDditions TXD 815. The block Change Operations Performed COP 816 indicates where to insert each sentence or paragraph of the text 815, and what other edit operations were performed.

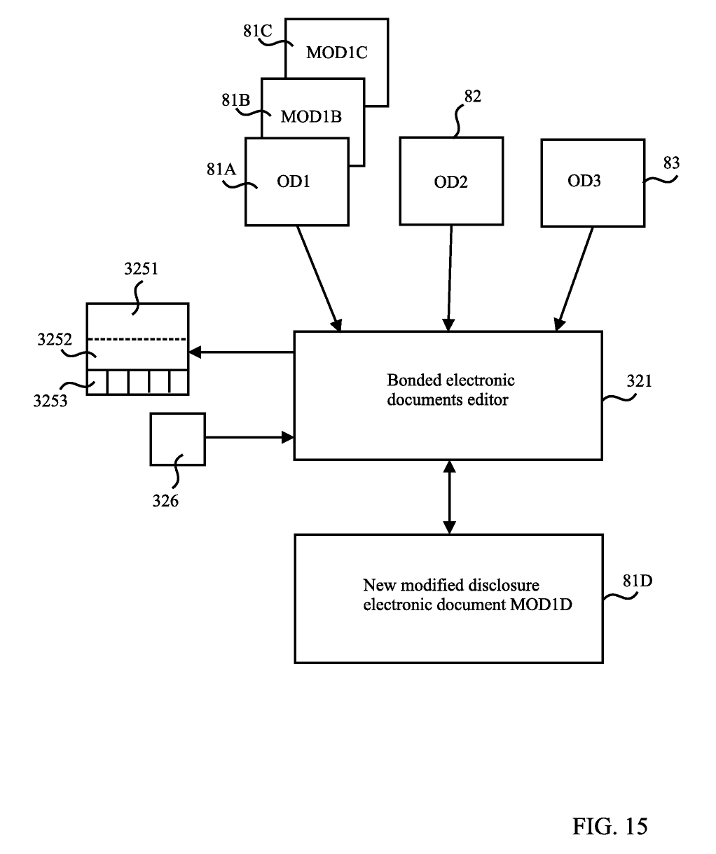

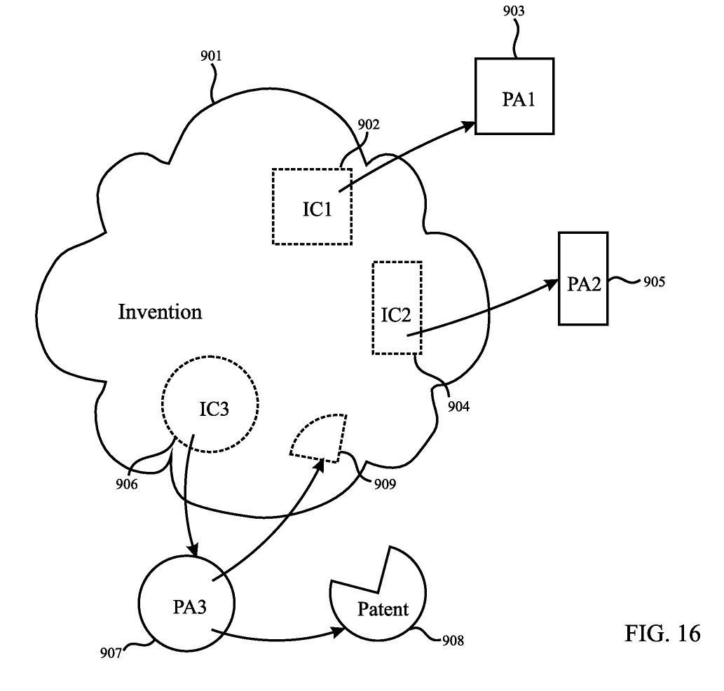

A specialized Bonded Editor, see FIG. 15 for example, may be used to allow performing the desired changes whilst recording the changes made in the appended sections.

e. Edit operations may include, for example:

A sentence was moved (intact) from the Background section to a specific location in the Detailed description (ie before sentence No. 44).

A Claim was moved (almost intact) from the Claims section (Claim No. 18) to a specific location in the Detailed description (ie before sentence 33).

a sentence was canceled (give its number. It can still be viewed if necessary)

a spelling error was corrected.

a comment only referring to prior art is added. The operation may include proof that this is known matter. The claims should not point to this text as parts of a claimed invention.

f. The digital signature DIS2 817 may clearly identify the person who made the above changes, and/or the computerized system which performed the mentioned changes.

The document 81B includes the original filing and the changes done to it, in a distinguishable format. The former document 81A is no longer necessary, as document 81B contains all the information of 81A; or, the document 81A is used, with the additions of blocks as indicated for 81B.

g. At a later date, the applicant may desire to make further changes in the application. Electronic document 81C is then formed.

New text is appended to the previous document, as text of additions TXD3 818 with the added text, change operations performed COP3 819 and a digital signature DIS3 810.

Thus, the original disclosure electronic document 81A is edited into the modified disclosure electronic document 81B, then into the modified twice disclosure electronic document 81C, etc. There is no limit to the number of changes possible in a document, or the magnitude of each change made.

h. further additions and other changes to the original disclosure may be performed, there are no limitations. Throughout this process, no information is lost—deleted text or drawings may still be viewed and examined, and all the changes are traceable. The Bonded Editor can process the information in the file to present to the user any version of the document as desired, or the evolution of a specific sentence over time.

i. the Patent Office may return an enhanced Filing Receipt, in the form of an electronic document which may include:

the original document filed by the applicant

filing-related info, such as filing date and application number

an authorization to file abroad

a digital signature using for example public key encryption and the Patent Office's private key, to attest to, and support the, info in the document.

j. During examination, the examiner may enter his/her comments into the document created in (i) above, to also include these comments and an additional digital signature, ie using Examiner's private key. The resulting document is sent to the inventor.

k. The inventor inserts amendments in the same file received in (j) responsive to examiner's comments, signs it and returns it to examiner. It may include explanations—this is prior art, this new text is based on the original drawings thus is entitled to the original filing date, etc. Thus, the complete history of the patent application is contained in one computer file—all the Office Actions, amendments, all the versions of the application, the rationale for each action, etc.

***End of Method***

Method U2—Electronic Patent Document

Use of the appended text in document 81B to indicate changes in the application (FIG. 11):

a. Assign a unique number to each sentence in the application 81A, see for example FIGS. 7A-7C. Each equation or special term may be assigned a number as well. In another embodiment, each paragraph is assigned such a number. The numbers may be sequential, starting from 1.

b. To add a sentence of text, accept the text to insert, assign it a unique sentence number N1 and place it in block TXD 815.

In block COP 816, indicate the sentence number N1, a destination address N2—the number of a sentence in TOD 811 after which to place the new sentence, and an Operation code—Insert it.

The new text may have a new date.

c. To move a sentence of text to another location, accept from the user an indication of the sentence to move N3, and its new location N4.

In block COP 816, indicate that sentence number N3, its destination address N4 and an Op code—Move it.

d. To delete a sentence of text, accept from the user an indication of the sentence to delete N5. In block COP 816, indicate that sentence number N5 and an Op code—Delete it.

e. To change a sentence of text, accept from the user edit operations such as inserting characters and/or words and/or deleting same. Each such operation is recorded and inserted into block COP 816, together with the sentence number N6 of the sentence to change. The original sentence in TOD 811 remains unchanged. Such an operation may cause the loss of the original filing date for that sentence N6. The user may be given notice accordingly, possibly with a warning and a question prompt (Are your sure?).

f. For each operation thus performed, the user will indicate the type of operation referring to Patents Law and Regulations; this type will be stored in the block COP 816 along with other details of that operation. Types of operations may include, for example:
1) New matter inserted; to receive a new date (date of this filing), provided the Patent Office allows such additions at all.
2) This sentence is taken from a priority document in this case; this sentence is to receive the priority date of that document.
3) This sentence only includes prior art known material, added to clarify the issues discussed in the present application. The material is not claimed as novel. Such additions may be allowed with Patent Offices where no new matter can be added.
4) Edit of existing sentence which may change its meaning, the sentence will receive a new date (date of this filing), if permitted at the PO
5) Edit of existing sentence which does not change its meaning, ie correction of an obvious error. The priority date is preserved.

g. The user may perform the above operations (b) to (f), in any order he/she desires and for a plurality of sessions with the computer, without limitations, as long as activity is done in the present stage.

h. Edit may be finished at the end of the present stage, for example when the user indicates to the Bonded Editor that the document is ready and will now be filed as an amendment with the Patent Office. Upon receiving such a notice, the Bonded Editor will perform the following operations:
1) An indication in the COP 816 will record the event of closing the present stage. Authorization may be required, such as a digital signature or password entered by a senior partner in the firm.
2) the system will compute a new signature DIS2 817 for the whole new electronic document.

A new CRC may be added as well.
3) The document is closed for further edit of this stage. No more changes can be made in blocks 815, 816, 817.

i) When more changes need to be made in the document, for example when a new amendment is to be filed, or a divisional, etc.—the Bonded Editor is informed of this event, a new stage is declared, and the user can enter text in a new text area TXD3 818 with operations descriptions COP3 819. The steps (b) to (g) above can be performed with the new locations in the electronic document, etc.

***End of Method***

Method U3—Electronic Patent Document

a. Write a new patent application using a text editor/drawings Editor. The text of the application is preferably UTF-8 code text (one byte per character), in an open structure, completely visible for various software packages. This is important, to ensure that no extraneous matter (things that the inventor did not intend to disclose) are included in the file.

An editor such as Word or Office software packages manufactured by Microsoft Corp., WordPerfect, etc. may be used initially, however the result should be converted to UTF-8 text for use in patenting.

Drawings may be presented as a textual description of their components and the interconnections therebetween, as detailed elsewhere in the present disclosure.

b. There are transitions between distinct stages in the life of a patent application, for example when presented to applicant for review, when filed, when amended during examination, etc.

The first time such a transition occurs, patent application file or files are transferred to a Bonded Editor, together with additional info as deemed relevant. The Bonded Editor is a new, specialized patents/patent applications Editor as disclosed in the present application. This Editor will only allow controlled changes in the file, as required by Patent Law and Regulations.

c. The Bonded Editor allows the free edit of text and drawings during the active time of any stage (the stage is open now); however, when there is a transition to a new stage, the text and drawings prepared until that event are frozen, and are no more allowed to change. Rather, changes are appended as distinguishable information.

When such a transition occurs, the Bonded Editor is notified; it will write a corresponding block, ie Inventor and Document-Related info IDRI 812, to be appended to the file, including details relating to the file such as the event which caused the transition, specification of the stage which ended, etc., possibly in concise form using predefined codes.

For example, the block may include inter alia: “This is the original version of the patent application as filed with the British Patent Office on 18 Jun. 2006; no priority claimed”.

d. For a specific patent application, all the information relating thereto are included in that document. There is no need for the patent agent to manually compare many versions of the manuscript and, time and again, try to understand what happened, where, when, by whom.

Such information may include:

text and/or drawings of the original (first, priority) application as filed

indicating the applicants, inventors, patent attorney, etc.

filing data: where filed, when

changes made after filing: what changes, where, by whom, date filed with the patent office

***End of Method***

Method E1—Patents/Applications Editor

The method may use two separate programs, a Reader for displaying electronic documents and various aspects of the application/patent there, and an Editor/Writer for preparing such electronic documents.

FIG. 12 details an editor PatEdit™ method, suitable for processing electronic documents, adapted for use with patents and patent applications:

a. Input user and application details 871

b. Input file(s) of application 872

c. Selective Display of application; READER SUBROUTINE

Save, Print, Transmit version 873.

The user may indicate what version of the application to view. The Editor will find that version, or will compile it from existing files and the commands COP 816 recorded, as used by inventor to create the new file. The READER sub may be implemented in a server or in a user's PC, for example using off-the-shelf browser programs or a specialized program.

d. Enter Edit commands 874; EDIT/WRITE SUBROUTINE (steps d, e). For example, the EDIT/WRITE sub may be implemented as a program in the server, or in a user's computer if the user installs the program there.

e. Execute commands if permitted 875.

The new text, after executing the permitted instructions, is then presented to the user, as in step (c), for example by again executing the READER sub.

f. Ready? 876

The user decides whether the edit is complete or not. If complete, then proceed to (g).

g. Append IDRI, CRC, DIS. Close file 877.

***End of Method***

Method U4—Electronic Patent Document

FIG. 13 details a structure of an electronic document adapted for patents and patent applications use, including reference to a plurality of prior documents. This structure may be used where a new patent application includes various paragraphs or sentences from several prior applications, mixed together—the example may be exaggerated, to prove the point that even such extremely complicated structures can be precisely tracked using the present invention.

Thus, in this example, the new patent application includes:

text from original disclosure TOD 8111, followed by

text from 2nd original disclosure TOD2 8211, followed by

text from original disclosure TOD 8112, followed by

text from 2nd original disclosure TOD2 8212, followed by

text from 3rd original disclosure TOD3 8313, followed by

text of 2nd original disclosure TOD2 8212, followed by

text from original disclosure TOD 8114;

(each disclosure may have its own different priority date) inventors and documents-related info IDRIS 8123 cyclic redundancy code CRC 813, and digital signature DIS 814.

*** End of Method***

Method U5—Electronic Patent Document

FIG. 14 details an electronic document usable for translations or adaptations of patents/patent applications. It may include two or more documents:

a. the full text of each disclosure. Each sentence, and each formula in each disclosure/document is uniquely numbered so it can be uniquely addressed.
text from original disclosure TOD 8111, ie a national application
text from 2nd original disclosure TOD2 8211, ie a PCT application
text from document TOD3 8311, ie national stage from PCT, translated.

b. operations performed to get to 8211 from 8111, and to 8311 from either 8111 and/or 8211: change operations performed COP 816;

This may include instructions such as “To form 8211, insert (text . . . ) after sentence No. 165 in 8111; delete sentence No. 188; replace sentence No. 199 with (text . . . ); formula 565 in 8111 is replaced with formula 3491 in 8211 . . . ”.

“To form 8311 from 8211, replace each sentence in 8211 with its equivalent translation which has the same number in 8311, except the following: Sentence 132 in 8211 is deleted; new sentence 3287 to insert after sentence 326 in 8211; sentences 324-345 in 8211 are moved to after sentence 657 in 8311 . . . ”. This allows a precise tracing of each and all the sentences in the translated file 8311, for easy checking of any of them. Important to sample-check complicated translations, ie into/from Chinese. In another embodiment, each paragraph and formula is uniquely numbered.

c. inventors and documents-related info IDRIS 8123

d. cyclic redundancy code CRC 813

e. digital signature DIS 814

***End of Method***

Method U6—Electronic Patents Editor

FIG. 15 details a text/drawings Editor PatEdit™ suitable for processing electronic documents, adapted for use with patents and patent applications.

Inputs to the editor may include various files as selected by the user, for example three disclosures, and two modifications of one of them:
original disclosure electronic documents ODI 81A, OD2 82, OD3 83
modified disclosure electronic documents MODI 81B, MODIC 81C

The edit system may include input means 326 to receive user's commands and data, and preferably a display with a split screen:

Screen_A 3251 of a split screen display

Screen_B 3252—the second part thereof

The Edit tools 3253—these are specialized tools, adapted to Patent Law so as to allow permissible operations, and track and log all the editing activities, to allow subsequent display of all changes made, by whom and when. The editor preserves each prior date for each sentence, paragraph and/or formula, or clearly indicates NO PRIORITY for a new sentence.

The Bonded electronic documents Editor 321 may be used to process the text and drawings of an application, maybe also hyper links and cross-references, ie to edit the New modified disclosure electronic document MOD1D 81D.

The applicant, after filing the original patent application, may desire to add text, translate to another language or otherwise change the original patent application. The Electronic document 81B is then formed.

Additional text may be appended to the original file, see FIG. 11 as TeXt of aDditions TXD 815. The block Change Operations Performed COP 816 indicates where to insert each sentence or paragraph of the text 815, and what other edit operations were performed.

A specialized Bonded Editor may be used to allow performing the desired changes whilst recording the changes made in the appended sections.

Using the Editor, it is possible to view the original application or a later version of it (each of the versions which were filed).

It is possible to view the evolution of a selected sentence or paragraph vs time, or to see its various forms and the filing date of each. Such presentations may help decide whether that sentence is entitled to an earlier filing date, or not.

The Editor may also present an original sentence side by side with its corresponding, translated sentence, to check the translation—of all the application, or just for the important, relevant parts of it.

***End of Method***

Method N3—Numbering of Sentences

At present, sometimes the lines in a patent application are numbered. It may be preferable to number the sentences, as the basic entity or atom of a patent which has a technical and/or innovative meaning. Each sentence may then be monitored and processed, such as to its filing date or translations.

1. Numbering sentences, ie as referred to with reference to FIGS. 11-15, may be implemented with an UTF-8 number (ie byte value 48-57 decimal) inserted before the text of each sentence. Six bytes may be used for example, preceded by a special code, such as byte value 3 (heart) not to be used elsewhere.

2. Sentences refer to logical sentences, which have an independent logic, semantic meaning to humans. For example, where there was a period or semicolon in the text. Either sentences or paragraphs may be chosen as the basic unit to attach numbers to, or other text portion having independent meaning to humans. Each table may be seen a sentence, or each line or column there. In drawings description by text as detailed with reference to FIG. 10, each line (equation) may be a sentence.

3. The numbers may be entered automatically by computer, or manually. In the automatic method, the system searches for predefined characters which indicate the end of a sentence, which may change from one language to another. The system then inserts a string of bytes, starting with a special byte (only to be used for this purpose in the file) and several bytes representing the number, for example each byte—a decimal digit (0 to 9).

4. The Bonded editor may include means for allowing a user to check the numbering and correct where necessary. For example, the sentence numbers may be displayed along with the text, but in a different color.

5. The Editor may either display the sentence numbers or hide them, as the user presently chooses. For allocating numbers and comparing versions for example, the numbers are displayed; when writing a disclosure or editing the text itself, the numbers may be hidden from view. In any case, the numbers are preserved in the text. The numbers are part of the electronic document.

***End of Method***

The sentences numbers may be used in cross-references in Quality patent applications as detailed in the present disclosure.

Method Q4—Detect Errors and Omissions in Patent Applications

The cross-reference matrix may be used to indicate errors in the application, for example where several different claims are supported by the same text, or there are conflicting benefits in the various claims, or there is no reasonable correspondence between the text and drawings, or part of the text or drawings does not affect the claims, etc.

These and other problems may be detected by mathematical operations on the cross-correlation matrix or the Math equations detailing the patent application.

***End of Method***

(10) Electronic Document Attached to a Patent Document

Method U7—Tracking Changes in a Patent Document

An electronic document is attached to a patent document to detail activities performed such as:

amendments

divisionals

translations

multiple applications.

The electronic document may include for example parts from the files in FIGS. 11, 13 and 14, and using methods from FIG. 15.

(11) Fast (One Week) Patent Filing Method

It is important to file a patent application in a short time—a patent will be granted usually to the first to file. There may be other considerations, such as a pending publication, timetable to commercializing a product, etc.

The various Patent Offices now allow for direct online filing through the Internet: the UK IPO, USPTO, EPO, WIPO, etc. However, the inventor may benefit from the guidance of a professional in filing the application.

The fast filing may be at the expense of the quality of the application, but sometimes there are constraints. The inventor may be guided and presented with the various choices, to help him reach an informed decision.

The present invention offers the inventor a choice—he still can review a plurality of agents, the agents can review the project to decide whether to take it. A relatively complex process, to preserve the rights of all parties involved and to better define the work to do, can be performed in a short time using the internet and the method here.

The Fast filing method may use parts of a regular filing as detailed elsewhere in the present invention, including:

A. The inventor and agent getting acquainted, exchanging general information without disclosing the invention itself.

B. Agreeing on the work to be performed and its terms—cost, timetable.

C. Performing the work—filing a patent application, etc. Electronic communication means adapted to patenting allow a complex interaction in a short time. Part of the steps may be omitted, to achieve lower cost and/or faster filing.

Method F1 for Fast (One Week) Patent Application Filing

The method includes:

a. The user visits Agent's Internet site and views relevant info there, including IP protection services offered, terms and conditions, prices. 11C

b. If the services or terms are not acceptable then Exit, else continue. 12C

c. User sends a Request for service Without Disclosing the Invention, by answering questions in the agent's site, including: 13C

service sought—patent filing? else Exit

inventor and applicant's details—name, address, phone, email address

right to file—inventor, agreement, will, etc.

has experience in the field of the invention?

has experience in patenting an invention or other legal IP protection?

is this the first application/national stage/divisional/enhancement/other

field of the invention (without disclosing the invention itself)

existing, known similar or related products or patents

concept proven technically? prototype/simulation/theoretic study? working software? will it work? specific concerns or techical issues?

did prepare a written description? how many pages of text, drawings?

where is protection sought? UK, USA, West Europe, East Europe, Asia, Australia, North America, South America, Africa, worldwide

priorities in processing: Speed (or there is a deadline to filing), Low cost/cost limit, Quality patent, extensive protection.

d. The Request is processed automatically at user's computer or at agent's site—under certain conditions an immediate refusal is issued to the user, for example if the invention is a Perpetuum mobile or in a field not supported by that agent. If refused, preferably no info will be transferred to the agent at all. 14C

If not refused, user's Request is sent to the agent.

e. Agent reviews the Request and decides whether to accept. The decision may be manual or automatic, per predefined rules. 15C. If not accepted—Exit.

e. If accepted, a replay is sent to user, with a Reference number for this Service and a price quote—a fixed cost is preferable. 16C

Additional conditions/terms or questions may be presented, as the need be. In all subsequent proceedings, the parties will quote the Reference number.

f. User reviews agent's response and decides to proceed, or Exit. 17C

g. If there are questions to answer, the user may answer them. 18C

If there is agreement to file a patent application, then:

the user transfers the payment as agreed

the user sends to agent a description of the invention. Preferably, SafePaper™ pages are used, to ensure correct transfer of the disclosure. VArious means may be used to send the description, such as email, fax, voice mail, pictures transmission of the invention/prototype, etc.

h. The agent drafts the patent application and formal filing forms. 19C

i. Is there to be a review by applicant? if no, goto (11). 192C

k. The ready application is sent to applicant in paper or Acrobat PDF or Word DOC file format. Applicants answers with his corrections, if any. 194C

m. The patent application is filed with the Patent Office, and the fee paid. If changes/corrections are required by the user, these are performed prior to filing. 196C

**End of Method**

Notes:

1. In all the above communications, the parties preferably use the SafePaper™ forms for safe transactions. Each party may acknowledge receipt of any communication, indicating whether it was received OK or with errors. In case of errors, transmissions may be repeated or other channels are used.

2. Preferably, SSL communications are used between the parties to protect the confidentiality of the info transmitted.

3. Processing of info may be performed using Java, Java Script, DOM, JSP, ASP, PHP, etc.

4. Sometimes the invention is found to be complex, and a more in-depth processing may be required. If this is agreed between the parties, then a dialog to better define the invention and its protection may be maintained between applicant and agent. This may delay the one-week filing, but it may improve the quality of the patent.

The dialog applicant-agent may involve many electronic communication means, for example, email, fax, voice description of the invention (phone) or web camera. A web camera allows to transmit pictures of a prototype, drawings, etc.

(13) Drafting application answering the requirements set by UK IPO

The new methods of the present application may assist an inventor to comply with the requirements of patentability set by the UK IPO.

The requirements for patentability include the “four step approach” defined by UK IPO and approved by Jacob LJ in Aerotel/Macrossan:

“(1) Properly construe the claim;

(2) identify the actual contribution;

(3) ask whether it falls solely within the excluded subject matter;

(4) check whether the actual or alleged contribution is actually technical in nature.”

The novel methods in this invention can be used in a structured approach as required by UK IPO. By drafting the patent application responsive to the requirements of the Patent Office, the applicant has a better chance of his application being approved. Checking the patent application against the UK IPO requirements, prior to filing, may contribute to improving the application to better prepare it for the examination.

Method K1 for Addressing the Patentability Requirements at UK IPO

“(1) Properly construe the claim;”

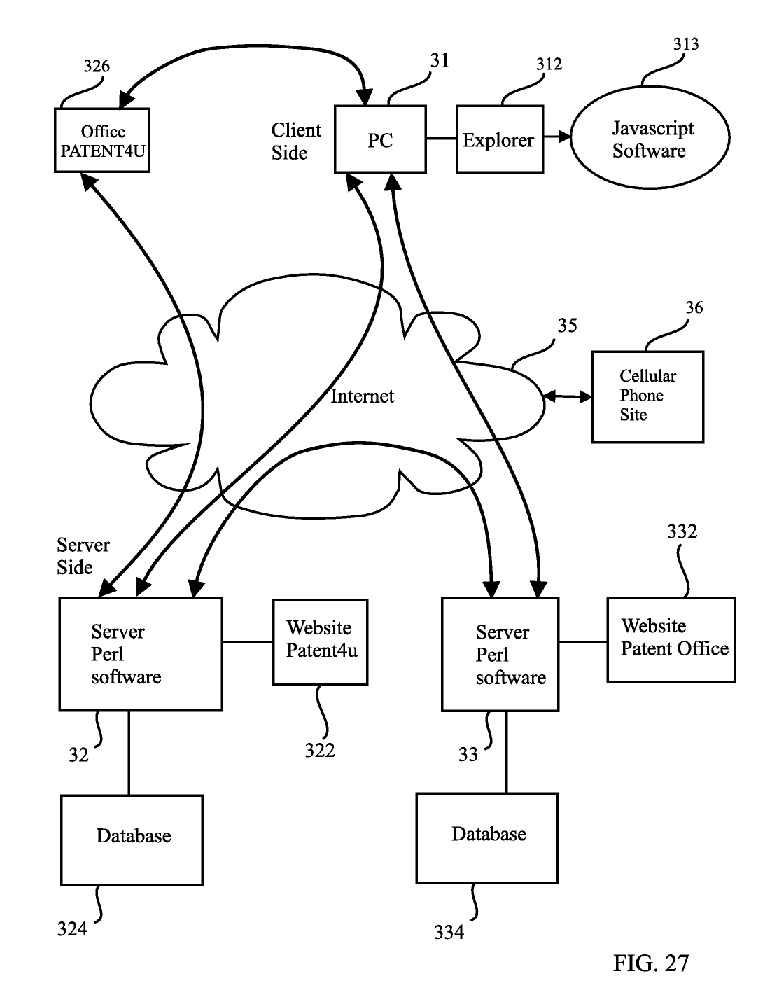

a. The invention is disclosed in dialog between inventor and agent, preferably using communications over the internet as illustrated in FIG. 27. See for example Method G1 for disclosing an invention in pictures. Preferably the disclosure includes pictures and concise text using a Standard vocabulary per Method C9 for developing a Standard vocabulary. See Method G1 for disclosing an invention in pictures. Other methods in the present disclosure may be used.

b. Prepare a description of the invention using a mathematical equation with the Standard terms, see Method C8 for defining inventions and Methods C10, C11.

c. search the prior art—patents, applications, technical publications, etc. Prior art search methods may be used, or the novel search methods in the present invention. Prior art methods search the text for specific combinations of terms, possibly using Boolean equations. The new present methods may search for inventions. The new search may also search the drawings of prior art, as detailed elsewhere in the present disclosure—search for a specific structure, then for the text in the blocks/parts of the structure—this is a bi-dimensional search.

Possibly relevant prior art is converted to mathematical equations, and the terms therein are translated into Standard terms.

Translation tables are kept with each such prior art, to make the process traceable and verifiable. Translations may be performed with other languages, such as Japanese, Chinese, Korean, Russian, etc. The method may thus be applied on a global scale, as required—patenting is an international process.

“(2) identify the actual contribution;”

d. compare the invention with prior art using a computer and software which can read and process the mathematical formulas for the above inventions. Differences from each of the prior art articles are pinpointed, and quantized. A combined, manual and automatic method may be used; the issues involved may be too difficult and complex to trust with a computer, although automatic tools may help.

Using Patentics™ and comparisons of inventions, a mensurable and traceable process may be achieved.

e. if the actual contribution versus one or more of the prior art is not significant, repeat steps (a)-(d) to re-define or narrow the scope of the invention so as to address the identified most relevant prior art; maybe a new search is required for the newly defined invention, and a new comparison with the prior art.

f. The above steps (a)-(e) are repeated until an invention crystallizes which convincingly differs from the prior art in some precisely defined aspects. Of course, success is not guaranteed; maybe this is not a viable invention in light of the prior art; it is better to find this at this early stage. If no patentable invention is found, then stop the method, Exit. If a patentable invention is found, the results of the above processing may be used during the patent drafting and prosecution, to show and prove what is the contribution distinguishing the invention from each of the prior art items.

“(3) ask whether it falls solely within the excluded subject matter;”

g. the results of the computer comparison of the invention with prior art in (d) above are reviewed considering this requirement: Each of the differences from each of the prior art articles are scrutinized to detect whether they pertain in the excluded subject matter.

A DataBase of excluded subject matter may be maintained, possibly at the agent's office. It may be necessary since the list of excluded matter is not exhaustive, rather it evolves, see paragraphs 8, 9.i) and 9.11) in Aerotel/Macrossan.

Artificial intelligence tools may be used, including a plurality of rules based on decision at the Patent Office and courts of law. The rules may be applied to a patent application prior to filing, to detect compliance with requirement (3). As new cases become available, the Al rules set may be modified and enhanced. For a manual verification, a list of standard questions may be presented, to be answered by inventor and/or agent.

In any case, distinguishing features pertaining to excluded matters is tagged as such.

A combined, manual and automatic method may be used; the issues involved may be too difficult and complex to trust with a computer, although automatic tools may help.

This process may help pinpoint the prior art over which the distinguishing features are only within excluded matter.

Such differences from prior art should be ignored. The remaining features indicate patentability. If they are not enough, then further review and changes in the inventive concept are necessary, to modify or narrow the claimed invention, by performing steps (a)-(g) above.

Again, success is not guaranteed, maybe this is not a viable invention in light of the prior art and with respect to excluded matter.

If no patentable invention is found, then stop the method, Exit.

If a patentable invention is found, the results of the above processing may be used during the patent prosecution.

“(4) check whether the actual or alleged contribution is actually technical in nature.”

h. The above steps are repeated, the results of the computer comparison of the invention with prior art in (d) above are reviewed considering this requirement. Corrective steps are taken if possible, else stop the procedure, Exit. If corrective steps were taken, then perform again the above steps (a)-(g) as necessary.

**End of Method**

Notes:

1. The order of the steps in method K1 may be changed in various ways, for example by first tagging various features as excluded matter or non-technical.

The subsequent processing takes this into account in distinguishing from prior art. This approach may reduce the workload on the computer, as matter excluded at the outset need not be processed. On the other hand, a combination of technical and non-technical matter is permitted, and the invention may lay in the combination. Thus, eliminating/ignoring part of the info may unnecessarily reduce the scope of the claimed protection.

2. Other methods in the present disclosure may support the UK IPO “four step approach”, for example Method P6 for searching inventions.

Method K2 for Addressing the Patentability Requirements at UK IPO

“(1) Properly construe the claim;”

a. The invention is disclosed in dialog between inventor and agent, preferably using communications over the internet as illustrated in FIG. 27.

See for example Method G1 for disclosing an invention in pictures. Preferably the disclosure includes pictures and concise text, using a Standard vocabulary per Method C9 for developing a Standard vocabulary. Other methods in the present disclosure may be used.

b. Prepare a description of the invention using a mathematical equation with the Standard terms, see Method C8 for defining inventions and Methods C10, C11.

“(3) ask whether it falls solely within the excluded subject matter;”

c. Tag parts of the description as excluded matter. This can be done by computer, using a DataBase of excluded matter or Artificial Intelligence rules. Preferably a human will review such activities. Alternately, the tagging is done manually.

“(4) check whether the actual or alleged contribution is actually technical in nature.”

d. Tag parts of the description as non-technical matter. This can be done by computer, using a DataBase of excluded matter or Artificial Intelligence rules. Preferably a human will review such activities. Alternately, the tagging is done manually.

“(1) Properly construe the claim;” (cont.)

e. search the prior art—patents, applications, technical publications, etc. Possibly relevant prior art is converted to mathematical equations, and the terms therein are translated to Standard terms.

Translation tables are kept with each such prior art, to make the process traceable and verifiable. Translations may be performed with other languages, such as Japanese, Chinese, Korean, Russian, etc.

“(2) identify the actual contribution;”

f. compare the invention with prior art, using a computer and software which can read and process the mathematical formulas for the above inventions. Differences from each of the prior art articles are pinpointed, and quantized. Excluded or non-technical matter is ignored in identifying the contribution.

g. if the actual contribution versus one or more of the prior art is not significant, repeat steps (a)-(f) to re-define or narrow the invention so to address the identified most relevant prior art; maybe a new search is required for the newly defined invention, and a new comparison with the prior art. The above steps (a)-(f) are repeated until an invention crystallizes which convincingly differs from the prior art in some precisely defined aspects. Of course, success is not guaranteed, maybe this is not a viable invention in light of the prior art; it is better to find this at an earlier stage. If no patentable invention is found, then stop the method, Exit. If a patentable invention is found, the results of the above processing may be used during the patent prosecution, to show and prove what is the contribution distinguishing the invention from each of the prior art items.

“(3) ask whether it falls solely within the excluded subject matter;” (cont.)

g. the results of the computer comparison of the invention with prior art in (f) above are reviewed considering this requirement: Each of the differences from each of the prior art articles are scrutinized to detect whether they pertain in the excluded subject matter.

A DataBase of excluded subject matter items may be maintained at the Patent Office and possibly at the agent's office. It may be necessary since the list of excluded matter is not exhaustive, see paragraphs 8, 9.i) and 9.11) in Aerotel/Macrossan.

A list of standard questions may be applied to be answered by inventor and/or agent.

This process may help pinpoint the prior art over which the distinguishing features are only within excluded matter.

Such differences from prior art should be ignored. The remaining features indicate patentability. If they are not enough, then further review and changes in the inventive concept are necessary, to modify or narrow the claimed invention, by performing steps (a)-(f) above.

Again, success is not guaranteed, maybe this is not a viable invention in light of the prior art and with respect to excluded matter. If no patentable invention is found, then stop the method, Exit. If a patentable invention is found, the results of the above processing may be used during the patent prosecution.

“(4) check whether the actual or alleged contribution is actually technical in nature.” (cont.)

g. The above steps are repeated, the results of the computer comparison of the invention with prior art in (d) above are reviewed considering this requirement.

Corrective steps are taken if possible, else stop the procedure, Exit. If corrective steps were taken, then perform again the above steps (a)-(f) as necessary.

**End of Method**

3. Complex Patents

In complex patents, a more detailed disclosure is required. It may benefit both the examiner and the applicant. The present invention identifies the problem and guides the parties involved, showing how to perform this additional disclosure.

The specific disclosure required may depend on the nature of the technology being protected. The application of this novel approach to Software patents is detailed below.

The present structure of patent applications is practical and efficient for disclosing simple inventions. At present, however, many of the inventions are complex and more difficult to grasp. Also, the number of prior art patents and applications to be considered has greatly increased. Therefore, a new structure of patent application is presented, which facilitates the understanding and examination of the invention.

The new structure implements the applicant's duty of disclosure as adapted to today's complex inventions. For example, in the claim there should be an indication, for each term significant to the disclosure, whether it is a standard term or a special, user-defined term. Otherwise, each time the examiner reads the claim, she has to search the whole disclosure to find, for each term in the claim, how to understand it.

The applicant knows this info, so why not present it in the application? Furthermore, each claim should include info helpful to examination, such as pointers to locations in the disclosure where each term was described. Again, why waste examiner's time to search large applications, when the applicant of course has this info at his fingertips?

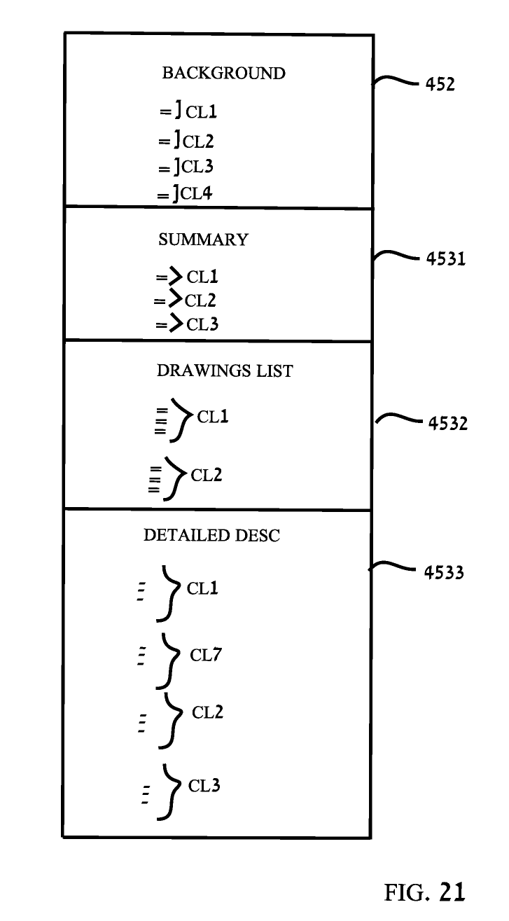

FIG. 21 illustrates a claims-sliced structure of a patent application (and patent).

Each part of the application (Background 452, Summary 4531, Drawings 4532, Detailed description 4533 . . . ) includes an indication, to which claim it pertains—which claim is backed by that part. This allows, during examination of a claim, to find easily backing for the claim in the disclosure.

For example, the Background includes the mention Claim 1, Claim 2, etc. between unique delimiters such as:

“

{claim 1} Prior art PLLs use one wire for carrying each of the reference and VCO signals; this may result in low reaction speed of the PLL.

{claim 2} At present, patent applications do not include specific links between each claim and the corresponding parts of the application, thus wasting examiner's time to try and understand where each feature is disclosed, if at all.

{claim 3} The prior art claims do not include info indicative of Novelty.

”

It may be possible for the parts not to be arranged in an increasing order of the claim number, if that is required for the sake of clarity; It may also be possible that a text segment may support several claims, etc.

Another problem in prior art is that the parts of complex inventions may themselves be complex components. These components allow different implementations of the same invention, making it difficult during examination to decide whether these embodiments (in the present invention vs. the prior art) relate to different inventions.

A new approach to presenting Novelty in an application is disclosed, which facilitates comparison with the prior art in complex inventions. The new approach conforms with approaches in other aspects of patenting practice. The new method benefits both the examiner and the applicant, for both desire to have the issue of novelty solved as soon as possible.

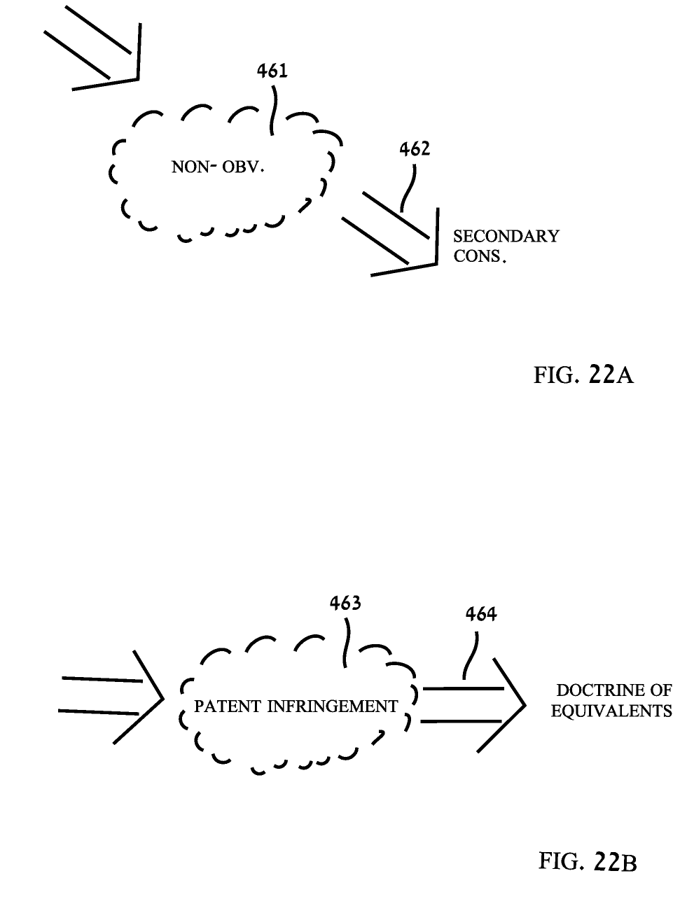

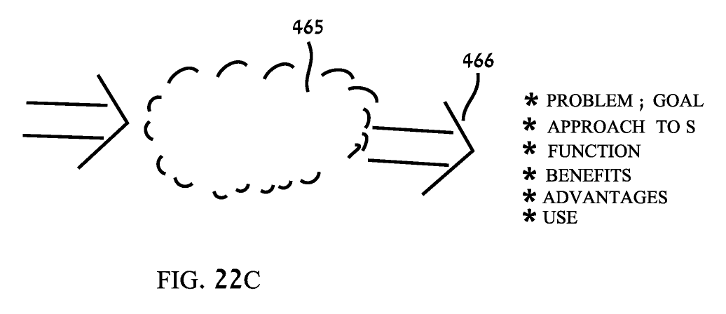

FIG. 22 presents a novel approach to checking for Novelty, which may be useful especially in complex inventions such as Software patents.

At present (see FIG. 22A), Non-obviousness 461 may be proved with Secondary Considerations 462. This is a most useful method, since it may be very difficult to define the non-innovative person skilled in the art, in that specific art, at the time the invention was filed.

The test 462 is indirect, Non-obviousness is inferred from its effects or symptoms which may be more easily tested.

Similarly (see FIG. 22B), patent Infringement 463 may be proved using the Doctrine of equivalents 464, again an indirect test.

A new method (see FIG. 22C) is now presented to test for Novelty, also using an indirect test. The method checks for various parameters which may affect or be affected by the Novelty of the invention, and use these parameters to decide on Novelty. These parameters may include, for example:

the problem to be solved, or the stated goal of the invention

the approach taken to solve the problem or achieve the goal

the function of the novel invention (what it does)

the benefits or advantages over the prior art

uses of the invention.

Indirect Criteria for Novelty may be defined as various combinations of the above, for example: if an invention under examination addresses the same problem as a previous patent, using the same approach and achieves the same benefits, then it may not be novel.

This criterion may be used, for example, to compare software modules which are written in a different code, possibly in different computer languages.

Indirect criteria for proving Novely may be defined by the Authorities, if they decide to do so.

Accordingly, in a novel patent application structure according to the present invention, such information which may be indicative of Novelty using suitable info may be provided.

4. Software Patents

Software-related inventions require a specially adapted version of the Complex Patenting technology detailed above.

This is based on applicants'e experience and knowledge as computer programmers, the present applicants have experience in the various aspects of software development.

1. Patenting of Software Inventions

a. Much has been written about the patentability of software. The present invention is about applying the standard patentability tests. In U.S.A. for example, it is compliance with 35 U.S.C. 101, 102, 103 and 112; and taking into account the special properties of software.

b. Software is a most powerful medium for expressing an inventor's ingenuity and innovation—there are almost no limitations, very complex methods and structures can be imagined and precisely implemented. The programmer can control the precise behavior of an airplane or car engine with a split microsecond measurement and correction, etc.; on the other hand, software is just as powerful in the hands of a non-inventor to obfuscate matters, to create the appearance of an invention when actually there is none . . . a huge complex program is easily generated, taking hundreds or thousands of printed pages . . . and without a single patentable invention there.

c. Due to the complexity of software, more documentation is required to properly describe it and allow its examination.

This will not impose additional work on the applicant, for the information is already there—it is generated when the software is being developed. Just as this info is required by programmers to create the software, so it is also required by the Examiner so he can examine it.

Since the applicant has this relevant info, it is his duty to disclose it.

d. Software is difficult to understand, even to professional programmers. A software product may be the work of a group of programmers over a prolonged time period. Thus, even with all the relevant info available, it may be difficult to examine software.

According to the present invention, the examination is facilitated using novel Patentics^{SM} method herein disclosed.

Thus, a method for achieving a quality software patent includes:

1) Prompting or guiding the applicant to include all the relevant info in the application, to allow its efficient examination.

2) Organize the info in a machine-readable form, to be processed by computer; process the info in the computer; all according to the legal patentability criteria. This is implemented using the novel Patentics^{SM} method.

2. The Methodology of Software Development

Let us describe the software development method and the generation of info which is also relevant to the patentability examination. There are several stages or layers in software development; one or more of them includes patentable subject matter (otherwise there is no reason for applying for patent). The method may include:

a. Devising the concept of a new software—what the software should do, how should it be implemented and what would be the benefits over existing software. Usually software development is an expensive endeavor, performed by a group of (highly paid) professionals in a commercial firm or other organization. No such activity will begin before a clear concept is devised and the desirability of the project is evaluated—technical feasibility, what benefits it will bring and how these benefits will be achieved.

The info to be shared with the examiner may include:

1) how the invention is made and used; what is the invention at the concept level, if any. (Art. 112)

2) what patentable (not excluded) matter does it include (Art. 101)

3) what are the differences between this concept and prior art? (Art. 102)

4) what are the benefits of this concept over prior art? (Art. 103)

It may be easier to prove non-obviousness using the “secondary considerations”.

b. Prepare a complete specification of the software: a definition of the blocks comprising the software, the interconnections between the blocks, the interface with the user and with other machines, menus displayed, options available to each type of user, etc.

Again, info required to understand the software at this stage should be shared with USPTO. Especially important are changes made to stage (b) and/or (a) responsive to problems encountered in (b), for solutions to problems not expected in prior art may themselves be distinguishable from the prior art.

c. Product design

the function of each block, how the blocks are interconnected, hardware requirements such as memory required, processing speed or response time in real-time systems, computation precision/number of bits used.

The info presented to USPTO may include that as detailed above.

d. Detailed design

e. Coding—writing the actual computer program, which can be translated into machine language and executed in a computer.

f. Integration and verification—the various modules comprising the software are operated and tested together.

The process may move sequentially from the first stage to the last, however it may also move in the other direction or skip steps as necessary.

For example, during a specific stage it may be found that the parameters set by a previous stage are not practical; that previous stage may be reviewed and its output possibly updated.

1. Possibly it will implement a new function which was never done before; or it may execute a known function but achieving superior performance; or maybe it is a “me too” software, when the competition has that software and would not sell it to us. In the latter case, the software is not entitled to a patent for it does nothing.

2. patent-related aspects of software

patentability—the Supreme Court refrained from making a specific decision, whether software is patentable or not, and rightly so:

There is nothing specific to software which makes it patentable or not, rather the application of patentability criteria is more difficult for software. The President's Report on patents 1966 said just so:

The software under examination can be checked using the criteria set in para. 101, 102 and 103 of the US Patent Law, just like any other invention.

Where required documentation is missing—it can be requested of the applicant, who is under the obligation to fully disclose the invention.

Indeed, the application of the patentability criteria may be difficult, for software tends to be large and complex. The problems, however, can be addressed using a scientific approach to patenting (Patentics^{SM}) as disclosed in the present application and demanding the applicant to file a Quality Patent Application per the guidelines set forth in this application.

Due to the complexities of software, it is easier to obfuscate matters, but one should keep in mind that:

a. the same patentability tests can be applied to software, and

b. it is applicant's duty to provide the information required for the application of the patentability tests.

The information required is just the existing info generated during software development, see (1) above:

in each stage (1-8 above), there is a definition of a structure (apparatus) and method of operation (method), these may be novel, or maybe not.

There is also a well-defined benefit or advantage over competition—this may be an argument for non-obviousness (“secondary considerations”).

if patentable matter is found in a stage of the software development, this is a basis for patent; patentable matter may be found later, when problems are encountered and new solutions are developed. Working, practical novel solutions to unexpected problems may be legitimate patentable inventions.

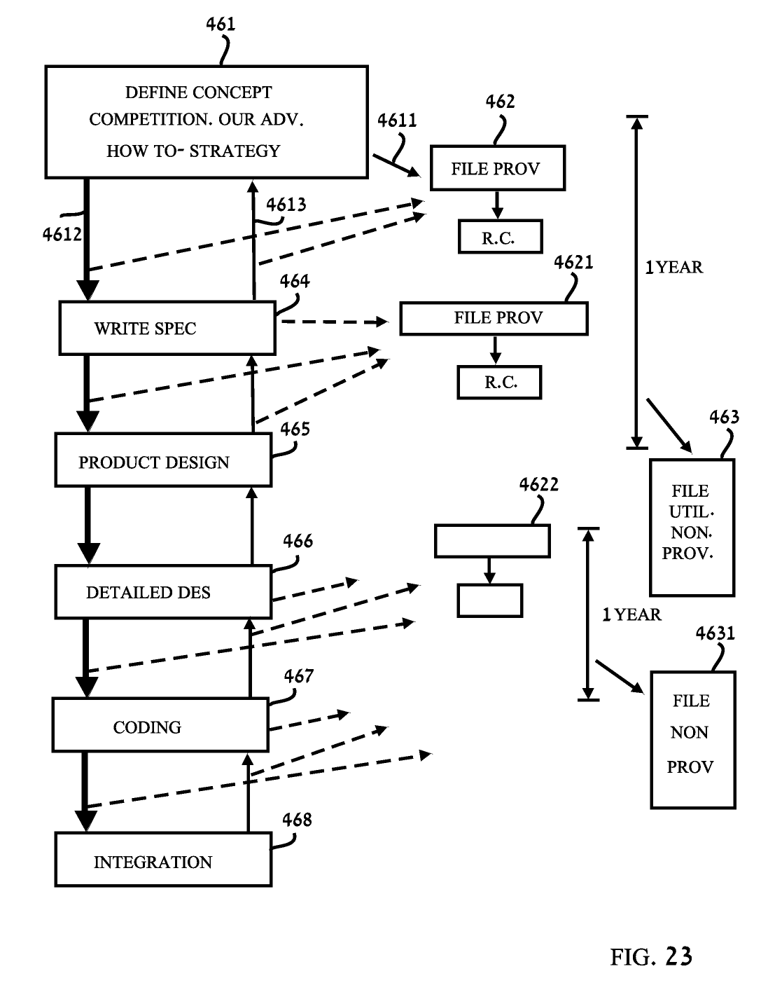

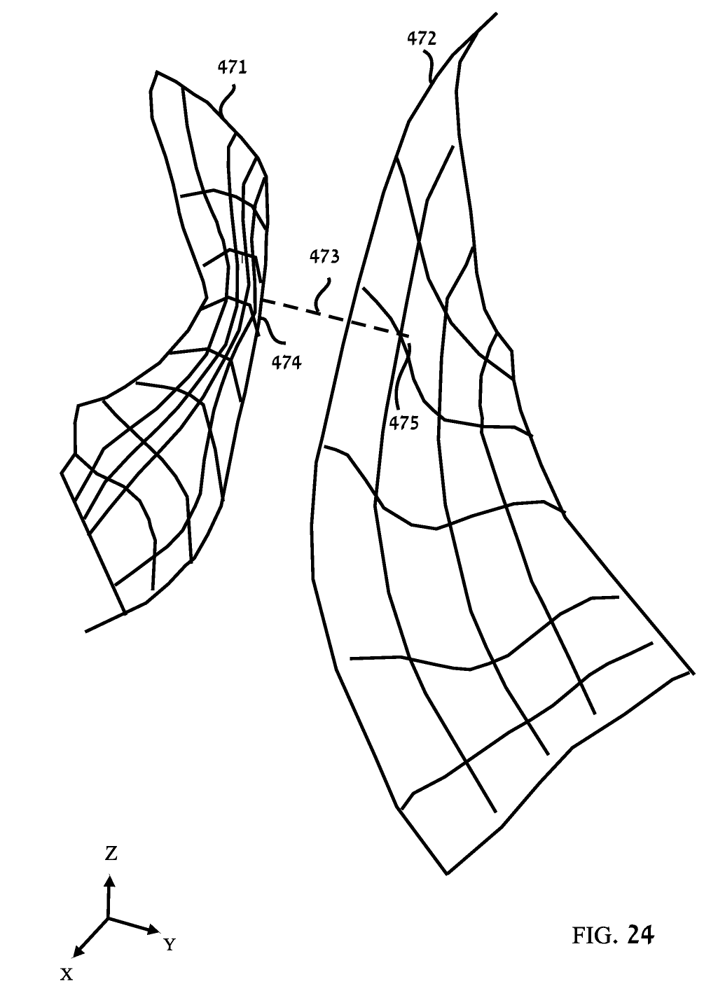

FIG. 23 illustrates typical stages in developing computer software, using accepted practices in the software industry, and a method for presenting software inventions created in the process.

Copious documentation is produced during this process, which may be advantageously used to examine the patent application.

Typical stages in software development may include:

concept definition 461

writing the spec for the software 462

software product design 463

detailed design of the software 464

coding 465—here the computer program is written, in a mnemonic language,

then translated into machine code executable by a computer integration 468, where various modules developed in (465), possibly by different programmers or programming teams, are activated and tested together in a complete, integrated computer program or software.

There is the usual flow of development down the blocks, as illustrated with arrow 4612 from block 461 to 464, etc. The results of one stage are used to implement the next stage.

There is also the reverse flow, for example when there are problems with implementing a stage, or a better way is found—this requires a review of the previous (higher in the hierarchy) stage.

It would be mistaken to believe that any software is patentable, just because it is large and difficult to grasp—maybe this is just an ordinary work performed by people skilled in the art.

On the other hand, each stage in the software development opens opportunities to innovation, for example:

When the software concept 461 is devised, a firm's managers review the present software of own firm and others' and devise a novel approach, a novel structure or use which will give us an advantage; this may be a patentable invention.

A report 4611 may indicate the problem or goal contemplated, and the novel solution devised in response.

A provisional patent application 462 may be filed for the invention, or an utility non-provisional application. Preferably, a copyright may be registered as well.

As a result of the concept definition, an innovative concept may be finally drafted and passed down 4612 to the next stage 464. This novel concept may be patentable as well.

During the spec writing stage 464, it may be found that no effective spec may be written for the present concept because of various problems or if an inferior product may result. Updates to the spec may be suggested 4613, possibly innovative solutions to the extant concept. These updates may also form the basis for an innovation in the software.

Please note that, at this stage, there is no computer code at all—the invention may relate to a method of operation, menu to user, high level communication protocol, data structure, definitions of hardware, etc.

Thus, a complete description of a software invention may include details as pertaining to the above process—in what stage of the software development was the invention devised? What was the problem, what is known in prior art, what is new in the new approach and what are its benefits?

All the criteria for patentability can be applied to software, once there is an adequate, complete disclosure allowing an intelligent decision.

FIG. 23 also illustrates a patenting strategy: as soon as an invention is identified, a provisional patent application 462, 4621, 4622, etc. can be filed. The applications accumulated during one year may be integrated in one non-provisional utility application 463; if these are different inventions, then separate non-provisional applications can be filed, as known in the art. A copyright may be registered after each provisional filing, for the same material as filed in the provisional.

FIG. 24 illustrates a method for comparing software inventions to decide on Novelty, for example:

a. A software module or product 471 under examination may be presented as a multi-dimensional vector (see details elsewhere in the present disclosure). For example, the vector for ea

b. A second software (prior art) 472 may also be presented as a multi-dimensional vector.

c. There may be different aspects or embodiments or coding versions or views at different levels of software development, of both software products—these are presented as points on the surfaces 471 and 472.

d. A computer program may be devised, to store the vectors for software 471 and 472 (or a plurality of vectors 472 for several prior art software).

e. The computer program computes the distances between points on the surface 471 and surface 472 (actually this may be a multi-dimensional vector, not just a tri-dimensional vector), for a plurality of points on these surfaces.

f. The computer finds the points most close to each other 474 and 475, corresponding to a minimal distance 473. Actually, there may be a plurality of such minima. These pairs of points are presented to an examiner during examination, or to the applicant or patent attorney during a patents search.

i. A person may then compare two software products, by comparing their most similar representations or structure at a similar level. If they differ on those points, one can assume that they are different inventions.

**End of Method**

Notes:

1. An important aspect of this invention is that a large computer effort may be required to perform many comparisons of complex vectors, until that most similar aspect is found and presented to a human.

2. Performing this huge automatic processing can be done using the methods disclosed in the present invention.

This allows to perform an effective comparison of software inventions in a short time, to facilitate the examination and to achieve quality patents.

3. For example, the vector for each software may indicate:

a. the type of software: signal processing, communications, operating system, user interface menu, etc.

b. level of development, see for example the stages of software development in FIG. 23

c. the language of the software

d. the function of the software: may be defined using keywords or a Boolean, logic equation for example.

5. Multi-IP Protection

It is possible to claim several types of IP protection in one invention. For example, the functional aspects may be protected by an utility patent; non-functional forms—by a design patent; the expression of the invention in text, drawings and computer programs—by copyright, etc.

Possible IP instruments may include utility patent, design patent, copyright, trade mark, service mark, trade secret, moral right.

In each case, a strategy should be devised to protect those inventive aspects which can protected, and using the suitable IP instruments.

Sometimes, actions to protect one type of IP may forfeit inventor's rights to other type(s) of IP: for example, if a patents search is made, it may endanger inventor's right to copyright; if a product is used in commerce to establish trademark or service mark rights, the inventor may lose his rights to obtain a patent for a subsequently filed application.

If a proper strategy is used, however, such interference between different types of IP can be prevented. Moreover, activities to achieve one type of IP protection may actually contribute to also achieving other type(s) of IP. For example, in a patent application other IP instruments may be claimed as well, for example the mention of inventor's trademark or service mark, copyright and moral right claims.

Trademark position is stronger if the product was used in commerce, however if no IP protection is available, then others may copy the product and the intended mark itself; then the entrepreneur may be driven out of business, or his mark may cease being unique, this preventing the mark's registration.

The money factor should not be ignored, for it is ever present in IP protection proceedings: Government fees should be paid to file for, and register, IP rights. Moreover, for such activities at the patent office or in Court, the services of a professional are usually required.

To generate the required cash, it is preferable to achieve IP protection as soon as possible, to allow cash-generating business activities in the early stages of commercializing an invention. If successful, IP protection and business growth will develop together, feeding each other.

For a sustained success in business, IP protection should be available for prolonged time periods. Each IP instrument has a different time coverage property (the earliest time protection is achieved, and for how long), and a different cost/effort required for its registration.

Again, IP protection strategy should take these factors into account.

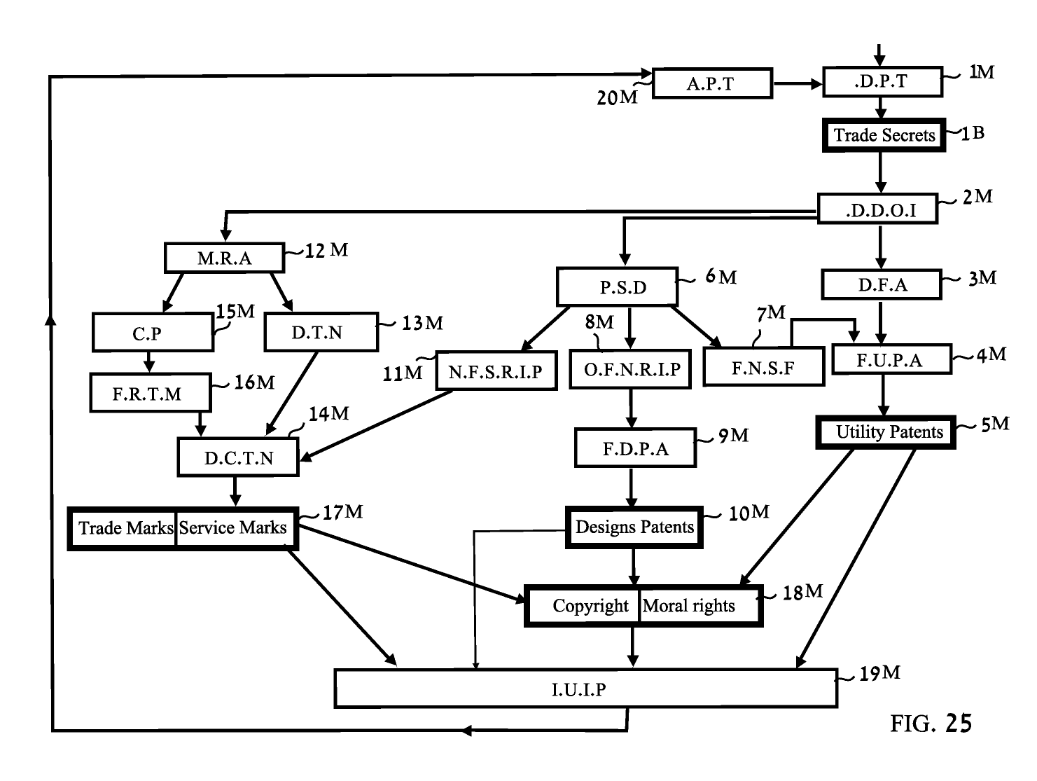

FIG. 25 details the LIM-IP^{SM} method—an integrated, coherent approach to multiple-IP protection of inventions or new technologies, including:

1M. Define proprietary technologies owned by a person or a firm.

1B. Identify and protect Trade Secrets, using accepted practices. This is the first line of defense for protecting IP, also the fastest and not so expensive.

2M. Delimit and define an invention to protect now, based for example on the business aspects of the invention and its implication on company's operations.

3M. Define functional aspects of the invention—the invention may have various aspects, such as external appearance of the product, a catchy name, etc.

4M. File utility patent applications for the functional aspects of the invention and for non-exempt patentable matter. May first file a provisional.

5M. Utility Patents—granted

6M. Product/service design—this is a common activity relating to commercializing a new product. Incidentally, it may result in novel functional and/or nonfunctional features for which IP protection may be claimed.

7M. Functional shape/form—may be patentable (utility patent).

8M. Non-Functional shape/form, which is not related to identification of the company—may be patentable (design patent).

9M. File design patent applications

10M. Design Patents—granted

11M. Non-Functional shape/form which is related to identification

12M. Marketing-related activities

13M. Devise, create Trade names

14M. File to register Trade Marks and/or Service Marks, also clearly indicate this claim on company's publications, services and products

15M. Create/design package for product or service

16M. Devise, create Trade names

17M. Trade Marks, Service Marks registered

18M. Register Copyright, also including Moral Right

19M. Identify unprotected IP

20M. Add to proprietary technologies owned

**End of Method**

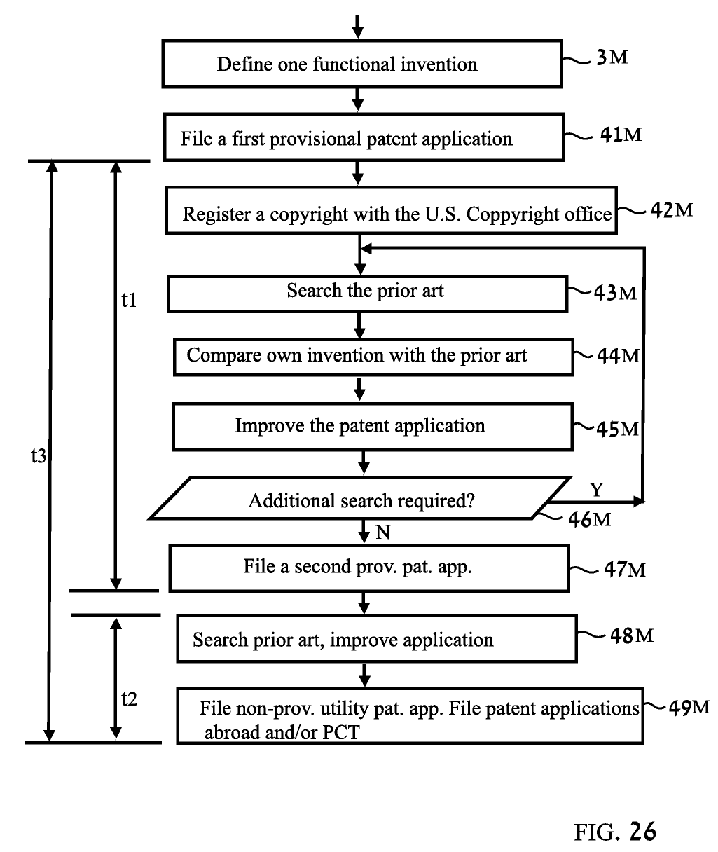

FIG. 26 details the LIM-IP^{SM} method—an integrated, coherent approach to multiple-IP protection of functional inventions

The focus is on utility patent protection, however other types of IP protection may also be achieved in the process.

3M. Define one functional invention

41M. File a first provisional patent application.

In another embodiment, a nonprovisional utility application may be filed now. There are various advantages and disadvantages in each approach, from business and legal/patenting considerations as known to persons skilled in the art.

42M. Register a copyright with the U.S. Copyright Office. The copyright registration achieves various benefits for its owner.

43M. Search the prior art—After a copyright was registered for applicant's original work which was not affected by other's work.

44M. Compare own invention with the prior art. Maybe the inventor did not use the standard, accepted terms for that discipline, maybe part of the invention is not new, maybe some parts of the application need to be made more explicit or some problems be addressed.

45M. Improve the patent application accordingly.

46M. Additional search required? if Yes then goto (43M)

An additional search may be required if the last search did not use the right terminology or search strategy, as become apparent upon analyzing the last search results for example.

47M. File a second provisional patent application.

In another embodiment, a nonprovisional utility application may be filed now. There are various advantages and disadvantages in each approach, from business and legal/patenting considerations as known to persons skilled in the art. Timing is important, the second application should be filed within as short a time t1 as possible. Since there may be significant improvements in the second application (47M) with respect to the first application (41M), the priority date provided by the first filing may be insufficient; thus it is important to have as early filing date as possible for the second filing (47M).

48M. Search prior art, improve application—preferably a short time t2 before drafting and filing the non-provisional in (49M). Things may have been changed during the time form the previous filing, changes that should be addressed.

49M. File non-provisional utility patent application, claiming priority from the provisional(s) filed within the last year.

The non-provisional should be filed within a time t3 less than one year from the first filing (41M) and any intervening filings.

At this stage, it is required to also File patent applications abroad and/or Patent Cooperation Treaty (PCT).

**End of Method**

Method T1 for Unified Intellectual Property Protection

FIG. 32 details one embodiment of a unified method for assisting in achieving intellectual property IP protection as suitable for each invention. Various aspects of the invention may require different types of IP instruments. Several activities may be concurrently performed, as the need be.

In one embodiment, the method includes:

a. Defining the invention: 41

by the inventor, assisted by the patent agent.

1) The inventor describes the new system and/or method. Advantages, benefits. For a computer program—computer code or a plurality of codes and/or computer menus, etc.

2) The patent agent, preferably using forms, questionnaires, computer modeling and simulations and other means, will challenge, provoke, stimulate, guide and help the inventor, to enhance the inventor's disclosure, to prepare a more complete disclosure of the invention.

3) The activities in para (1), (2) above to be performed before the inventor is exposed to the prior art. The enhanced disclosure is written together with drawings, recorded and/or otherwise put in a tangible form.

4) The activities in para (1), (2), (3) above to be performed during person-to-person meetings and/or using various telecommunication means.

5) Other info is gathered which will affect the IP protection strategy, including details on the inventor (experience in this field, etc.), the present status of the project (patent applications filed, practical tests to prove the concept, basis for benefits assumptions, etc.), the goals for this project (geographical coverage required, timetable to pursue commercialization, commercialization strategy, etc.).

6) Planning a total IP protection strategy.

The complete disclosure is reviewed by the patent agent to identify parts/aspects thereof which may be protected by various IP instruments: patents, trade marks, designs, copyright, moral right, trade secrets.

According to the strategy devised, activities will proceed to file a patent application (42), perform a patent search (43) and/or perform other IP protection activities (4A).

7) The inventor, however, may decide to skip the above steps; he may have already decided to file a patent application per his written description, for example, or start with a search. He does not want advice nor strategy planning. In this case, the system may proceed to step 45 or 47 for example.

b. Filing an urgent preliminary patent application 42:

Without exposing the inventors to the prior art.

Presenting applicants' unadulterated, original concepts.

Preferably—the patent agent, with the support of the system and method herein presented, questions the inventor to stimulate him/her to fully disclose the novel inventive concept(s), address gaps in the disclosure coverage, explain/define unusual terms used by inventors, etc.

As a minimum: File inventor's material with minimal corrections, Or a short description of the invention. Including for example one Claim, draft of drawings, without applicants' Review.

Sometimes formal changes may be necessary for the application to be accepted at a specific Patent Office; these changes should then be made accordingly. Preferably, an enhanced, detailed application should be prepared in a short time; it is possible, although this approach may be rather expensive. To do: Preferably Within 1 week.

Rationale: A preliminary application, even if imperfect or incomplete, may present a strong claim to an earlier filing date. Lack of such an application may result in lack of a priority, which sometimes may be of a critical importance. Interpretations vary, there is the First to file vs First to invent issue, etc., however: a significant advantage can often be gained by this Preliminary filing.

c. Patents search, initial 43

New patent search, Initial international search or search at the US PTO for example. May be performed by the patent attorney or the inventor.

To do: Preferably Within 1 week.

d. Preparing other IP protection means: 4A. These may include, for example, trade marks, designs, copyright, moral right, trade secrets.

e. Studying search results for improved definition of the invention 44. Improved definition of the invention, to distinguish from prior art. Consulting with experts, ie to enhance weak points in the disclosure.

To do: As soon as possible.

f. Editing and submitting a complete patent application 45.

Preferably, a full disclosure of the invention is prepared by the patent agent with inventor's cooperation.

Including a glossary for defining inventor's unusual terms in use, or a translation of such terms to the terms accepted in prior art.

After the disclosure is completed, an in-depth search may be performed, prior art studied and the application may be enhanced to include additional matter if required.

Claiming priority (or specific partial priority) from the preliminary patent application filed in (42), and/or possibly several priority dates from several prior filings.

The application may include applicant's review and specific corrections according to the applicants' notes.

To do: Within 1-2 months.

A common misconception among inventors is that a preliminary (or provisional) application confers protection beyond the actual disclosure therein presented. The inventor then waits one year before filing a complete patent application, sometimes with disastrous consequences.

To benefit from the earlier date, the claims in the complete application should be fairly based on the disclosure in the preliminary application. In the present invention, steps (43)-(45) are performed as soon as possible, to earn as early a filing date for the extensive, complete patent application. A new document structure as detailed with reference to FIGS. 13, 14 for example may be used in conjunction with these filings.

g. Accelerated search and examination 46. This step is optional and involves additional expenses. This procedure may require the approval of the Patent Office authorities, according to relevant patent laws.

Granting of a patent is conditional upon the result of an examination of the application, and possibly allowing for opposition by the public prior to final grant of the patent.

h. Additional patent searches 47. Various types of searches may be performed, according to applicant's protection strategy. Possible strategies and possible searches are further detailed in the present disclosure. Preferably, the amount of time and money spent on searches should be commensurate with the planned effort in filing applications worldwide [48]. Other considerations may apply, for example planned expenses in R&D, marketing, etc.

i. Filing patent applications worldwide or an International patent application PCT 48. This step should be completed before the end of one year from the priority date of (42)

j. If another invention is discovered, for instance during product development, then repeat steps a-i above. 40

***End of Method***

Notes 1. Steps 42 to 48 should be performed within one year (428), so the overseas or international applications (step 48) should benefit from the priority date of the initial application (step 42). Similar deadlines relating to other IP protection instruments should be observed as well.

2. The above steps are optional; which steps to perform may depend on customer's filing strategy. For example, steps 42 to 44 may be skipped so the applicant just files the patent application (45). Or, after performing the preliminary search (43), the applicant decides no further action should be taken.

3. Two or more stages may be performed concurrently, according to circumstances and as directed by relevant law.

4. Sometimes it may be preferable to file the initial patent application without reviewing the prior art. The reasons may include, among others:

The application can be filed earlier, to gain an advantage in filing date;

the inventor may be discouraged or intimidated by the prior art, this interfering with his capability to fully express his invention;

exposure to prior art may later rise questions of copyright infringement;

exposure to a solution to a problem may prevent the inventor from developing an original solution of which he may be capable—the known solution will pop up whenever he thinks on the subject.

Such considerations may be still more important in computer-related inventions or those relating to the Internet.

The system may present the various options (file first or search first) to the user, who may decide on his/her preferred strategy.

6. Communicating Inventions and Invention-Related Processes

At present, each activity relating to patenting is custom-made: performing a search, drafting a patent application, answering to an Office Action, etc. The present invention discloses a method for standartizing the process, by converting it to standard modules or blocks, which can be understood by both applicant and patent attorney, or one of them and the examiner.

In the future, the applicant may be able to shop around for a specific service, a well defined task to be performed.

see also (1-3) below:

(1) A communications system and method for supporting a dialog between inventor, agent and Patent Office using advanced computer and communications tools adapted to patenting; which hardware to use for each task according to patenting considerations, and using methods adapted to the tasks. See for example FIGS. 1, 2.

(2) Define the invention in pictures, in dialog between inventor and agent. The pictures may include mechanical/electronic drawings, block diagrams, flow charts, tables, etc. Use picture processing methods for drafting and prosecuting the patent application. See for example FIGS. 5, 25.

(3) Method for guiding the inventor through the patenting process, using the Internet. Various choices are explained, then the inventor can choose a strategy to pursue—whether to perform each recommended task, and how much to invest in it. See for example FIGS. 3, 4.

(15) Safe Paper™ for reliable transfer of invention documents

(1) Communications System and Method

FIG. 27 illustrates a communications system for supporting a dialog between inventor using PC 31, agent office 322, agent's internet site 32, and the Patent Office site 332.

Preferably, the inventor's PC 31 is used for preparing the text and drawings an invention description, for acquiring pictures of a prototype or various documents using a web camera for example, etc. The invention is kept secure in inventor's computer until the inventor decides to disclose it to an agent. Furthermore, the inventor preferably uses a removable media such as a disk-on-key to store the invention, so it may not be available over the internet unless he so desires.

Moreover, the PC 31 may include a program from the agent's website 332, to perform an initial, automatic selection process: if the invention is outside of specific criteria defined by that agent, the dialog agent-inventor will be terminated. For example, an agent may not handle specific areas in which he does not specialize or to prevent a conflict of interest; the agent may refuse to accept a perpetual motion invention, etc.

This initial screening prevents an invention's unnecessary and premature disclosure where it may not benefit the inventor.

Rather than a PC, unit 31 may include a laptor or palm computer, connected by wireless. Broadband links may be used to communicate effectively from any place, for example to present the agent with an invention in a remote location, such as an oil rig, or even overseas. Unit 31 may be a cellular phone with camera, for sending photos of the invention. SMS messages may be used to convey the dialog with agent.

The initial screening may be performed automatically at the agent's site 322, using predefined criteria and a questionnaire presented to the inventor.

Further steps may be performed for the inventor and agent to get acquainted with each other, as detailed in the present disclosure and, if both parties agree, to disclose the invention and start work together according to a plan.

Multi-channel communications may be implemented between the inventor, the patent agent and the Patent Office, including transfer of text, drawings, pictures, digital voice, etc.; video-conferencing is also possible, all in an integrated environment conducive to pursuing the protection of inventions. Most of these communications may be performed over the Internet 35.

On the Client side (there may be a multitude of such clients), there may be a personal computer PC 31, using for example a browser 312 such as the “Explorer” or “Navigator” software, possibly in conjunction with Javascript software 313, displaying for example Web pages.

The client may be connected through the Internet 35 and/or an intranet, etc. to a Server side (the patent agent's site—there may be many such sites): Server 32 running a suitable application such as Perl, to maintain a Website 322, such as Patent4u^{SM}, and supported by a database 324, which may be implemented as known in the art.

The client may also be connected through the Internet 35 and/or an intranet, etc. to another Server side (the patent office site—there may be many such sites, one official site for each country): Server 33 running a suitable application such as Perl, to maintain a Website 332, such as UK IPO, USPTO, etc. and supported by a database 334.

Using this structure, for example, a customer 31 may connect with a patent agent office 32 for performing various activities relating to protecting an invention.

The agent office 32 may perform such activities with the client, may also connect to a patent office 33 as necessary, or may assist the client 31 in connecting directly with the patent office 33, as deemed necessary.

The patent agent's office 326 may connect through the Internet to its server 32 as required. The office 326 may connect with the customer using other communication channels, for example using cellular services or other wireless services, POTS, the mail, courier services, etc. The system may also use a cellular phone site 36 over the Internet.

The patent agent may communicate with the applicants and the Patent Office. Patent applications may be filed online where possible, for example in Great Britain and U.S.A.

The goal of the present invention is to contribute to communication between the people involved in the process of patenting, whether they are at separate locations or meet in person. In the latter case, the system may be used to enhance communications by transferring files, supporting changes made on the spot, verifying data, etc.

The system supports personal meetings between patent agent/attorney and customer, or between agent and Examiner.

The above dialog may use, for example, the Method C12 for defining inventions and/or the Method C9 for developing a Standard vocabulary.

Method C1 of Communications with Customer

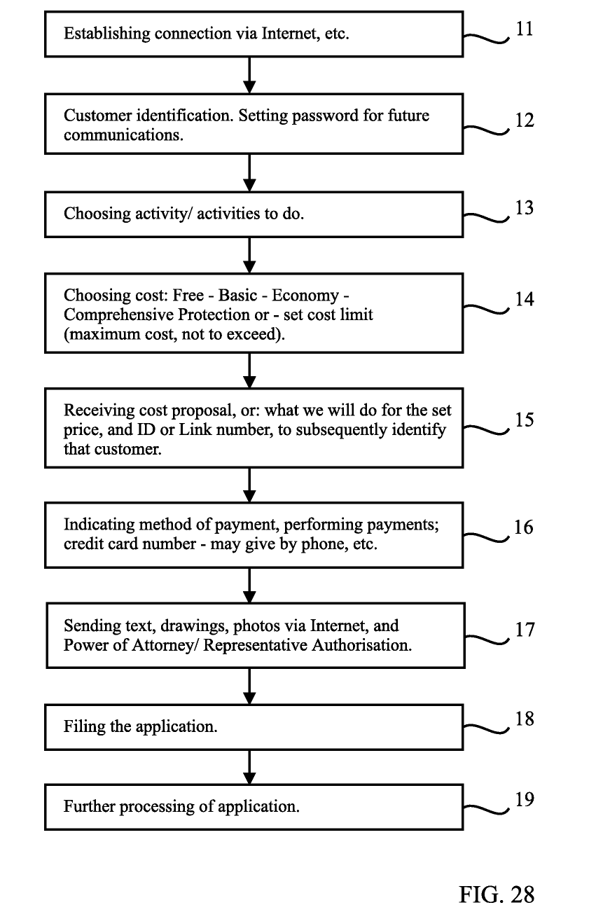

FIG. 28 details a method for patent applications drafting and filing using the Internet 35 and other telecommunication channels. The stages include:

a. Establishing a connection via Internet [11]. A system configuration as shown in FIG. 27 may be formed for the present transaction.

b. Customer identification [12]. Setting ID, password and other parameters for future secure communications.

Formal info may be provided, such as: designate inventors and applicants, addresses, his right to file patent application, nationality, employment status, restricted inventions such as relating to armament or atomic energy. Disclose all the information which may affect the right of the customer to file at all, and if permitted—any legal or contractual limitations.

c. Choosing activity or activities to perform [13]. These may include:

define filing strategy;

the application to file—formal aspects: where to file, history of filings in this invention; prior filed applications or patents granted;

field of the invention (without disclosing the invention itself): select from list;

deadline or desirable filing date;

material prepared by applicant: none—number of pages text, drawings, pictures . . .

Preliminary work definition:

Problematic issues, what bothers the inventor: Technical feasibility (will it work?) ; patentability (is it patentable?) maybe vs. a specific prior art patent known to him;

IP protection strategy (what is the proper protection for this invention: maybe patent, design, trademark, copyright, or a combination thereof?); business issues (where to file? what to do after filing the application?); Other issues of concern to applicant.

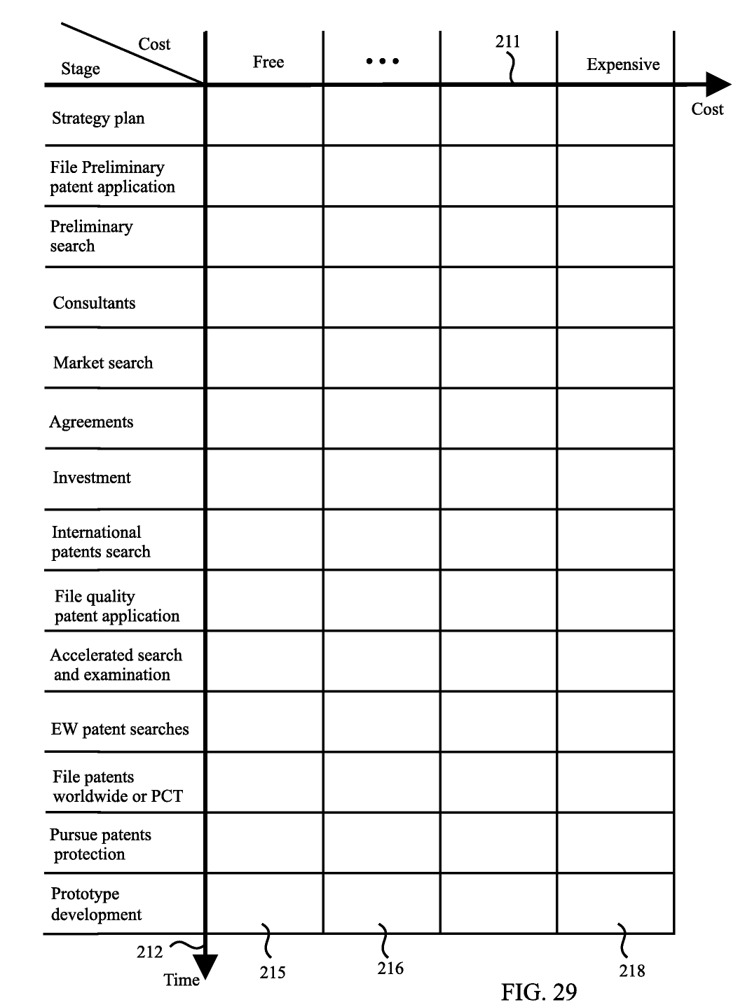

d. Choosing cost [14]: Free—Basic—Economy—Comprehensive protection (Expensive) or—set cost limit (maximum cost, not to exceed). The cost issue is further addressed, for example, with FIG. 29. Preferably this is not an explicit amount or amount range, but a basic approach—how important the issue is to applicant, then he/she will be guided to an appropriate strategy.

e. Receiving cost proposal, or: what we will do for the set price, and ID or Link number, to subsequently identify that customer. [15]

Including Patent agent's evaluation and decision: can we take it?

The decision may be automatic, based on predefined algorithms; if necessary, the system will report and wait for a human's decision.

technical aspects—proven concept? how?

business aspects—planned activities after filing

cost/budget for filing.

f. Indicating method of payment, performing payments [16], for example by credit card number—may give by phone, etc.

g. Sending an invention description using text, drawings, photos via Internet and Power of Attorney/Agent Authorization [17]

Various multimedia means may be used, such as text, voice, pictures, video clip, video conferencing, a combination thereof, etc.

A multi-session dialog may be performed between inventor and patent agent, to better define and describe the invention.

Preferably, a quality application should be drafted, which uses the vocabulary accepted in the specific field of the invention, etc. as detailed elsewhere in the present invention. Consulting with experts in the field is recommended where necessary.

h. Filing the application [18] subsequent to drafting it and possibly implementing several iterations/review cycles with the applicant

i. Further processing of application [19]

***End of Method***

Method C2 of Communications with Customer

The system has two separate distinct states: neutral, public info; confidential invention-related.

At any moment, the inventor is presented a display with an indication what is the present state, Public or Confidential.

The system will change to confidential state only if both sides agree to order a service, for example in Client-Representative State CRS.

The office's site will present the terms of work with a customer, and will continue only if the customer agrees.

a. Initial contact. Identify potential customer. Answer questions—not to anonymous callers. At this stage there is no disclosure of the invention, there is no transfer of confidential info.

Optionally answer questions, such as “Ask the Expert . . . ” column.

b. Define, agree on what the caller needs. Identify possible problem areas, such as right to file or limitations on filing; Patentability and patenting history issues; Technical/engineering problems or uncertainties; Ownership, inventor's identification; Business-related issues.

c. Decide whether to accept customer; if yes, send proposal—what will do, cost and details about our experience and expertise in this field, etc.

d. If customer agrees—arrange payments, terms of the deal . . . Then in confidential mode: disclose invention.

e. Define IP protection strategy and present to user. Discussing the work to do, cost and timetable, etc.

f. For patent application: Draft, file application. Interactions with applicant regarding search, invention definition, etc.

The interactions inventor-agent may include: Establish the scientific discipline of the invention, then the words used to describe the invention from a relevant Standard vocabulary. The invention is described in Invention formulas^{SM}. The complete application is next drafted.

***End of Method***

Method C3 for Providing Services to a User

General terms for providing the services in this application:

a. Through the Internet as default option. May also use personal meetings, the mail, courier services, bank funds transfers, etc.

b. Using a secure link, HTTPS. There is a “secure corner”, “secure area” in our Internet site, where the customer goes for submitting his/her invention

c. Including payment where required—by credit card or deduct from deposit with us, or otherwise make arrangements for payment, cheque. Our system will offer various methods for payment.

d. Performed automatically at our (agent's) site, without operator's intervention; With a human intervention where required—review of info by patent agent, answering questions, etc.

e. Without installing software in customer's computer may be preferable. There is less danger of viruses or damage to his/her computer.

f. Presents to user our terms, copyright and Confidentiality Policy. If he/she does not agree—the system will terminate transaction, will not receive user's material and will not send an acknowledgment.

g. Using our special software for drawing on-line in Internet where necessary.

h. Filing the application with the patent office—by us or by the customer. In the latter case, we send him a ready-to-file application with specific instructions what to do. The customer is not forced to use a formal representative if he/she wants our help, but to file by himself.

***End of Method***

Benefits to user:

a. easier to perform

b. saves time—meeting patent attorney, travel, parking, etc.

c. saves money.

Method C4 of Communications with Customer

a. The inventor identifies himself before the patent agent office, and receives a password or other means for implementing secure communications in the future. The patent application drafting process may take one session or many sessions. It is important to preserve the invention in confidence throughout the process.

b. The inventor uses the system 32 to describe the invention, to receive information and comments, to answer attorney's questions and/or to perform various tasks as instructed. Furthermore, the system 32 may assist the inventor in connecting to various resources on the Internet.

The system 32 helps select the words used from a Standard vocabulary. The invention is described in Invention formulas^{SM}. The complete application is next drafted.

The parties may use Email, MMS messages, WAP, etc.

c. The system 32 may be used as intermediary, a mailbox between inventor and patent agent—each can access the system at his leisure, upload info for the other party and/or download other info.

In another mode of operation, a real-time RT link may be maintained between the parties, to discuss matters by exchanging text messages or a video-conference or pointing to a picture/drawing being displayed.

d. Wireless links may be used by inventor to receive info while on the move, for example “reading” a patent application which is “spoken” by the computer at 32 using synthetic speech to convey the written text. The inventor can relate to the application and enter comments while commuting to/from office, etc.

***End of Method***

Method C4B of Communications with Customer

a. The inventor and agent getting acquainted, exchanging general information 1S without disclosing the invention itself:

a1. The user visits Agent's Internet site and views relevant info there, including IP protection services offered, terms and conditions, prices.

a2. If the services or terms are not acceptable then Exit, else continue. (Exit means stopping/ending the transaction).

b. Discussing the specific work to be performed and its terms—cost, timetable. If an agreement is reached:

Formalizing the order and making payment arrangements:

b1. User sends a Request for service Without Disclosing the Invention, by answering questions in the agent's site, including:

service sought is patent filing? If yes continue, else Exit

inventor and applicant's details—name, address, phone, email address

right to file—inventor, agreement, will, etc.

has experience in the field of the invention?

has experience in patenting an invention or other legal IP protection?

is this the first application/national stage/divisional/enhancement/other

field of the invention (without disclosing the invention itself)

existing, known similar or related products or patents

concept proven technically? prototype/simulation/theoretic study? working software? will it work? specific concerns or technical issues?

did prepare a written description? how many pages of text, drawings?

where is protection sought? UK, USA, West Europe, East Europe, Asia, Australia, North America, South America, Africa, worldwide

priorities in processing: Speed (or there is a deadline to filing), Low cost/cost limit, Quality patent, extensive protection.

b2. The Request is processed automatically at user's computer or at agent's site—under certain conditions an immediate refusal is issued to the user, for example if the invention is a Perpetuum mobile or in a field not supported by that agent. If refused, preferably no info will be transferred to the agent at all, then Exit.

If not refused, user's Request is sent to the agent, then continue.

b3. Agent reviews the Request and decides whether to accept. The decision may be manual or automatic, per predefined rules. If not accepted—Exit.

b4. If accepted, a replay is sent to user, with a Reference number for this Service and a price quote—a fixed cost is preferable.

Additional conditions/terms or questions may be presented, as the need be. In all subsequent proceedings, the parties will quote the Reference number.

b5. User reviews agent's response and decides to proceed, or Exit.

b6. If there are questions to answer, the user may answer them. If there is agreement to file a patent application, then:

the user transfers the payment as agreed, then continue to next step. If there is no agreement then Exit.

c. Disclosing the invention.

The user/inventor sends to agent a description of the invention. Preferably, SafePaper^{SM} pages are used, to ensure correct transfer of the disclosure. VArious means may be used to send the description, such as email, fax, voice mail, pictures transmission of the invention/prototype, etc. See for example Method G1 for disclosing an invention in pictures.

d. Performing the work as ordered—filing a patent application, etc.

d1. The agent drafts the patent application and formal filing forms.

d2. Is there to be a review by applicant? if no, goto (d4).

d3. The ready application is sent to applicant in paper or Acrobat PDF or Word DOC file format. Applicants answers with his corrections, if any. Agent performs the changes/corrections as required.

d4. The patent application is filed with the Patent Office, and the fee paid. If changes/corrections are required by the user, these are performed prior to filing.

e. Using Electronic communication means adapted to patenting for the above stages will allow a complex interaction in a short time.

Part of the steps may be omitted, to achieve lower cost and/or faster filing.

***End of Method***

Notes:

1. In all the above communications, the parties preferably use the SafePaper^{SM} forms for safe transactions. Each party may acknowledge receipt of any communication, indicating whether it was received OK or with errors. In case of errors, transmissions may be repeated or other channels are used.

2. Preferably, SSL communications are used between the parties to protect the confidentiality of the info transmitted.

3. Processing of info may be performed using Java, Java Script, DOM, JSP, ASP, PHP, etc.

4. Sometimes the invention is found to be complex, and a more in-depth processing may be required. If this is agreed between the parties, then a dialog to better define the invention and its protection may be maintained between applicant and agent. This may delay the one-week filing, but it may improve the quality of the patent.

The dialog applicant-agent may involve many electronic communication means, for example, email, fax, voice description of the invention (phone) or web camera. A web camera allows to transmit pictures of a prototype, drawings, etc. - - - added from qp2b: (2)(3)

(2) Define the Invention in Pictures

Method G1 for Disclosing an Invention in Pictures and Processing It

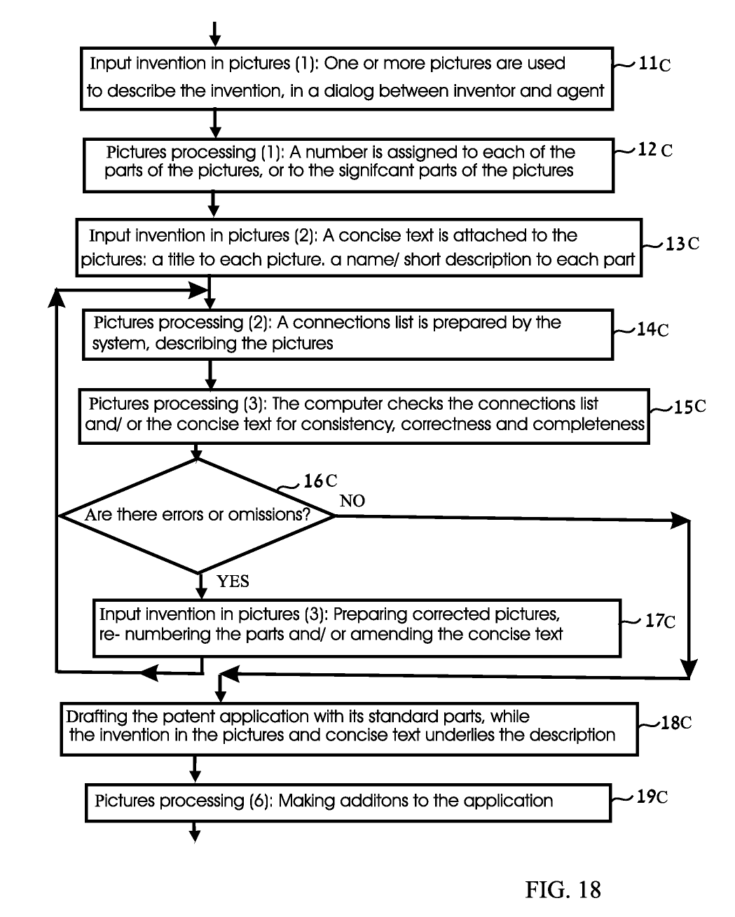

The method may be used for disclosing an invention to an agent, for drafting a patent application, amending the application, prosecuting it, etc. The method includes, see FIG. 18:

a. Input invention in pictures (1): One or more pictures are used 11C to describe the invention, in a dialog between inventor and agent.

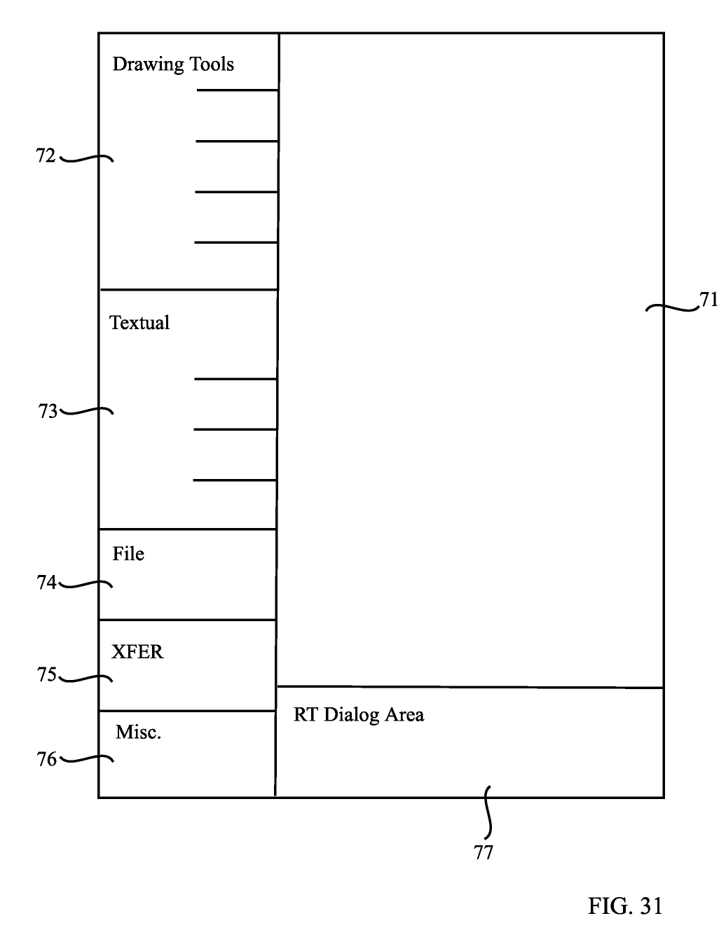

The dialog may be performed over the internet using for example the system of FIG. 27 and the menu of FIG. 31.

The inventor may prepare sketches illustrating the structure and/or operation of the invention; he may bring photos of a prototype in action, or a flow chart or a table with novel aspects of the invention.

The pictures may detail the invention at several instants (samples) in time, to illustrate movement of the parts and/or interactions therebetween; or the pictures may illustrate a system and details of its various subsystems in a hierarchical description. If the inventor's description is verbal or a text, the agent may convert it to pictures and will present it to the inventor for his approval.

b. Pictures processing (1): A number is assigned to each of the 12C parts of the pictures, or to the significant parts of the pictures (some parts are insignificant or are obvious, well known). Numbers may be assigned to groups of parts. Different parts or different types of parts have different numbers assigned to them. Sometimes, identical parts have the same number; sometimes not.

c. Input invention in pictures (2): A concise text is attached to the 13C pictures: a title to each picture, a name or short description to each part, what each significant part does, benefits and novelty in each significant part and/or combinations of parts and/or the operation of the parts and interrelations therebetween. The numbers assigned to the parts in pictures in (b) form the link between the pictures and the text. For example, a motor has number 7 in a picture; the text indicates “motor 7” then specifies the benefit in this part (or the benefit and novelty in connecting it to the output axis 9 though the universal joint 22).

The concise text may include a Terms list with the name of each term used, or group of terms, and its number in the picture/drawing (ie engine 7, pedal 22, display 38).

Preferably a standard vocabulary is used, see for example Method C9 for developing a standard vocabulary. This is important, since the vocabulary forms the basis for subsequent dialog, search, examination, prosecution. Non-professional terms will obfuscate matters or endanger the application. Numbers are assigned to the parts and their inputs and outputs, see for example Method N2—parts numbering.

Pictures processing (2): A computer checks the Terms list for consistency, correctness and completeness, reporting on errors and omissions. If required, preparing corrected pictures and/or re-numbering the parts and/or amending the Terms list so as to correct the detected errors or omissions, in a dialog between the inventor and agent.

d. Pictures processing (2): A connections list is prepared by the 14C system, describing the pictures, see for example Method C10—Structure definition method, with FIGS. 12 and 14.

Preferably, the list is prepared by a computer. It may use a scan of the picture with the user entering the text for each part. The computer can identify blocks, connections, contours of parts, possibly using Pattern Recognition Techniques.

Alternately, the list may be prepared manually or semi-automatically. The list may include for example electrical connections, mechanical relationships (ie supports, axis for rotation, counterweight for), flow path in a flow chart, wireless links, entities affecting other entities, control and sensing paths, etc. For some pictures/drawings it may be difficult to prepare connections lists; in this case, the Terms list in step (c) may be used for further processing/checking, or the concise text.

e. Pictures processing (3): The computer checks the connections list 15C and/or the concise text for consistency, correctness and completeness. See Method G1B—checking the connections list. The checks may be performed for one drawing, and also across several drawings in the patent application being prepared. Errors and omissions are presented to the inventor and/or agent.

If the list only includes parts names (Terms list), then check that the same terms are used for each number in all pictures, that every number has a term associated with it.

f. Are there errors or omissions? If no, go to (i), else continue 16C

g. Input invention in pictures (3): Preparing corrected pictures and/or 17C re-numbering the parts and/or amending the concise text, as required so as to solve the reported errors and omissions, in a dialog between the inventor and agent. The Terms list may be updated if required.

Go to step (d) (14C).

i. Drafting the patent application with its standard parts, while 18C the invention description in the pictures and concise text underlies the description. Keeping links between the application and the above description, for example by numbering the sentences of the application and generating links pointing to them, see for example Method N1—numbering the sentences of an application, and FIGS. 11A-11C.

k. Pictures processing (6): When the inventor desires to make 19C additions to the application, these are first discussed with the agent and performed on (a)-(g); only then the patent application itself is modified accordingly, see (i). The same process is applied for amendments, comparisons with prior art, etc.

**End of Method**

Notes

1. Often, the invention only exists in inventor's head; it is fuzzy, with many aspects unclear. As the inventor puts it in tangible form—pictures, he can see contradictions, uncovered options, etc. Sometimes the invention is completed, finished during this stage of putting it to paper or preparing pictures.

Sometimes the agent will raise a technical question which the inventor has not heretofore considered; that issue is solved using inventor's innovative approach. The invention may grow and become clearer in the process.

During examination, sometimes the inventor reckons that an important innovative aspect is not disclosed. Maybe it was considered obvious by him, or he did not objectively consider all the aspects. At that stage it is impossible to add new matter to the application.

The systematic approach in the present invention helps solve this problem. Thus, the method helps achieve a description having industrial applicability.

2. The pictures representing the invention are processed in their textual representation, to detect errors and omissions; the results are used to create new, corrected pictures. The method is concerned with pictures processing. The criteria for checking the pictures may include both technical/engineering aspects and legal/patenting aspects. The picture processing methods are especially devised for invention-pictures, these are not the prior art picture processing methods.

3. Sometimes, detected errors and omissions are not just technicalities or formalities, but substantive problems in the innovative concept, internal contradictions or differences between what the inventor meant and what the agent understood. These issues are much more difficult to detect after drafting, in the patent application.

4. Correcting the pictures at this early stage is important for achieving a quality patent application with good technical and IP protection. It may be impossible to correct the application later or add new matter.

Method G1B—Checking the Connections List

The method checks the connections list which represents the pictures (drawings, flow charts, block diagram) describing an invention. The method is performed automatically on a computer and includes the following stages:

a. Consistency check: a one-to-one relationship between parts numbers and the textual terms describing them: the same term is attached to a part number, throughout each drawing; no two different numbers are attached to the same term. A specific term/block has the same function in all drawings.

b. Correctness (1): the blocks/components are connected the same way in the various drawings, unless the user approves the difference.

Where the inputs/outputs of blocks are indicated, ensure connections are from one output to one or more inputs; that no two outputs are connected together, unless specifically approved by user.

c. Correctness (2): Maintain a database of types of components in different technical fields, and of allowable connections between them. The computer then compares the connections in the drawings with the database, and warns of unallowed connections.

Where elements require initiation (setting at a defined initial state) such as a digital memory device; ensure that means for doing so are present.

d. Correctness (3): For a block diagram, check that there is a logical flow of activities or signals from inputs to outputs (no loops without input or output, etc.), inputs having no influence on the system, etc.

e. Correctness (4): For a flow chart, check for a reasonable flow of control, generally from an input to one or more outputs (preferably one output), possibly with one or more feedback loops.

f. Completeness: ensure that no inputs to each component/block remain unconnected; that all system inputs and outputs are defined and used. That all possible options in a flow chart are defined.

g. repeating steps (a)-(f) across a plurality of listings, for multiple pictures/drawings. Check for consistency, correctness and completeness across all the drawings/pictures in the invention description. Control in a flow chart may pass from one drawing to another, as signals in a block diagram.

**End of Method**

Method G1C for Disclosing an Invention in Pictures and Processing It

Sometimes the inventor cannot easily express himself in pictures, although he may better understand the invention visually. In this case, a modified version of Method G1 may be used, where the agent assists in preparing the pictures, then continues the dialog with the inventor using the pictures:

a. Input invention in pictures (1): A textual description of the one or more pictures describing the invention is used to describe the invention, in a dialog between inventor and agent.

The dialog may use the system of FIG. 27 and the menu of FIG. 31. These means may be used with all the steps of this method, as appropriate.

Otherwise the inventor may communicate the description verbally over the phone, on a direct link with the agent's office or through the internet using Skipe for example.

The pictures description may detail the invention at several instants in time, to illustrate movement of the parts and/or interactions therebetween; or they may illustrate a system and details of its various subsystems.

If the inventor's description is verbal or a text, the agent will convert it to pictures and will present it to the inventor for his approval.

b. Input invention in pictures (2): Pictures are prepared by the agent, based on the textual description of step (a). These are communicated with the inventor. Corrections or additions to the pictures can be performed where necessary.

c. Input invention in pictures (3): Concise, precise text is attached to the drawings: titles for each drawing, a name or short description for each part, what each part does, benefits and novelty in each part and/or combinations of parts.

Preferably a standard vocabulary is used, see for example Method C9 for developing a standard vocabulary. This is important, since the vocabulary forms the basis for subsequent dialog, search, examination, prosecution.

Non-professional terms will obfuscate matters or endanger the application. Numbers are assigned to the parts and their inputs and outputs, see for example Method N2—parts numbering.

d. Pictures processing (1): A connections list is prepared by the system, describing the drawings, see for example Method C10—Structure definition method, with FIGS. 12 and 14.

e. Pictures processing (2): The system checks the list for consistency, correctness and completeness. See Method G1B—checking the connections list. The checks may be performed for one drawing, or across several drawings in the patent application being prepared. Errors and omissions are presented to the inventor and/or agent.

f. Input invention in pictures (3): Where errors and/or omissions were found in (e), these are corrected in an iterative process involving a dialog between inventor and agent per steps (a)-(c) and processing (d)-(e) above, until all the errors and omissions are corrected.

g. Pictures processing (4): Drafting the patent application with its standard parts, while the invention description in (a)-(c) after processing in (d)-(f) underlies the description.

Keeping links between the application and the above description, for example by numbering the sentences of the application and generating links pointing to them, see for example Method N1—numbering the sentences of an application, and FIGS. 11A-11C.

h. Pictures processing (4): When the inventor desires to make additions to the application, these are first discussed with the agent and performed on (a)-(f); only then the patent application itself is modified accordingly, see (g).

The same process is applied for amendments, comparisons with prior art, etc.

**End of Method**

Method G2 for Disclosing an Invention to the Patent Agent

a. FIG. 31 details a user's menu for disclosing an invention to a patent agent using computer interface means, for example over the Internet. The computer menu and assistance may be also used during a person to person meeting. Preferably the method uses the communication system of FIG. 27.

b. In one embodiment, the menu may include:

a drawing area 71, where the user can draw his/her invention on-line, using for example the drawing tools 72. This may be usable for fast communications with the agent to disclose the invention, possibly to convey an idea to a consultant at the attorney's office—the consultant sees the drawing as it emerges, and can react instantly to ask questions, add comments, etc.

c. There may be a textual tools area 73, for text editing in the drawings or generally. File control 74 tools may be used for saving the description, retrieving previously saved text and/or graphics, a voice recording, pictures, a video clip, etc.

d. The transfer XFER area 75 controls the transfer of files and/or other objects to a patent agent server 32 or between other locations.

e. A Misc. area 76 is reserved for other functions relating to patent applications processing.

f. The real time RT dialog area 77 may be used for real time textual communications with the patent attorney for example. The inventor can discuss, in real time, the drawing presented, a file retrieved from memory, etc. The attorney can present questions, comments, tasks for the inventor to perform, corrected drawings or text, etc.

***End of Method***

A challenge for the patent agent is to understand the full extent of an invention and present it in the patent application. The inventor may omit essential parts of the invention because they are obvious to him, or because he does not know the limitations of prior art (he thinks some aspects he solved are obvious, whilst in reality they are novel), or the invention is complex and difficult to describe, or simply the inventor is not good at explaining things.

During examination, the inventor may exclaim “But of course it is done this way . . . it was always very clear to me”. Unfortunately, the Examiner looks for a written disclosure in the patent application.

The present invention strives to bring more of the inventive concept into the patent application, using advanced high tech tools to enhance the dialog inventor—patent agent.

Preferably, the disclosure is made in two stages:

1. File a preliminary patent application with inventor's unadulterated inventive concepts, with the disclosure enhanced with the patent agent's help.

2. File a complete patent application claiming priority from the preliminary application, also relating to prior art. Researching the prior art and relating to it is only performed after the description of the invention itself is completed.

Method G3 for Disclosing an Invention to the Patent Agent

a. The above (or a similar) menu is used to interact with the agent not in real time. The inventor and the agent, each at his leisure, can interact with the system to place their contributions there—questions, answers, tasks, drawings, comments to drawings, etc.

Such a menu may be used as a mailbox to overcome the distance limitations.

b. Thus, although the meeting with the attorney is not face to face, it can be productive, focused and conducive to advancing the application.

c. Moreover, it is personal and bidirectional: this is not a one-way, open loop posting of a disclosure, but an attorney-assisted disclosure which may be followed by a professional patent application drafting by patent attorney. The above method of communication may be used with performing the search, drafting the patent application, post-filing activities, etc.

d. The extent of the patent agent's involvement in the process may be defined by the applicant, see FIG. 29. Of course, the more extensive the work performed by the patent agent, the better the chances of getting a patent approved, and the result—a stronger patent protection, if approved. However, such work may be more expensive. The method lends itself to either a lower cost implementation or a higher quality protection, as per customer's decision.

e. The process or the above iterations, continue until both inventor and agent are satisfied that the invention is properly detailed, or until other factors demand to end the process and file the application—time limitations or a deadline, the cost factor, etc.

***End of Method***

Method G4 for Disclosing an Invention to the Patent Agent

a. The inventor draws a system using a suitable menu, for example such as illustrated in FIG. 31, and while attaching part numbers to the parts of the drawing and their inputs and outputs, for example as illustrated in FIG. 10.

b. The system prepares a connections list from the above drawing and sends the list to inventor. If the inventor did not attach numbers to the components and their input/outputs, the system does it prior to preparing the connections list, preferably using Method N2 for parts numbering.

c. The system checks the list for consistency, correctness and completeness. The checks may be performed for one drawing, or across several drawings in the patent application being prepared.

Errors are presented to the inventor, who can correct them in an iterative, closed loop mode of operation with the system.

d. the inventor checks the final list and approves it.

e. The list forms the basis for drafting the description and claims of the patent application.

***End of Method***

Note: The above method may be used with either a system or a method patent application. The stages in a method may be seen to be connected in a similar way to the connections of the blocks of a system.

(3) Method for Guiding the Inventor Through the Patenting Process

Often, an inventor does not know the stages of getting a patent or the costs involved; what choices are available at each stage. He may start the filing process, only to be surprised and discouraged later on to abandon it. By presenting the user with the various stages and the choice in each, users can make informed choices and plan in advance, thus increasing the chances of success.

Method G5 for Displaying the Stages of Filing and for Choosing a Plan

a. FIG. 29 details a method for educating the user and presenting him/her with various choices in the time/cost domain. An educated user may make better choices, so the process is more effective and possibly lower cost. The menu and method may guide a user through the patenting process. The user interface has a dual purpose: to provide information to the user, and to receive a user's choice once the inventor has made his mind.

The system will then advise the user, by displaying the stages of filing a patent application and pursuing the invention, further offering the user a choice of activities to do and their cost, as a bidimensional Time/Cost matrix (Stages to be performed in a Time 212 vs Cost 211 domain).

The info in FIG. 29 may be displayed to the user as a computer menu. The system thus presents a recommended action plan, with consecutive stages to be performed, pending user's agreement.

b. The Stage axis 212 displays recommended stages required to achieve a user's goals. The stages are not mandatory, rather the user may choose whether to perform or not each stage.

c. The Cost axis 211 indicates various cost-related approaches. The user indicates his basic approach for each stage, according to the importance he attaches to that stage.

For example, for the Preliminary search stage, the options may be:

A. Do not search at all—the user may do it himself or may skip it

B. Free search—The system will indicate links for the user to search there

C. Search with our assistance in free databases—The patent agent's system will assist the user, during free searches on the Internet

D. Search with our assistance in for-a-fee databases; search done by user

E. Search performed by patent agent's office, on a per-hour basis

F. The User is directed to a Search for a fee performed by another party, such as the UK IPO or the European Patent Office EPO.

d. Each cell in the table may be an Internet link—by pressing it, the presentation changes to display details for that option. For example, Preliminary search—Free will display links to sites which offer this service. Furthermore, explanations may be also displayed, to educate the inventor and guide him/her through the complex patenting process.

As the user points to a specific Stage/Cost rectangle, a window will open with more details: explanations, warnings, examples, cost estimates (range), time to perform it estimates (range), etc.

e. The user, after choosing a suitable Stage/Cost rectangle, activates it to Submit a Request for price quotation to the Patent agent's site. Alternately, the Request may include a complete plan with a plurality of activities chosen from the bidimensional display.

f. The agent may refuse to accept a specific work, for various reasons. Methods for implementing a preliminary filtering may be automatically performed at the inventor's computer (using software received from the agent) or at the agent's site. If the agent does not accept the case, the dialog is terminated. This may happen for example if the invention is outside of specific criteria defined by that agent.

For example, an agent may not handle specific areas in which he does not specialize or to prevent a conflict of interest; the agent may refuse to accept a perpetual motion invention, etc.

This initial screening prevents an invention's unnecessary and premature disclosure where it may not benefit the inventor.

The initial screening may be performed automatically at the agent's site 322, using predefined criteria and a questionnaire presented to the inventor.

g. Further steps may be performed for the inventor and agent to get acquainted with each other, as detailed in the present disclosure and, if both parties agree, to disclose the invention and start work together according to a plan.

h. The patent agent's site (system) receives the Request and other relevant info, such as details about the work to do, the invention and the inventor; A price quotation is prepared accordingly and is sent to the user.

i. The user, if he accepts the price quotation, indicates his agreement, which is then transformed into a specific work order for the Patent agent.

***End of Method***

Notes:

1. The extent of the patent agent's involvement in the process may be defined by the applicant. The Free option is performed by the user, possibly with automatic help from the system. The Expensive option includes work performed by the patent agent/attorney and possibly meetings in person.

2. Of course, the more extensive the work performed by the patent agent, the better the chances of getting a patent approved, and the result—a stronger patent, if approved. However, such work may be more expensive.

3. The user's choice principle applies to the various activities to be performed, for example searches, drafting the text of a patent application or the drawings. The drawings can also be done at various levels of performance and cost: Using inventor's drawings “as is” ; drafting correct drawings at the representative's office; concept and strategy planning including drawings by the patent agent.

4. The method lends itself to a lower cost implementation if the customer so decides, or to a higher quality, more expensive work where possible.

5. This menu presents to customer the recommended stages vs time. At each stage, there are choices for customer to make: Whether to perform the recommended task, and the amount of money to invest in it, from Free to Expensive.

6. The bidimensional display of stages/tasks vs time as in FIG. 29, may be used both to educate/inform the inventor and to receive his/her choice of tasks to perform. It is easy to use, for each stage the inventor reads the instructions and makes a choice, just “point and shoot”.

7. Preferably, the system will distinguish between “Free” and “Irrelevant”, the former indicating the inventor undertakes to perform the task himself, whereas the latter—inventor's decision that it not to be performed at all. FIG. 33 details one implementation of a user's choice of activities to do and their cost, for performing unified patents search and patent application filing, in a bidimensional matrix structure. The various activities, such as detailed with reference to FIGS. 3 and 6, are now mapped onto a Cost vs Time space, defined with Cost axis 211 and Time axis 212.

For each stage (if performed at all), the customer may decide on the level of investment dedicated to it. In the example as illustrated, Step 41 (Defining the invention) is allocated the Basic cost (a low cost), whilst step 42 (Filing an urgent preliminary patent application) is allocated a minimal investment; Step 43 (Initial Patents search) is done by applicant for free, etc.

Method G6 for Displaying the Stages of Filing and for Choosing a Plan

Example of a succession of Stages for protecting and pursuing an invention, see FIG. 29 for example of stages presented to an inventor to choose from:

a. Strategy Plan

The system gathers information on the invention, the invention, the planned business. A preliminary, tentative strategy plan may then be presented, as prepared by an automatic computer algorithm. Of course, it is recommended that the inventor should consult with the patent agent (for a fee), to devise a better strategy, suited to his business.

The overall strategy may include various IP protection means, for example trade marks, designs, copyright, moral right, trade secrets.

b. File Preliminary Patent Application

The filing date is very important in patents, so the system strives to file an application as soon as possible. There is the dilemma of whether to spend more effort, time and money in improving an application, or to file it earlier. Circumstances vary, the issue will be decided between the inventor and patent agent.

c. Preliminary search—may include technical data, technical terms, patents, etc.

d. Consultants

e. Technology/Market search

f. Agreements

g. Investment

i. International patents search

j. File quality patent application

k. Accelerated search and examination

l. EW patent searches

m. File patents worldwide or PCT

n. Pursue patents protection

o. Prototype development

More (or less) stages may be included in such a system and method. The order of the stages may vary.

***End of Method***

Notes:

1. The inventor is not forced to perform all the stages, nor must he perform the stages in the order as presented. Rather, the inventor can choose stages as he decides to do. Thus, the system is flexible and will support the inventor in various scenarios.

2. The rationale for this preferred embodiment is that promoting an invention is a highly complex process, involving interdisciplinary knowledge, differing from one area to another, part science and part intuition. Moreover, the inventor may act under various constraints relating to timetable, budget, prior contractual obligations, product performance, etc.

Thus, a flexible system where the inventor has an intelligent choice and can decide what to do, may be preferable.

3. The inventor may feel that he must disclose the invention in order to receive any general guidance or a cost estimate; then he may feel trapped and obliged to continue with the same agent, who is already party to his secret. Using the present invention, the inventor is free to decide after receiving general information and a cost estimate, before disclosing his invention.

Method G7 for Displaying the Stages of Filing and Choosing a Plan

Another Example of Stages for protecting and pursuing an invention:

a. Initial IP evaluation and strategy planning

b. Initial choice and specification of means for IP protection

c. File preliminary patent application

d. File application for design (design patent)

e. File application for trademark

f. File application for copyright registration

g. Define, Study and specify the invention

h. Technical analysis of invention, technical utility and possible embodiments

i. Prior art searches: patents, applications, non-patent information

j. Strategy planning for IP protection

k. Patent application drafting and filing

l. Business development activities: Marketing, investments, licensing and confidentiality agreements

m. Accelerated examination proceedings

n. Patent prosecution, to get a patent approved

o. Filing of international PCT patent application and/or patent applications in other countries

p. Filing of continuation applications, divisionals, etc.

q. Patent maintenance, up to 20 years from priority or as the case may be

r. Proceedings before the Patent Offices of other countries, patents prosecution.

***End of Method***

Method G8 for Guiding the Applicant/Inventor Using Price-Stage Table

The user can decide how much time, money and effort to invest in patents and prior art search. Information is provided for each option or each possibility to choose—free on the Internet site. If this is not sufficient, then it is possible to order a consultation over the telephone or at the office.

The consultation would target the specific dilemma the user has, for example choosing how much to invest in a search. In this way, the user can perform the work himself for free with initial guidance, if this is sufficient for him. The more professional and thorough options will usually be more costly.

The user can be directed to other service providers, such as lawyers, advisors and searching companies, which can offer specific services that can help the user, for the purpose defined in that stage.

Each option of the price-stage table can include a Tooltip, thus initial information appears when the user places the mouse over such an option. Each such option would preferably have at least one link, directing the user towards detailed information pages in the website, optional links, and ways to define what work is desired, and with the option to receive a price quote to email, fax or by phone, or choosing the free option.

Articles, Books, Publications and other Prior Art—The user can choose to perform such searches or researches. Links and support for performing search in free databases.

***End of Method***

Method C5 of Communications with Customer

a. The inventor identifies himself before the patent agent office, and receives a password or other means for implementing secure communications in the future.

b. The inventor views the various stages recommended by the agent office, as illustrated in FIG. 29. Each rectangle in the Time/Cost space, such as rectangles 215, 216, 218, may be a hyperlink which can be activated by the user to prompt the presentation of:

What will the inventor get by ordering this item; how will he get it;

Work definition: size, scientific discipline or class/subclass, extent of work to be performed by the patent agent/attorney

Price or a request by inventor to receive a quotation; in the latter case—The inventor may reduce costs if no personal meetings are performed, if the iterations are kept to a minimum, if he prepares himself the drawings, etc. How to send the quotation: by email, mail, fax, phone, etc.

Advice to inventor/applicant relating to the presently contemplated activity Standard advice may not be enough nor suitable to a specific situation. The inventor is advised to meet with the patent agent for personal advising. Such advice, of course, is not free.

An estimate of time to perform.

Classification of work to do, and/or

Other relevant info.

c. The inventor chooses the stages to be performed. The choice is translated into a Work Order for the patent agent office, and a Work Plan for the inventor. The Work Plan may therefore include a list of stages to be performed, the cost associated therewith and an estimated timetable. Additional information which may assist the inventor may be included as well. Supported by the system, the inventor may print a report with the Work Order, to bring with him when meeting the patent agent.

d. As the work advances, a status table/report may be presented to the inventor, with an indication of Present Status: which stage is being done at present, which stages have been finished and what remains to be done. The costs and timetable may be updated as may be agreed between the parties.

***End of Method***

Note: The options available to user, as illustrated in FIG. 29, may be as one menu or a plurality of menus, organized in various ways. Thus, the menus may be organized in succession (when one ends, another begins) or in a hierarchy (pressing a button such as 216 will result in another, lower level but of similar shape menu to be displayed).

Method C6 of Communications with Customer

The method applies to any type of intellectual property protection, such as a patent application filing (this is illustrated by way of example in FIG. 29), patent searches, trademarks, etc.

a. The inventor establishes a link with the system and enters the relevant information, including but not limited to: info about the inventor; the work performed until now, the present status, questions that need answers and identified problems; the goal, or purpose/target of the present project.

For example, the inventor is the president of a small firm, has already filed by himself two patent applications; he wants to file an international PCT application claiming priority from the above applications, while correcting errors therein and adding new matter to cover additional developments in the project.

b. The system computes a recommended strategy to be implemented with a list of Stages, devised especially for the present situation (the user characteristics; the present state of the project; desired work to do) and displays it in a format similar to that in FIG. 29.

For each Stage, there are various approaches, from Free (if possible) to Expensive. An automatic response with a preliminary strategy will issue for free; a more elaborate, advanced strategy suitable for the specific user, will be issued for a fee. In the latter case, the system may call a patent agent's attention to review the contemplated strategy prior to its presentation to the inventor.

c. The inventor chooses the stages to be performed. The choice is translated into a Request for price quotation which is submitted to the patent agent site.

d. A price quotation is transmitted to the inventor. If the inventor accepts it, then it becomes a Work Order for the patent agent office, and a Work Plan for the inventor. The Work Plan may therefore include a list of stages to be performed, the cost associated therewith and an estimated timetable. Additional information which may assist the inventor may be included as well.

e. If the inventor disagrees with the present strategy, or if circumstances change, the inventor so notifies the system, and the strategy with its stages may be updated accordingly, if both parties agree to do so.

***End of Method***

Throughout the present disclosure, where applicable, the system may send a cookie to the user/inventor/applicant, according to the IP there, to help in providing coherent support from one session to another, etc. For example, the cookie may store the pages viewed by the user, to estimate his/her understanding; where appropriate, the user may be directed to other relevant pages in the system.

FIG. 30 details a user's menu 61 for connecting with various Patent Office sites 62-66. The menu may be presented to a user 31 by an application software in the patent agent site 32 (see FIG. 27). The menu allows the user to connect with various Patent Offices 62, 63, 64, 65 and 66 in USA, Japan, Great Britain, European Patent Office and Israel respectively, etc.

Thus, free searches with these and other offices may be performed.

The web window 61 may include:

Initial data window 611

Other data window 612

Submit button 619

and/or additional displays and controls.

The window 61 may be presented to a user 31 by patent agent's server 32 as one of the menus in the system, see FIG. 27.

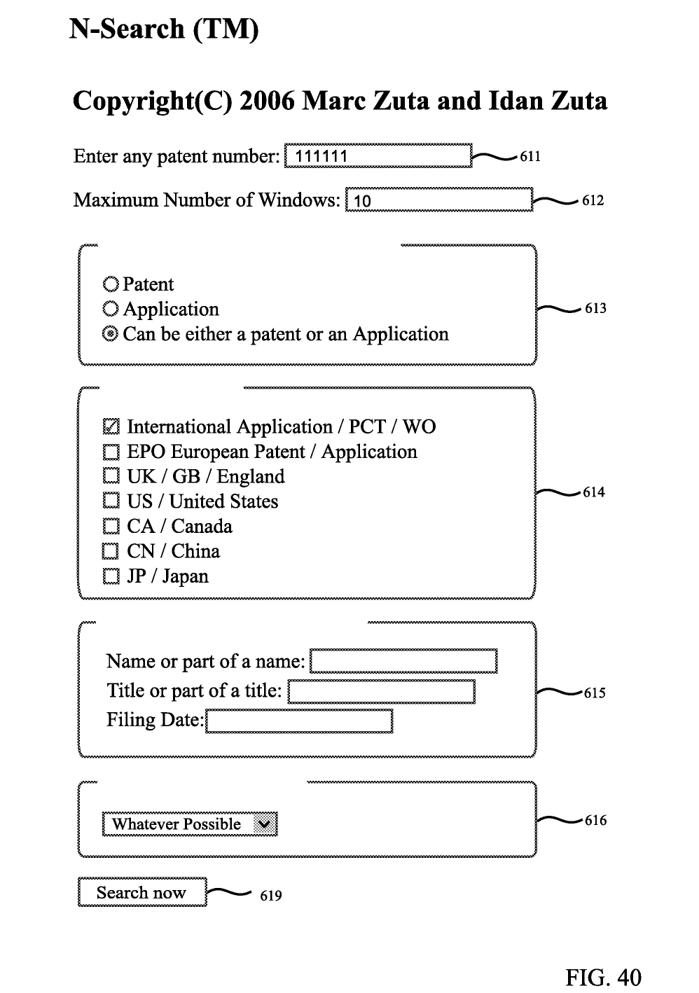

For a multi-database, multi-window search on the Internet—see FIG. 40 and the related disclosure.

Method C7 of Assisted Connection on the Internet

a. The user 31 (FIG. 27), in a dialog with the patent agent's server 32, defines a need or activity to perform.

Alternatively, the activity may be part of an action plan agreed between user and patent agent, as defined by the user ie using the menu in FIG. 29.

b. The agent's server points to a site or a plurality of sites, which can help: for example the UK Patent Office or the Japanese Patent Office.

c. The agent's server assists in establishing the connection with the site selected by the user.

d. The agent's server presents relevant comments and advice, relating to the resource site now visited by the user. Such info may be presented in the user's native language, other than English.

Advice may include, for example, pointing to automatic translation service at the JPO, for presenting the text of applications in English.

e. Help to activate additional resources on the Internet, such as translations, technical info, expert consultants, investors, lawyers specializing in various fields, etc.

f. Data capture—the data viewed by the user may also be stored into his computer. The inventor, if he so decides, may transfer results of the search to the patent agent, preferably with the inventor's comments.

***End of Method***

(15) Safe Paper™ for Reliable Transfer of Invention Documents

SafePaper™ allows for reliable transfer of invention documents through the Internet or other electronic channels, the documents also including drafts or sketches, while preventing loss of info.

An inventor desires to send a description of an invention to the patent agent or the Patent Office. The received document may differ from what the inventor intended to send: sometimes the scanning of the document is faulty, so that part of the page is missing (the upper or lower part is clipped; one side of the page is missing; several lines in the middle of the page are distorted or missing, etc.), the scanning is too light (difficult to read) or too dark (black dots or areas). Sometimes the message is distorted in transmission; sometimes the transmit and receive equipment or software are not completely compatible. Sometimes one or more pages of a document are missing; sometimes the same page is transmitted several times.

For patenting using electronic communications, it is essential that documents be received without errors—the inventor depends on these channels.

The problem is the inventor does not know what exactly was received, and the recipient does not know what was send, so neither party can check the transmission to verify its correctness.

Method V1 for Sending Verifiable Messages

1. The inventor writes or draws the invention on SafePaper™ pages, which include means for detecting damage to the message therein. Each SafePaper™ page includes a work area, surrounded by special markings to detect a disruption to the page.

2. The message is send to recipient.

3. The recipient checks the markings on the page to detect damages in the message.

4. The recipient answers in any case, indicating to the inventor whether the message was received OK or there were errors.

In case of errors, it may indicate the type of error: missing pages, incomplete pages (and indicating which pages), damaged pages, faulty scanning, etc.

5. Corrective actions are taken by inventor to ensure the message is received OK. Depending on circumstances, some pages may be retransmitted, the whole message may be retransmitted, other communication channel may be used, the document may be scanned anew or the missing pages added to the document.

**End of Method**

The structure of a SafePaper™ page (1)

The page 2C includes, see FIG. 19:

1. A work area 21C, usable for writing, printing, drawing etc. by the user. For each page of a message, the info in the work area 21C may be different.

2. A frame 22C surrounding the work area 21C. The frame 22C is the same for all pages of a message. It may contain letters, numbers and/or other symbols. If part of a page is missing or distorted, the symbols in the frame 22C will be distorted. The recipient does not know what is written in the work area 21C, but he does know the standard structure of the frame 22C. Thus, if the frame 22C is intact, the message in the page is OK.

3. Page-specific info field 29C, including for each page the number of the page, the total number of pages in the message, a Reference number common to that message, a date (of creating or sending it), the type of message: text, drawings, photos, etc. This allows to check that all the pages of a document were received, that all the pages belong to this message and to the present version thereof, etc.

Details on the Structure of the Frame 22C

Preferably, the frame 22C includes a column of ascending numbers 23C to the left of the work area 21C, a column 24C with the same numbers to the right of the work area, a line 25C with letters in generally ascending order above the work area and a line 26C with the same letters below the work area 21C.

The numbers and letters thus define a coordinates system, which can be used to point to various features in the message. Using the same letters/numbers on both sides of the work area 21C makes it easier to find the coordinates of each location. The location of a specific feature in the page may be indicated as 18F, to indicate line 18 and column F.

The symbols may also be used to check there are no missing parts of the page. The symbols may also be used to check the resolution and quality of the transmission, noise and distortion and other features of the page.

IN one embodiment, the rows and columns may use letters and numbers as illustrated; in other embodiments, they may use only numbers or only letters or other symbols.

IN one embodiment, the user may use pages as that illustrated in FIG. 19, filling manually the details in field 29C for each page of the message.

In another embodiment of the invention, there is no field 29C, see FIG. 20. The user prints the info in the work area 21A and also prints the info in the field 29C.

IN yet another embodiment, the frame 22C is incorporated in a word processor software—the user types the desired message, then the word processor automatically adds the frame 22C around each page of the message. The complete pages can then be printed, sent as a document file or converted to an Acrobat PDF file, for example.

IN yet another embodiment, the frame 22C is incorporated in a graphic editor software—the user prepares the desired drawings, then the software automatically adds the frame 22C around each page of drawings. The complete pages can then be printed, sent as a drawings file or converted to an Acrobat PDF file, for example.

The structure of a SafePaper™ page (2)

When the applicant files an application electronically for example through the Internet, preferably the Patent Office should acknowledge receipt indicating exactly what was received. This may prevent misunderstanding, for example the applicant believing the PO received the intended documents, when in fact this is not the case. The applicant may disclose the invention in public and thereby lose the rights to a patent. Were the applicant to know there was a problem in filing, she could correct it instantly.

A second purpose of this acknowledgement is to give the applicant a detailed Receipt and proof of what was filed.

Following is detailed the structure of a page in a document returned by the Patent Office to applicant, which can accomplish the above goals.

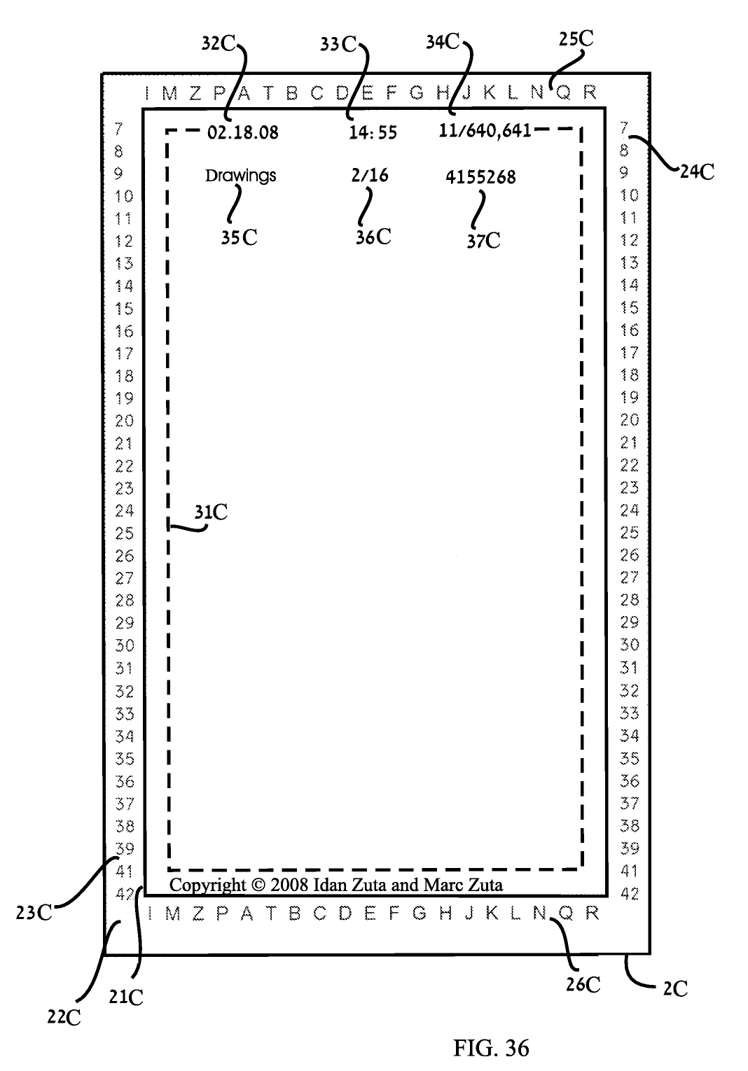

See FIG. 36, page returned from Patent Office (PDF format) with filing acknowledgement. The returned page may include:

frame indicating scope of received page 31C (area considered to include all the drawing, text or computer code being sent to PO—info in the margings outside this frame may be ignored by PO)

time stamp including:

filing date 32C

filing time 33C

patent application number 34C, as was assigned during electronic filing type of document, this PDF file 35C, for example: Drawings, Text, Claims, Computer code, Chemical formula, Combined document

page number out of a total of pages 36C

digital signature or Receipt number 37C

The digital signature 37C may refer to the whole document, thus not different for each page.

The above document is preferably in the standard PDF format.

Method for Returning Document with Acknowledge

The method includes:

a. The Patent Office receives an electronic filing of a patent application, for example a provisional or non-provisional utility patent application, for example through the Internet or through a local net at the Patent Office.

b. The received documents are analyzed, for example to find the number of pages in each type (text, drawings, computer code, etc.), also for file correctness

c. Irregularities may be corrected, for example gray or color items may be converted to black and white, or as required.

d. A patent application is granted if the filing complies with the requirements.

e. A PDF file is created or the received file is edited, to also include all or part of the additional info detailed above: A frame with the scope of the info received, time stamp, application number, digital signature, etc.

f. The file created in (e) is sent to applicant.

One file may include all the application, or separate files may include the text, drawings, computer code, formulas, etc. The text also may be separated into files with the description, claims, abstract, etc.

**End of Method**

7. Patenting Worldwide

Multilingual Patenting for Processing Patents on a Global Scale

Patenting is now a global process—Patent Offices search globally for prior art; a patent may be filed in several countries, under the Paris Convention or the PCT. There is a language barrier in processing these patents.

Multilingual Patenting Method L1

1. The various tools in the present applications may be used to facilitate communications and to provide precise translations of terms used.

2. For example, when filing an IDS document for the US PTO, a translation file may be filed as well. This allows the examiner to discuss various issues with an applicant speaking a different language. A word may have various meanings, also depending on context, so standard translations may not be helpful. According to the present invention, by defining a translation table for key terms from the outset (ie when filing the first application), a precise translation and use of terms in all the desired languages may be achieved.

3. Several translation tables may be used, one to each language of interest, for example English with Japanese, Chinese, Korean, Russian, etc.

4. A translation module and/or translation table may be added to the various methods in the present disclosure. The module and table may be used by automatic means (a computer) to translate various text or structured text files from one language into another.

For example, the IDS document can be translated, as well as the links between the claims, detailed description, drawings and benefits, etc.

**End of Method**

Method L2 for Limiting the Meaning of Terms

In any language, a term may have several meanings. This may interfere with the scope of the patent application, to present an unambigous apparatus or method. The method comprises:

1. Identify the key terms in the description and claims: the terms which are important for the understanding of the invention—these are the terms which are substantial for defining the invention.

2. For each such substantial term which has more than one meaning, include a further indice which will limit that term to only one meaning. The indice may be a number or word attached to that term. In another embodiment, a Glossary of terms may be included in the patent application, which will define all the terms used and, for terms having more than one meaning, the only meaning which will be used in that application will be clearly indicated.

In yet another embodiment, the indice is a number indicative of the field of that term according to the meaning of the term in that description.

The indicative number can pertain to a standard classification code such as the American or International classification code.

**End of Method**

Method L3 for Limiting the Meaning of Terms During Translation

When translating a term from one language to another, there may be a one to one correspondence, one to multi or multi to multi correspondence.

Usually, the several meanings in one language do not correspond with those in the other language—there is only partial overlap.

The translation method can include:

1. Identify the key terms in the description and claims: the terms which are important for the understanding of the invention—these are the terms which are substantial for defining the invention.

2. For each such substantial term which has more than one meaning, include a further indice which will limit that term to only one meaning.

3. Translate the substantial terms into the other language and check whether any of the terms has more than one meaning there; if positive, then attach additional indices to each meaning and indicate which one corresponds to the term in the first language. This is important to allow unambiguous translations in both directions between the two languages, and prosecution of patents in multiple languages.

The applicant or inventor may not be versed in another language, so to allow proceedings in other languages a precision translation is required.

4. Whenever relating to the invention in either language, indicate the various meanings of key terms in each language and the chosen meaning now used.

**End of Method**

The above methods (L1 to L3) may be used with the other methods in the present disclosure, to make unambiguous all the invention descriptions there.

8. Applications of the Novel Methods in this Invention

The Processes in the Life of a Patent may include, for example:

a. Prior art search

b. Examination of the application

c. Accelerated examination in USA

d. Improving/correcting the prior art

a. Prior Art Search

The problem is not the search itself, but the interpretation of the results. There are abundant and excellent sources of information, see for example USPTO requirements for search relating to Accelerated Examination.

The problem is selecting those references to present to the Patent Office: If too many references are presented, USPTO will reject them: the applicant presents a multitude of irrelevant references to hide among them the really relevant ones.

If relevant results are omitted from the report, the applicant may be accused of failing the duty of candor by hiding relevant references.

Thus, there is the problem of selecting the relevant citations among a multitude of prior art.

Furthermore, patents now tend to be more and more complex and bulky. Moreover, patents use different terms, some not according to their usual meaning or even contrary to it.

How then to relate to all this prior art, and in such a way as to prove applicant's good intentions? It is not enough to do one's work conscientiously, but the applicant or his representative should be able to prove that he did so.

Patentability Computerized Search Method PACSEM^{SM}

a. Define a patentable invention using the methods in the present invention, for example to include the invention itself in standard terms with concise relationships therebetween, also indicating the benefits or other Secondary Considerations, etc.

b. Search the prior art

c. Bring the prior art into Standard form, to use standard terms and concise relationshiphs among the terms; also adapted for automatic processing.

d. Compare each of the prior art items, and each invention or inventive aspect in each of those items, with the present invention. The comparison is made in several dimensions corresponding to the Patentability criteria: Field of the invention, structure of invention (for Novelty), Benefits or other Secondary Considerations (for NOn-obviousness).

The comparison is preferably done in a computer. Results:

1) A quantitative value, allowing to order the prior art items according to their relevancy to the present invention.

2) Pointers (links) to parts in each prior art and the present invention which are most similar or identical

3) Pointers (links) to parts in each prior art and the present invention which are most different

**End of Method**

Notes:

1. The above method allows to find the most relevant prior art, possibly analyzing thousands of prior art patents, or more.

2. For a block diagram or flow chart, a bi-dimensional comparison may be made, including the structure (layout) of the blocks and the text in each block.

3. The examiner or patent attorney is presented with the results and also with the rationale for those results (where the patents are similar, where they differ), so the user can verify the computer analysis and possibly correct it. The automatic analysis may be just a preliminary preparation for examination.

(6) Searches in Prior Art for Inventions Rather than Keywords

At present, there is no scientific tool to search for inventions.

A plurality of keywords cannot define an invention, as they cannot convey the meaning of a story or poem comprised by these words.

Patentics™ uses a mathematic definition of inventions to compare an invention with a multitude of other inventions, automatically by computer. It can compare in a flash maybe millions or thousands of millions of patents and other documents.

See details above, for example in “Method for defining inventions”. See also FIGS. 23 and 24 for the parts indicated below.

Method S1 for Searching Inventions

The method includes, see FIGS. 23 and 24:

a. Define the invention, ie by using the abovedetailed “Method for defining inventions” and the terms therein. The definition may include:
1) Prepare a list of standard terms in use [4590], that is the list of relevant terms for describing the invention.
2) Structure definition [4591], including the components and the interconnections between them, using mathematic terms. The components are described using the standard vocabulary of step (1).
3) Description of the use, application or benefit of the above structure/embodiment [4592].
4) The advantage over prior art [4593]. An invention has to advance the state of the art in some way, to do it better, faster, more precise, in a structure which is smaller, bigger, sturdier, lighter, softer, etc.

An invention can be defined as a three-dimensional vector comprising the variables of Structure description, Use/application and Advantages over prior art (or other Secondary Considerations for Non-obviousness). This definition answers the requirements of Patent Law regarding Novelty, Utility and Non-obviousness, respectively.

The Field of the invention may also be considered, so as not to compare inventions in unrelated fields.

Each of the above variables is defined using standard terms with mathematical terms defining the interconnections between the terms.

b. Perform a search of prior art databases, using prior art methods: keywords with Boolean relations between them, class/subclass, inventor, applicant, etc. Other methods may also be used to find documents which disclose possibly related prior art.

c. Manually review each document found and, if possibly relevant, compile for it an invention definition (for one or more inventions therein) using the tools in step (a) above [8824], [8834], [8844].

An invention is defined as a three-dimensional vector comprising the variables of Structure description, Use/application and Advantages over prior art. This definition answers the requirements of Patent Law regarding Novelty, Utility and Non-obviousness, respectively.

If the document uses non-standard terms, compile a translation dictionary (a cross-reference between terms used there and the standard terms), and define the invention(s) in standard terms as per step (a).

Each document may include several structures or inventions.

For the non-standard terms, preferably prepare the following files:
1) a glossary of terms, describing them in term of standard terms
2) a dictionary to translate from non-standard to standard terms
3) a dictionary to translate from standard to non-standard terms
4) a table indicating where, in the cited document, are the non-standard terms defined and used.

d. Compare the present invention as detailed in step (a), with each of the corresponding vector components as defined in (c). The comparison can be done automatically by computer [885], since the equations or mathematic terms prepared above are machine readable.

The search may find identical or similar inventions. If similar, the degree of similarity (overlap in identical features) is precisely measured.

e. Using the mathematic/vector representation, absolute distances between inventions can be computed. These may be used for indicating Novelty or Non-obviousness in an objective manner.

The distances may include all, or each of the three components of an invention vector, and the specific elements of each component (specific to each invention).

“Distance”—as defined in mathematics for multi-dimensional spaces. Optional: use weights to set different priorities to each of the components of an invention. Some may be more important than the others.

f. Comparing distances between allowed applications and cited references in prior cases may set a precedent for the present search—a scientific, objective criterion for what is different and what is not, with respect to prior art. That is, prior decisions at the Patent Office may be measured mathematically to set a precedent or threshold, regarding what is considered a large enough difference/distance to be eligible to a patent. A different threshold may be used in each class and subclass.

g. Comparing distances between cited references, maybe with a higher weight for Use/benefit and Advantage, may indicate to what degree it is advisable and fair to combine references against a new invention.

h. display the results to user [886].

i. where relevant, repeat the process for several inventions there.

Where relevant, use a bi-dimensional description.

j. Priorities—an essential component has the highest priority, whereas a less important part—a lower priority. The Priority may be included in the above inventions description and processing.

This may add a new dimension to the invention description, which may be used to more precisely and effectively compare inventions. It may also guide the agent, on what features to spend more effort to describe in more detail, and to draft more claims to protect such features.

It also makes for a more objective comparison between inventions: maybe the same part exists in two inventions, but in one it is essential whereas in another it has just a marginal importance.

The priority feature brings, in a quantitative way, the inventor's intent. For of course each invention and apparatus has essential and marginal parts.

***End of Method***

Notes

1. The method may be used to search for system or method inventions.

2. A system or method may have a bi-dimensional description, as detailed elsewhere in the present disclosure: one dimension for the interconnections between blocks, the other for the component/function/method step in each block.

The components in each block may include the text there or key words in each block or a logical, Boolean expression.

Benefits:

1. Search for inventions, rather than meaningless strings of words.

2. Fast, automatic search replaces slow, tedious manual reading, understanding and opinion forming for each cited document.

3. The investment in coding prior art in Step (c) is worthwhile, since the results may be used by other examiners or patent agents, in other searches, or by the same person after a prolonged time period.

Method C12 for Defining Inventions

A novel method for representing inventions is used, comprising:
a. Learning/Understanding each invention—this is a manual process, which can only be performed by people having expertise in Patent law and the relevant technical discipline;
b. Rendering/Defining the above understanding of the invention in a standard, mathematic form—the Invention formula™, which can be easily used by other such Experts, and is also computer readable;
c. Automatic processing of inventions in the Invention formula format, to search for similar invention, decide on patentability, etc.

**End of Method**

Patent searches today are very difficult, for there are many millions of patents and applications, in many databases. Each database has different requirements. For the non-initiated, this is a formidable task. Searches may include not only patents and applications, but also new technology, products, scientific developments, etc.

To assist the inventor with these searches, the present disclosure details searches in several dimensions:

a. According to inventor's overall strategy: Prior art technology search; Patentability search; Infringement search; Early warning threats search.

b. The basic technology used (and the suitable computer program; where the program runs, whether in the server, in user's computer, etc.): Java/C/C#/.NET/C++/VC++/VB/Perl Script/Executable/Plugin/Module/ActiveX/JavaScript (JS)/VB Script/JScript/Flash/DOM/HTA/HTC/Scriptlets/CGI/Python/Perl/C/PHP/JSP/ASP/SQL/DBI or other server side

c. Type of search:
PD-Search—Parallel Databases Search. search desired terms in many databases, concurrently
Q-Search—support with the search strategy itself
N-Search Method—search for a specific patent/application number in many databases

d. Cost of search—basic approach regarding cost of search.

Accordingly, various methods are detailed below by way of example.

(7) A Multipurpose, Multisource Search Method and Strategy, QualSearch™

The new method may achieve various purposes, such as technology search, patentability, infringement, early warning searches.

The method may be used to search worldwide for a specific patent, a patent search in multiple databases, and using an improved search strategy.

Method S2—A Multisource, Multipurpose Search Method

FIG. 37 details a novel search method and strategy. The search may include, in an integrated package: Prior art technology search; Patentability search; Infringement search; Early warning threats search.

a. A choice is given to applicant: either to use search utilities at the patent attorney's site, or to download our search program to his computer. QualSearch™—our office search, may include, among others: Prior art technology search; Patentability search; Infringement search; Early warning threats search.

b. Initially, the user sets the parameters for the search:

Type of search 4711 (ie Technology, Patentability, Infringement, EW)

Terms or keywords 4712 for the search

Sources 4713 to be used, such as specific patent offices, free resources, paid sources for searches.

Limiting factors 4714, such as limiting the search in time, cost, number of entries, geographic scope, etc.

Invention definition 4715, such as a list of keywords or keywords in mathematic form, such as a Boolean expression.

c. Devising the Search and Evaluation Strategy 472, according to the selected parameters and other variables and algorithms stored in the system.

d. Technology search 4731—performed if chosen or if necessary as preliminary for another of the searches. Used to gather accepted terms used in a specific scientific discipline, relevant scientific laws, information on commercial products or other info.

e. Patentability search 4732—evaluates the chance of getting a patent approved. The relevant prior art may include patents, patent applications, technical publications, products on the market, etc.

Even unpublished applications (not yet available in a search) may prevent one from receiving a patent.

This search may use results from Technology search 4731, ie terms, products.

f. Infringement search 4733—evaluates the chance of infringing on another's patent.

This search may use results from Technology search 4731, ie terms, products.

g. Early Warning search 4734—warns of emerging technologies, as disclosed in newly published patents or patent applications.

This search may use results from Technology search 4731, Patentability 4732 and/or Infringement search 4733.

h. Results processing 474—the search results may be verified, consolidated and purged to remove multiple listings, etc.

i. Reports 475—various reports may be issued, either textual, tabular and/or graphic, as desired.

j. The search results may also be used to refine the search strategy, in a multi-iterative process as illustrated. The initial selection of search strategy may be disconnected from the actual prior art; using preliminary results, the search strategy may be improved.

***End of Method***

This is an integrated method, wherein the various search types support each other to share information and convey a multidimensional presentation of the subject being searched.

For example, the Technology search may unveil the standard, accepted terms used in the scientific discipline researched; these terms may then be used in the Patentability or Infringement searches. The EW search detects changes in the threats map. It may indicate changes from the last performed, most updated Patentability/Infringement searches.

Method S3—An Internet Search Method

a. Open web window, using Java script JS for example

b. receive keywords and destinations (ie list of Patent Offices)

c. adjust keywords to destination (each location may require the data in a different format)

d. open windows with adjusted data using script; perform and display search.

***End of Method***

Method S4 of Implementing the Q-Search

QualSearch™: Perform search through an interface between user's PC and the Internet. There are three main implementation methods:

Patent4U: promote patent protection and a possible business using some of our methods or mechanisms. This includes means to help define the invention, defining the technology and means used, making a consistent patent application, making drawings and directing the applicant, wherein the applicant can control which stages are required and how much he wishes to invest. Patent searches and relating to other inventions and prior art may be presented.

In addition, no personal meetings are mandatory. Rather, the user can promote his idea completely using electronic means (including at least one of the following: Internet, email Fax or Telephone).

There are three basic technologies presented for performing searches:

T1. Using mainly: Java/C/C#/.NET/C++/VC++/VB/Perl . . . Script/Executable/Plugin/Module/ActiveX/ or other installed application at user's PC. Authorization is required, thus it is likely to be used only upon trust. More can be implemented in the user's PC, including performing searches, gathering and analyzing the results.

T2. JavaScript (JS)/VB Script/JScript/Flash/DOM/HTA/HTC/Scriptlets/HTML/DHTML/XML/CSS or similar technology, by which it is possible to perform some or all of the required operations in the user PC, automatically. No special security alert or installation requirement is likely to be presented. It may be required to enable support for some of the features, such as in the “preferences” of the Explorer or Modzila Internet browsing software. The user would have less fears and less knowledge would be required.

T3. CGI/Python/Perl/C/PHP/JSP/ASP/SQL/DBI or other server side applications.

Since the program is running on the server, no special security alert or installation requirement is likely to be presented. This would also allow global support for different browsing software packages, as data submission and results would be the same (such as upon using Forms and get/post methods). The pitfall is that more server resources are required and the service may become slower.

The above technologies T1-T3 can be combined in any manner, For example using T2 and T3, each of searching and analyzing the data can be performed either at the server or at the user's PC, or in both.

Additional help and support: by browsing at our site, or a sister similar website, and using standard technology of (2) (of even old HTML versions) it is possible to direct the user and present forms. Using dynamic pages which support scripting of any form, it is possible to further monitor user behavior and help him. This is useful for preventing future errors of any kind, or too many results, that will occur upon submitting invalid or inaccurate data.

Secure Links can be maintained using any technology, with T1, T2 or T3. It is possible to establish an SSL secured connection, set a secure site HTTPS or use other technologies for supporting security. For using SSL no installation may be required.

Although most free patent or related search engines do not support SSL, our Patent4U server can support SSL between the user and our server.

Cookies, IP monitoring or other options would allow making a more useful session, monitoring what the user has already done and requested, and providing relevant content, services and guidance accordingly.

It is possible to use Unix/Linux/Windows compatible server, with available technology therein for supporting this invention.

e-commerce technology and shopping cart may help the user define exactly what product is desired. It is preferred that this would be done in two stages, in the first the user receives free information relevant to his interest and then decides what kind of service is preferred. He would then request a price quote and an order can be sent automatically or manually, such as by: email, fax or by phone. This can be implemented by filling a form and submitting it to our server, or sending it by fax, or ordering by phone the service type, as presented in the site.

The user can overview possible services and decide in which he wishes to invest, in which he wishes to save, and/or in which he does not wish to invest at all, or rather to perform it himself (such as making a search with the guidance at the site or submitting a provisional application).

The user can plan future costs or prepare a budget for promoting his technology, based on assessment of future required services.

Defining the invention using our mechanism can help in both making searches and preparing a patent application. This can save time and the effort of describing and defining the invention all over again.

Data Binding with Explorer or any similar technology can be used for accessing and processing data.

In a preferred embodiment, making and submitting drawings, making searches and describing the invention is completely done using only (T2). Thus, using scripts and under the Internet browser the user can completely define and submit the Invention. Additional options in this embodiment: SSL, paying or getting a price quote, submitting or preparing legal documents, finding drawings, receiving guidance (in real-time using chat etc. and/or from targeted articles), making charts describing systems or methods, etc.

***End of Method***

Method S5 for Parallel Databases Search (PD Search)

1. Define Keywords Possibilities: Help with keywords based on categories, or pictures, make translation or use/direct to translation sites. Find synonyms, antonyms or similar words or words from a certain field.

Supply words based on standards, category, type of business, etc.

Sort keywords and phrases which are equivalent in the same line (“or”) Sort unique groups of keywords and phrases in different lines (“and”)

2. Select Databases. For example, any one or more of the following: USPTO Patents; USPTO Applications; Esp@cenet (several databases); Japan Patents Database; PCT.

This is useful since each database may not completely include others and some are limited in number of keywords or in search fields (such as USPTO may search the Full Text while Esp@cenet may search only Abstracts).

Preferably, many free access databases will be included (patents, applications, and maybe also other prior art).

3. Calculate terms and display search possibilities. In the US PTO site, for example, many keywords can be placed in a search, however in Esp@cenet only several words can be placed in each field. It can be possible to make several iterations or open several windows for more keywords. For example:

If only 4 keywords are allowed, 5 windows, one for each search can be opened, for making 5 keywords search, each time different 4 words out of the five. 30 Windows for making 6 Keywords search, etc. The user may choose which search is preferred, or it may be chosen automatically by the system.

Automatic: A Rough Estimate (or a quick search) can be performed. This can be pre-checked, for example, by maintaining a table with the number of patents in each field, for example: Airplane and computer: 100,0001M patents; Airplane and wing: 1.5M-4M patents; and so on.

This may give an initial estimate. Such info may be useful to advise the user to remove common words from search, such as: “can, computer, internet.”, etc. Otherwise, such words may flood the search with irrelevant results.

In another embodiment, the search may include patents class/subclass information, and such info may be used to focus the search.

4. Perform detailed Search

***End of Method***

Method S6 for Parallel Databases Search (PD Search)

Searching in some databases simultaneously saves time for the user, since it takes in any case some time for each server to process and return results. This way it is done at the same time, rather than once at each search engine, although it is possible to do this in one sever at a time as well.

A. Adapting the search to the database formal requirements.

For example, Adjust as wildcard the letter * for keywords in esp@cenet or $ for keywords in USPTO, thus build the search query based on the rules of each search database.

B. Open a window for each search query in each Search Database, and make the query based on the search engine rules.

All stages so far can be implemented with JS or a combinations of (2) technologies, automatically or with a guidance and control of the user.

C. Gather Info

It may be possible to gather all search results from all windows, in order to present one preferably sorted list of results, wherein each patent (including number, title, etc.) appears once, and need not be re-examined several times.

It is possible to also display how many times each patent (or application) appeared in the searches. A patent which appeared in more search queries is may be closer to the invention.

The information can be gathered using any one, or several of, the technologies T1-T3.

Using technologies (T1) or (T3), all search results information can be gathered automatically.

(T1)—At the user's PC, the application would access search windows and take the data. It may be also possible to navigate between pages, refine searched, etc.

(T3)—At the server—the server can make search queries directly against patent database servers, gather results and edit them. Or the results can be supplied using any method from user's PC.

(T2)—Using scripts may be more limited, thus it might be possible to only open windows with search commands by the server, and the results should be gathered manually by the user himself.

In addition, it may be possible to manually gather the information by the user, using Copy and Paste in the search results windows. Thus, the user may Copy and Paste all relevant results, possibly all the results, and will paste them into a text box or equivalent, in an Internet window in a form of our site.

Results from different queries may be added and submitted to the Server using such a form, or may be analyzed at a PC application or Script. The server can further analyze and display results, with possible links to each patent. The user will be able to save, copy print or start checking the results.

It is also possible to remember a user by placing a cookie in his PC, or asking him to provide a user name and password, or sending a special link to his email. Thus, the user will be able to review the results later, and to continue analyzing the patents.

D. Analyze Results

It is possible to analyze the results by a professional—and the user can ask for a price quotation for each patent to be analyzed. A cited patent can be compared against the user's invention—in this case the invention should be defined as well, for getting a price quote.

The user can analyze the results himself. In this case, he can use Q-Search to find relevant patents, applications, and/or other available published info such as Abstract and Drawings.

***End of Method***

Method S7 for Parallel Databases Search (PD Search)

a. The agent or user may use the new system to automatically trace the patents data using N-Search and all relevant info, or it is possible to pay an additional fee and the patents will be retrieved professionally. These can be sent by email or provided on CD.

2. If also consultation is required, each result/cited document can receive a grade, such as:

0—Irrelevant.

1—From a similar Field however not interfering

2—Has few/minor common ideas.

3—Has many/major common ideas.

4—Seem to cover the whole invention.

3. Preparing a report similar to step (2) above, but referring to patents class/subclass rather than to ideas. Thus, the report indicates the measure of overlap (none—some—total) between the new and prior art documents.

4. Preparing a report similar to step (2) or (3) above, but referring to patents claims rather than to class/subclass or ideas. Thus, the report indicates the measure of overlap (none—some—total) in the claims, between the new and prior art documents.

5. A final report can be provided in the more costly search which include such grades for patents or other prior art documents which were analyzed.

***End of Method***

Q-Search Method S8

This service will focus on searching patents, applications and relevant data. The user will be directed to choose a preferred search method. The user can control cost and time spent on the search, and he can also plan the search strategy, for example technology/market overview search within a week and Patentability search 6 months afterwards.

The server or application on PC can automatically remind the user as well. The kind of data presented and search focus would vary with kind of service required:

1. Technology/Market overview search/Initial Search—a more general search approach may be initially recommended, to find keywords and major companies, etc. This can help decide roughly how much activity there is in the field, or for making strategic business decisions.

Subsequently, a more detailed technology search may be performed.

2. Patents Search—from free with guidance search, such as using PD Search, to ordering patents search from our office, defining where to search and how much data is desired, to more expensive searches.

The user will receive a price quotation and a definition of the search/options to be made. A search report can be sent afterwards.

3. Patentability Search—A thorough search including other prior art. This may be done in parallel, to save time, and the results may then be collected for later analysis.

Periodical searches can be subsequently be performed (EW searches), to look for newly published applications and granted patents. Thus, the user will periodically receive reports about other patents and applications, so he can keep up to date.

Automatic searches can be performed at the user's PC or at the server, or automatic notifications can be delivered to remind the user to do so. Patents will be searched at various databases, free and for a charge, for covering more applications, and patents' data. Official searched can be ordered as well. As information is gathered, it is possible to analyze it.

It is preferred that an initial search would be done first with initial patent protection, as described in this invention.

4. Infringement Search—In this case, only searches in local databases and local patents will be performed (in country of interest). It is also possible to include priority published data of interest, such as PCT applications as well. Components belonging to the invention will be defined and relevant patents will be searched for as well.

In each search, the user can define how thorough a search to do, how many resources to include, and he can define price limits.

***End of Method***

N-Search Method S9

The user often wishes to trace a patent or application, for many reasons such as:

1. Cited document, from the examiner.

2. Application was found on search report.

3. Was told about a certain patent from someone else, read about it, etc.

In these cases, it is possible to use the PD Search, such as for applicant and/or inventor name, title etc.

The N-Search would specifically help to trace a patent based on a number, and any additional available information. It would translate the number to different formats, each as required by a specific resource/database, and try to search there. The user would decide what is relevant and may access data available there.

N-Search can be implemented using any of the technologies T1-T3, and preferably just using a form with a simple script, to translate numbers.

***End of Method***

### EXAMPLES

1. Find Japanese Application Number: 2004069375 At esp@cenet: add “JP”, at numbers search page

Page of “Number Search” at esp@cenet: http://ep.espacenet.com/search97cgi/s97_cgi.exe?Action=FormGen&Template=ep/en/number.hts

Add “JP” before number, to have only one result. Query: JP2004069375

Page of JPO, Translation and data: http://www4.ipdl.ncipi.go jp/Tokujitu/tjsogodben.ipdl?N0000=115

There are two options:

If the number starts with digits of year then: (or they are after “JP” letters, etc.) Add: “A” at kind code field, Add: Slash after year “2004”. Query: 2004-069375

If the number does not start with digits of year then: Add: “A” at kind code field, Add letter: “H”, Add Slash after two first digits. Query: H11-351940

2. Find UK Application Number: 0425716.8

At UKPO, at “Application Number” add GB. Query: GB0425716.8 http://webdb4.patent.gov.uk/patents

At esp@cenet remove 0.8 for several results. Query: 0425716 Remove “04” from beginning of number, remove “0.8” at the end, and Add GB200400 at start, to have one result. Query: GB20040025716

3. Find PCT Application Number: WO 01/84090

At esp@cenet: Remove “/” and spaces. Query: WO0184090 Another possible formation, other application. Query formation: PCT/IL99/00139

N-Search Method S10

1. Get relevant information and number, based on what the user knows. It is possible that only the number is known. It is possible that the user will define one or more states or regions. Whether it is Application or Patent, Mentioned Dates, Title or keywords and Names of Inventors/Applicants.

2. Permitted formations are compared with defined formations in a database, preferably within our server (but possibly loaded to the user's PC such as by T1 using a script, etc.) For each type of possible formation, such as application in the US within certain years, possible formations would be defined, each including beginning and/or ending letters, number of numbers digits, special characters, overall numbers within and possibly valid numbers' range versus years.

For each such value, the valid formation for the search engine is kept as well, or required modifications, or otherwise such a description that would eventually allow submitting the correct search expressions for that number in each relevant database, and at the right fields of the database's search mechanism.

3. The more information provided by the user, the less options for a number exist. In addition, more fixing possibilities arise as the number of possibilities and possible formations is reduced. Irrelevant or not required symbols, letters, spaces or numbers can be removed. Missing or required symbols, letters, spaces and numbers can be added.

4. Relevant windows with valid searching terms submitted within them (such as using with T1 Get/Post methods, etc.), will be opened. The user can see all accessible information, such as one or more patents/applications in one or more databases. It is preferred each such query would be in a different window, however frames or other (such as T2) technologies can be used as well.

5. Help and guidance may be provided as well—such as the time it take for a certain application to be published. This will give the user indication, for example, that the type of application he is looking for is not likely to be published yet, additional info such as when is it likely to be accessible and where can be provided as well.

6. The commands of the user can be kept, at the server and/or by cookies, etc. It is possible then to modify the search—such as by adding, changing or removing details. This is useful if too many patents/applications were found or not the right ones.

***End of Method***

Patents Search Method S11

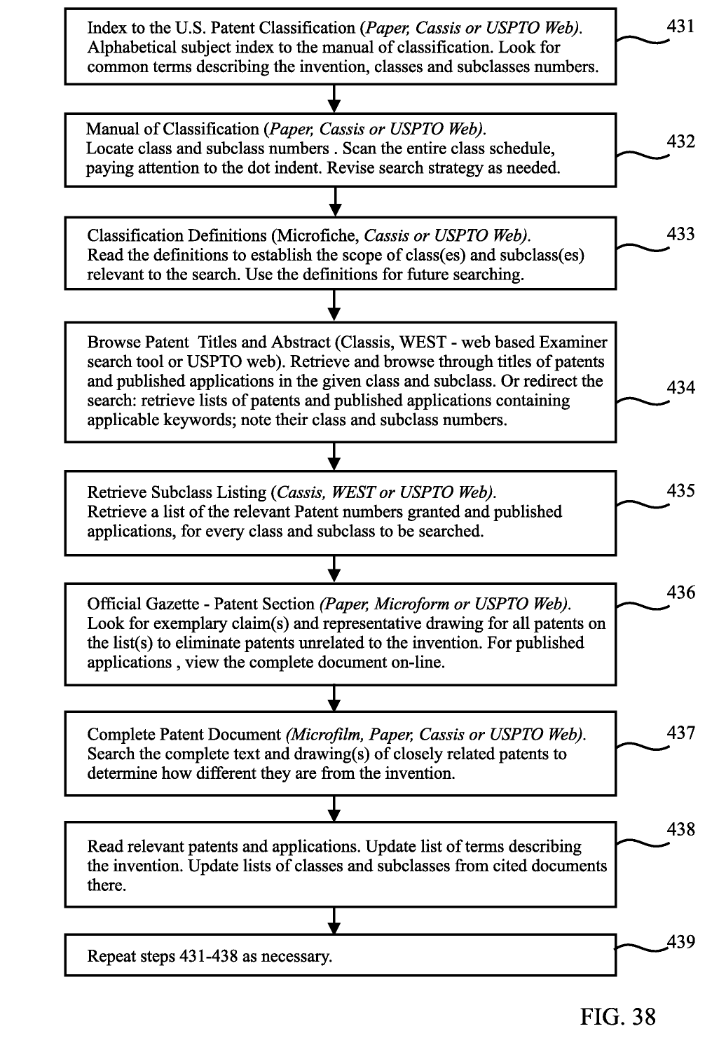

FIG. 38 details a method for performing a patents search at the US PTO site. This is a modification of the method presented at: http://www.uspto.gov/web/offices/ac/ido/ptdl/step7.htm

and entitled: The 7-Step Strategy

The user may choose to implement the original method detailed there. This is an example of a for free search which may be performed by the applicant if he/she so chooses.

The method, suitable for implementing Step 43 of FIG. 8, includes:

a. Reviewing the U.S. Index of classification 431

Index to the U.S. Patent Classification (Paper, Cassis or USPTO Web). Alphabetical subject index to the manual of classification. Look for common terms describing the invention, classes and subclasses numbers.

b. Locate class and subclass with the Manual of Classification 432

Manual of Classification (Paper, Cassis or USPTO Web).

Locate class and subclass numbers. Scan the entire class schedule, paying attention to the dot indent. Revise search strategy as needed.

c. Read classification definitions to define relevant classes 433 Classification Definitions (Microfiche, Cassis or USPTO Web). Read the definitions to establish the scope of class(es) and subclass(es) relevant to the search. Use the definitions for future searching.

d. Browse patent titles and abstracts 434

Browse Patent Titles and Abstract (Classis, WEST—web based Examiner search tool or USPTO web). Retrieve and browse through titles of patents and published applications in the given class and subclass. Or redirect the search: retrieve lists of patents and published applications containing applicable keywords; note their class and subclass numbers.

e. Retrieve subclass listing 435

Retrieve Subclass Listing (Cassis, WEST or USPTO Web). Retrieve a list of the relevant Patent numbers granted and published applications, for every class and subclass to be searched.

f. Look for examples of applications in the Gazette 436 Official Gazette—Patent Section (Paper, Microform or USPTO Web). Look for exemplary claim(s) and representative drawing for all patents on the list(s) to eliminate patents unrelated to the invention. For published applications, view the complete document on-line.

g. Review complete patent documents 437

Complete Patent Document (Microfilm, Paper, Cassis or USPTO Web). Search the complete text and drawing(s) of closely related patents to determine how different they are from the invention.

h. Read relevant patents and applications 438

Read relevant patents and applications. Update list of terms describing the invention. Update lists of classes and subclasses from cited documents there.

i. Repeat steps 431-438 as necessary [439]. As the user gains experience in the field, he/she will better perform all the stages to focus the search on the relevant issues to the invention subject to the search.

***End of Method***

Patents Search Method S12

A patents search may be performed by tracking cited documents in a patent or patent application:

a. receive list of patents, applications and other prior art references. Optionally also receive limiting parameters such as maximal number of documents to search, time period (from date . . . to date . . . ), etc.

b. search the documents in (a) for references or cited documents therein.

c. count multiple references to a specific document. This may indicate which documents are more important.

Optional: store additional information such as class/subclass of cited documents, terms used there, etc.

d. end the search when no more documents can be found, or the search limit was reached, according to the limiting parameters in (a).

e. prepare and present search report: the documents found, the interrelationships among them, number of occurrences of each document, etc. The results may be presented in textual, tabular and/or graphic format.

***End of Method***

Method P1—Automatic Comparison of Patents/Applications

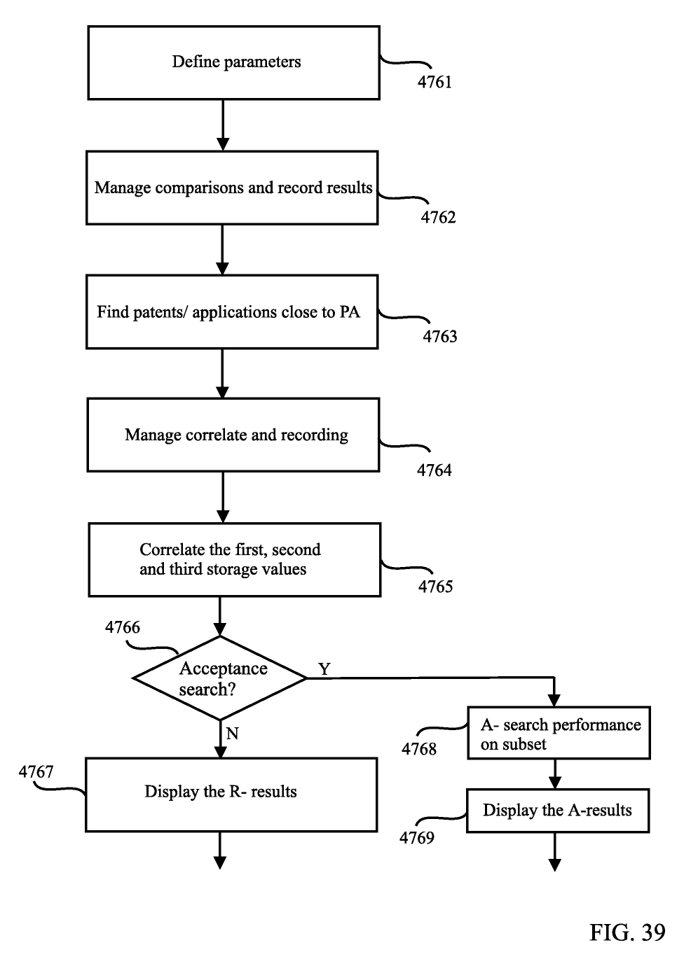

FIG. 39 details an automatic method for assisting in comparing patents and applications:

a. Decide which comparison to do: [4761] Rejection Search, to search for closest prior art (in order to reject the present claims if possible) or Acceptance Search, for different inventive concepts among the closest patents, to support patentability of the present application. Define comparison parameters, ie whether to only compare claims, or the present claims with also inventive concepts in prior art, their drawings. Define parameters for comparisons 4761

b. For each claim in the present application (PA), in Boolean form, do steps (c) to (e) below. [4762]

Manage comparisons to be performed in (c) to (e) and record results 4762

c. find all the patents/applications close to PA, for example in the same classes/subclasses, including predefined keywords etc. [4763]

Find patents and/or applications close to PA 4763

d. for each of the close patents/applications in (c) or—for the whole

patents/applications database: [4764]

Manage correlate and recording 4764

1) compare each claim with each claim in PA, both in Boolean form. Compute a match indicator value, ie in the range 0 (totally different) to 100 (identical) according to the elements in each claim and a predefined algorithm. Store match values above a predefined threshold, with pointers to the close patent/application and the claim there, to which it relates, in a first storage Claims_match.

2) compare each Invention with each claim in PA, both in Boolean form. Compute a match indicator value, ie in the range 0 (totally different) to 100 (identical) according to the elements in each claim/invention and a predefined algorithm. Store match values above a predefined threshold, with pointers to the close patent/application and the Invention there, to which it relates, in a second storage Inventions_match.

3) compare each drawing with each drawing in PA, both in mathematical equation form (ie mesh topology).

Compute a match indicator value, ie in the range 0 (totally different) to 100 (identical) according to the elements in each drawing and the connections between them, and a predefined algorithm. Store match values above a predefined threshold, with pointers to the close patent/application and the drawing there, to which it relates, in a third storage Drawings_match.

e. correlate the first, second and third storage values [4765] to find patents which may be close or identical to the present application/patent. Correlate the first, second and third storage values 4765

Compile a list of “close” patents/applications, and the close elements therein, for example:

claim no. 6 here is close to claim 22 in patent . . . , closeness 77%

claim no. 6 here is close to invention 31 in patent . . . , closeness 63%

FIG. 29 here is close to FIG. 7B in patent . . . , closeness 61%

In one embodiment—compute cross-correlations among each group (Inventions, drawings, claims) and between them to compile values of indices of closeness.

f. It is Acceptance Search? [4766] Then goto (h).

Acceptance Search? 4766

g. Present the results to user—display, print and/or store them. [4767]

Preferably, the list is arranged in a decreasing order of closeness, to bring to attention first the most relevant of the prior art. End Display the R-results 4767 (Rejection-related results)

h. Searching for patentable, distinguishable matter of the present application, in the close prior art patents find above (in the description and possibly drawings there).

The search may help find and distinguish novel, patentable matter in the application. [4768]

A-Search performance on subset 4768

i. Display results: The prior art is arranged in a reverse order, with closest matches last in the list.

Present new matter, that which is different from all the prior art, in a reverse order: the most different first. [4769]

Display the A-results 4769 (Acceptance-related results)

***End of Method***

Notes:

1. The comparison stage in the above method may be enhanced to include Invention to Invention comparison, or comparison of Invention or claim to drawings in equation form.

An invention, or inventive concept, is a novel feature in the disclosure which may or may not be included in a claim.

There may be novelty in drawings; there may, or may be not, a corresponding description in the text. Thus, it may make sense to compare inventive concepts in the present application (in text or drawings) with such concepts in prior art, in all the combinations possible.

2. The goal of the comparison: either to find the closest aspects between two applications, or the most different. The former is used to search prior art which may prevent patentability, ie by Examiner or competitors. The latter may be used by the inventor/applicant, to get a patent approved.

3. When looking for patentable, distinguishable matter in the application, the search may help in finding novel, patentable matter in the application. The prior art is arranged in a reverse order, with closest matches last in the list.

4. Computers may perform multi-to-multi comparisons, between each inventive concept in the present application and all the inventive concepts in patents which were found to be close to the application; Each inventive concept which is different from all the prior art thus defined, may be claimed as novel and patentable.

A computer may only recommend, the analysis and decisions are made by humans. However, the computer may perform a huge computing/comparing effort which may be impractical for humans to perform.

5. Find basis for combined references: sometimes an Examiner will look for two or more prior art patents, which together are used to reject the present claim. The above method may be used to find such patents, by searching for part of the new claim at a time.

For example, assume the present claim contains the structure A+B+C+D. A search may be performed for A+B+C and another for A+B+D . The first search finds a patent P1 for A+B+C+E, and the second: for A+B+D+F The text supporting these claims is then found using the inversed matrix and is searched to find something to support such combination.

FIG. 40 details a menu to user for performing patent searches, using the N-Search method detailed above.

This is a multi-database, multi-window search on the Internet.

The user can enter a patent or application or publication number in the patent number window 611, and the maximal number of windows in the window 612. The software will open a plurality of windows as required by the search (one for UK PO, another for US PTO, etc.) up to the limit specified in window 612.

Moreover, the user may indicate the type of document required 613, and if known, the country/place of document 614 and/or additional info windows 615 and required info 616. The user then presses the Search now button 619 to perform the search.

Listing of a computer program for performing such a search:

<html><head><script type=“text/javascript”>
function nsearch(pat11) {
// Perform any manipulation using any of the form's data.
// Call other function, algorithms or submit form's data to using GET,
POST Methods, etc.
var
aaa=“http://v3.espacenet.com/results?DB=EPODOC&sf=n&NUM=
”+pat11+“&C
Y=ep&PGS=
10&ST=number&LG=en”
window.open(aaa)
// document.write(aaa)
}
</script>
</head><body>
<h2>N-Search (TM)</h2><br />
<h2>Copyright(C) 2006 Marc Zuta and Idan Zuta</h2>
<table width=“400” border=“0”><tr><td>
<form>
Enter any patent number: <input type=“text” name=“pat_num”
value=“” /><br /><br />
Maximum Number of Windows: <input type=“text” name=“num_wins”
value=“10”
/><br /><br />
<fieldset>
<legend>Legal Status/ Type of application</legend><br />
<input type=“radio” name=“legals” value=“1”> Patent <br />
<input type=“radio” name=“legals” value=“2”>Application <br />
<input type=“radio” name=“legals” value=“3”
checked=“checked”>Can be either a Patent or an Application<br />
</fieldset><br />
<fieldset><legend>Country/ Place</legend><br />
<input type=“checkbox” name=“country” value=“1”
checked=“checked”>International Application/ PCT/ WO <br />
<input type=“checkbox” name=“country” value=“2”>EPO European
Patent/Application <br />
<input type=“checkbox” name=“country” value=“3”>UK/GB/ England
<br />
<input type=“checkbox” name=“country” value=“4”>US/ United States
<br />
<input type=“checkbox” name=“country” value=“5”>CA/ Canada <br />
<input type=“checkbox” name=“country” value=“6”>CN/ China <br />
<input type=“checkbox” name=“country” value=“7”>JP/ Japan <br />
</fieldset><br />
<fieldset><legend>Additional Details - Optional</legend><br />
Name or part of a Name: <input type=“text” name=“additi1”> <br />
Title or part of a title: <input type=“text” name=“additi2”> <br />
Filing Date: <input type=“text” name=“additi3”> <br />
</fieldset><br />
<fieldset><legend>Required Information</legend><br />
<select name=“requi”>
<option value=“1”>Whatever Possible <option value=“2”>Legal Status
<option value=“3”>Abstract <option value=“4”>Drawings <option
value=“3”>Full text
<option value=“4”>Original Document <option value=“5”>Translation
</select></fieldset><br />
<br /><input type=button value=“Search now”
onclick=“nsearch(pat_num.value)”>
<!-- Any form's data can be sent. GET/POST and additional scripts can be
used as well. -->
</form></td></tr></table></body></html>

Method S13—Multi-Database Search (N-Search)

Referring by way of example to FIG. 40, a display to user resulting from the above computer program:

N-search is a method for finding a patent from its number. The number provided by the user may not be precise, or not complete.

To find it worldwide is not a simple task. The new method helps the user to locate it.

The system finds it by type, and display info if possible.

It uses additional info if available—name of applicant, date of issue or filing. It can use it to check, choose one of many results, the result which also gives the additional info.

Depending on what the user wants: present status, text, drawings, What the system sends—is a valid query or a plurality of such queries. These queries will not result in error messages. This will reduce the load on database.

Thus, we help the frustrated inventor, who gets only errors. If the user has an invalid number—we will tell him, explain, not just display ERROR if incomplete; rather, we will complete the number for various options, and the user will see several windows with several results. He can choose and find the correct, desired one.

a. The user enters a patent/application number in window 611.

A partial number may be entered, the best the user knows.

b. the maximal number of windows to concurrently open is entered in 612. In each window, a different database (ie in US, GB, Japan) or type of search in a database (ie patents, applications) may be entered.

c. whether this is a patent or application, if known to user, in window 613

d. Country/place, if known to user 614

e. Additional details known to user (such as applicant's name, or inventor's or filing date, or title, or issue date)

f. when the Search now 619 button is activated, the system checks the search terms, and corrects them as possible to adapt them to each of the various databases where the search is to be performed.

The user's terms are converted to legal, acceptable terms in each database. The user's terms may be ambiguous; the system converts each such term to a plurality of acceptable terms. A plurality of answers may be received.

g. where possible, the additional terms entered above will be used to solve the ambiguity or reduce the number of possibilities.

h. The corrected search parameters are applied through the Internet to search in various databases. Preferably, the various searches are applied concurrently, and will open separate windows up to the number specified in parameter 612. Otherwise, searches may be performed consecutively.

i. the search results are compared with the additional terms entered above, and the system will try, where possible, to solve the ambiguity or reduce the number of answer.

j. the remaining results will be presented to the user.

***End of Method***

A benefit of the above method is that it will reduce or eliminate the “Error” messages users now receive from databases. These are very frustrating messages, which discourage inventors. This is achieved with the method correcting user's terms and adapting them to the databases.

The method will reduce the workload on the databases, as the number of futile, erroneous requests for searches will be reduced.

Further to FIG. 29, the price/stage table for choosing what to do: it can be used to manage IP protection and its business aspects, in stages. It enables the management of activities to do, tracking and monitoring these activities.

In each stage, a user can choose one of our proposed options, each with its estimated Time to finish range and Cost range.

Each Cost option in the table represents a different possible approach; the user can choose one of these approaches, according to his needs and means.

The actual price (to be sent by the patent attorney's system) depends on the chosen approach and additional info relating to the inventor, the status of the project at present and the goals to achieve and/or the specifics of the case.

For example, in search, approaches may include Free search, search with us, free database search with us, expensive database search by the hour, etc.

The user chooses, then is presented with additional info which is relevant to this case; maybe links, advantages, disadvantages, how much time will take and range of prices, time to do—estimates.

Or—Tooltip =when mouse cursor on it for a certain time, on a square in price/stage table, it will display this info, a tooltip box with summary of the option.

Then the user can submit a request for price quote, to fill form. More details. The price quotation may be issued manually or automatically, per predefined method.

Qual-search—will manage the search at a higher level, using a table as that in FIG. 29. The system will display various options in a Stage/Cost approach, adapted for the search.

Thus, various searches may be chosen by the user, using various approaches. One interface may be used for all these searches, in the various dimensions as detailed above. We help the user to do the search suitable for him.

PD-search is a more technical method, involving the search itself. Mainly on internet, for free. The system helps the user to define the search words, range. To see other patents, to find terms in use now. We fill in info, to open search windows, several searches on espacenet for example, at the same time.

Method S14—Solving User's Problems Relating to Searches

1. He does not know where to search, the location of patents/applications. The methods disclosed in the present disclosure help him by automatically preparing the search commands and sending them to these databases.

2. It is tedious work to repeatedly enter the same terms, in several databases—maybe many databases.

The methods disclosed in the present disclosure help him by using the user-defined terms in all these searches.

3. The same patents may pop up in several windows.

The methods disclosed in the present disclosure help collate the info, organize it.

4. Various searches may achieve a different level of success.

The methods disclosed in the present disclosure evaluates and rates each search for the user. The user may subsequently select only the more effective searches to perform in his/her special case.

***End of Method***

The abovedetailed system and method may be used for various intellectual property protection, such as patent, design, trademark, copyright, trade secret, etc. For each invention disclosure, one or more IP means may be used, to cover one or more aspects of a new product, service and/or technology.

Method S16—Functional Patents Search

Prior art searches using keywords is ineffective: It is possible to use a Boolean equation with many keywords, however the equation may not convey the intended meaning for the searched invention. The search may bring thousands of patents, then more keywords are added to reduce the answer to a hundred patents or less. However, this may exclude relevant patents which were in the prior search. There is no guarantee, and no reason to believe, that adding more keywords will keep only the most relevant patents.

The new search uses a functional description of the invention (or each inventive concept in each claim) in mathematical form, and compares it with similar descriptions in the prior art.

Thus, we now search for a patent which discloses a similar system or method. Using mathematic processing, a distance between our invention and each of the other patents may be computed. The distance is objective and quantitative, by counting the number of same terms and that of different terms.

***End of Method***

b. Examination of the Application

1) Leveling the field during examination

The application under examination and the prior art are brought to a common form using the same standard terms and concise expressions. This may make the examination and patent prosecution process more effective.

In answer to prior art cited by the Examiner, the applicant can:

a] Translate all the relevant terms in the cited prior art, into standard terms. This is the first step in leveling the field, to allow comparing the patent application with the prior art.

A log of changes made should be kept and provided to Examiner, to allow her to verify that indeed there was no substantial change in the prior art—all the changes should be traceable.

b] Compose concise descriptions of the inventions, or inventive aspects, included in the prior art (if not already done—do the same for own invention in the application under examination).

These descriptions should use the standard terms.

c] Comparing the inventions using a computer. The computer can pinpoint the areas of closest similarity, and those of largest difference between the application and prior art.

d] Interpretation of the results by the applicant, re-define the invention if necessary and narrowing of claims.

e] Answer to the Office Action.

2) Support for Accelerated Examination at the USPTO. USPTO requires complex searches and preparations of documents for this venue. Moreover, the applicant or agent should be ready to a telephone interview.

c. Support for Accelerated Examination at the USPTO

Starting 25 Aug. 2006, the USPTO has established a new procedure for accelerated examination of patent applications, to complete examination within 12 months. To be eligible, an inventor has to file an application which is easier to examine, together with a prior art search and further documentation to distinguish the invention from the cited references. It is difficult to comply with the requirements for accelerated examination using the manual, intuitive patent prosecution methods now in use.

For example, USPTO demands that the Accelerated examination support document, Information Disclosure Statement (IDS), detail how each of the claims are patentable over the cited references, indicating where each limitation of the claims is supported in the description, etc.

The applicant is required to include all the relevant prior art in the IDS, but not too many citations (this is considered as obfuscating matter to hide the relevant prior art). How is one to be sure what is most relevant? The applicant has to agree to a telephone interview; it may be difficult to answer (by inventor or agent) without a real-time computer support system.

Method A1 for Preparing the IDS Document

1. The invention is described in formulas or structured text, indicating the links between:

a. innovative concepts

b. benefits achieved from each

c. detailed description text

d. drawings

e. claims

Thus, for each claim there is a link to (a)-(d) above.

There may be a plurality of equations, corresponding to the various aspects and embodiments of the invention.

2. Performing a patentability search, of patents, applications, products and other information in the public domain.

3. The invention in each of the results of (2) above is described in formulas or structured text as in (1).

The info is entered into a computer.

4. Automatic comparison between the expressions in (1) and (3).

Computing a Vectoric Distance (VD) between the invention in (1) and each of the inventions in (3).

VD is a mathematic term used in multidimensional vectors, indicating the difference between inventions (represented as vectors for this calculus): the more aspects of the inventions differ in, and the larger the difference is in each, the further different the inventions are.

Some aspects differences may be digital (1 or 0, yes or no) whereas others may include qualitative/quantitative degrees of difference.

5. Redefining the invention—the user may redraft the claims or otherwise redefine the invention, so as to better distinguish (separate) it from prior art. In this case, steps (1), (4) are performed again to compute the difference of the newly defined invention.

6. Including in the IDS document the prior art which are closest to the invention under review.

In support of the IDS, include the mathematical definitions and results (differences in a multidimensional space) from each of the prior art. The basis for each difference, down to each element of the claimed invention and each of the prior art, may be traced down.

A wealth of information may thus be presented to the Patent Office, in a concise and precise way—no storytelling, just the facts.

Maybe the Patent Office will accept more than 20 references, if they are prioritized and the relevance of each is precisely specified. This may allow the Examiner a human's review—one cannot completely trust a computer.

7. Store the information, to support a dialog with the Examiner during the examination, especially the telephone interview.

**End of Method**

Method A2 for Answering the USPTO Telephone Interview

During accelerated examination at the USPTO, the applicant has to submit to a telephone interview. A private inventor may not understand the legal implications of his/her answer, and may answer wrongly and incur damages, especially if surprised by the examiner and without the possibility to ask for professional counsel.

A professional agent may also be surprised, as he may handle many cases and may not have ready answers.

In any case, a computer with information linking the claims, the parts of the application and prior art, may help in arriving at a better decision.

Furthermore, the computer may allow communications between agent and inventor, to discuss examiner's questions to better clarify matters.

The method includes:

1. Storing information with links between the aspects of the invention:

a. innovative concepts

b. benefits achieved from each

c. detailed description text

d. drawings

e. claims

and also links to corresponding inventions in prior art.

The computer will also store, in electronic form, the text disclosure and drawings, such as to be readable according to the links a-d above.

2. Storing a menu of possible issues or questions which may be raised by the examiner, and possible responses.

3. When queried by the examiner, activating the computer to select answer to questions according to the options of (2). If an unexpected question, then asking for time to consider. Logging the transaction.

4. Establishing a communication link between inventor and agent (regardless of whom the examiner has contacted). Allowing for private communications between the agent and inventor, to which the examiner is not privy (this may be implemented with switch means in hardware, or a method implemented in software).

**End of Method**

d. Improving/Correcting the Prior Art

The fast growth in the prior art (patents, published applications, etc.) makes the examination/patent prosecution more and more difficult, as the number of examiners and patent attorneys does not grow at the same rate. Thus, a crisis should be expected at some time.

To counter this effect, the present invention includes, among other means, improving the prior art. As prior art is translated into standard form during a patent's examination for example, that translation is stored in a database of prior art. It is available to other examiners, patent attorneys and applicants in other cases as well.

Efforts to improve the prior art may also be initiated by a Government, the same way as is done in earth pollution cases—low quality patents can be seen as a form of IP resources pollution.

Patent owners may also be requested to clarify matters in their patents as a matter of routine, for example as part of patent maintenance activities.

The database of corrected, translated prior art may include patents worldwide, for now the patenting system is international, and this invention provides a framework for collaboration between countries.

Improving the Quality of Prior Art

Improving the quality of the patent application is half the equation. The other half is the prior art, to which new applications are often compared.

There are three basic problems with the prior art:

a. Part of it is low quality. For example, published patent applications do not have to pass a technical or patentability review; some were refused in examination and are no longer relevant to the applicant. These applications, nevertheless, are legitimate prior art and have to be taken into account during the examination of a new application. Examiners, patent attorneys and inventors waste time and effort, time and again, in a Sysyphic effort to distinguish from this low quality prior art.

In contrast, technical articles may have to pass the review of an expert in the field, and also editor's decision, for example, to be published.

b. The collection of prior art grows at an ever increasing rate, both in the number of applications and in their complexity.

c. Prior art is now international, with significant parts thereof in foreign languages, including for example Arabic, Chinese, English, French, German, Japanese, Russian and Spanish.

Parts of inventor's intent may be lost or distorted during translation, this lowering the quality of the application in the target language.

The present invention discloses a positive mechanism which will counter the above negative trends, to reduce the amount of time wasted on the prior art. The new mechanism includes novel processes which will continuously improve the prior art. Thus, references to the prior art will be more effective, to save time and effort during a patent's examination as well as during patent infringement or patent canceling proceedings, for example.

Method S15—Analyzed Patents Repository

It is a waste of effort for many Examiners each to read and analyze time and again each prior art patent. Using the present methods, a repository of analyzed patents is maintained, to which can contribute all the Examiners.

1. For each patent or application used as prior art cited document, prepare a description in Mathematical form, including all or part of the following:

a) A List of terms used in the application 458, see FIG. 6

b) Hyper links 455—links to references in the text or to the drawings

c) The text and drawings of the disclosure 456, in Math form

d) Cross-reference between application parts 457

2. Generate an electronic document including the above and a digital signature of the author.

3. Store the electronic document in a Repository. The Repository has search means so devised as to read and utilize the description in Mathematical form.

***End of Method***

1. A method for describing an invention comprising:
a. defining a vocabulary of standard terms;
b. describing the invention in a concise form and using only standard terms for the substantive description.

2. The method for describing an invention according to claim 1, wherein the description in concise form uses mathematical equations or mathematical-like statements or tables.

3. The method for describing an invention according to claim 1, wherein the description comprises, for an apparatus invention, the parts of the apparatus and the interrelationships therebetween, and for a method invention the steps of the invention and the order of execution of the steps.

4. The method for describing an invention according to claim 3, wherein the invention description further includes info indicative of the non-obviousness of the invention.

5. The method for describing an invention according to claim 4, wherein the info in the concise invention description comprises, to the extent possible, pointers to the detailed description in a patent or patent application, where detailed info on each patentability-related feature can be found.

6. The method for describing an invention according to claim 4, wherein the info in the concise invention description comprises info detailing a compliance of the invention with patentability requirements.

7. The method for describing an invention according to claim 6, wherein the method is used to draft each claim in a patent application, so that each claim includes the patentability info relating to the invention claimed in that claim.

8. The method for describing an invention according to claim 1, wherein the concise description further includes means for it to be readable by a computer for automatic processing purposes.

9. The method for describing an invention according to claim 1, wherein for each term which is substantial for defining the invention and wherein that term has more than one meaning in a language of the description, a further indice is include to limit that term to only one meaning.

10. The method for describing an invention according to claim 9, wherein the indice is a number indicative of the field of that term according to the meaning of the term in that description.

11. The method for describing an invention according to claim 10, wherein the indicative number pertains to a standard classification code such as the American or International classification code.

12. A method for comparing an invention document with one or a plurality of prior art documents, comprising:
a. bringing the documents into a standard format, wherein terms substantial to describing the invention are translated into standard terms, and each invention or inventive version is described in a concise format;
b. converting the standard format description of the documents into documents in a format readable by a computer for automatic processing purposes;
c. comparing the invention with the prior art using automatic processing of the computer readable documents in the computer.

13. The method for comparing an invention document with prior art according to claim 12, wherein the results of the automatic processing include at least one of the following: a quantitative indice of the similarity between the invention and each of the prior art; an indication of the part or parts in the invention most similar with each of the prior art; and an indication of the part or parts in the invention most different from each of the prior art.

14. The method for comparing an invention document with prior art according to claim 12, further including a maintaining of a database with prior art documents in a computer readable format, and wherein the computer reads prior art documents from the database for comparing with the invention document.

15. The method for comparing an invention document with prior art according to claim 14, further including adding to the database prior art documents in computer readable format from other sources.

16. The method for comparing an invention document with prior art according to claim 12, wherein for each term which is substantial for defining the invention and wherein that term has more than one meaning in a language of the description, a further indice is include to limit that term to only one meaning.

17. The method for comparing an invention according to claim 16, wherein the indice is a number indicative of the field of that term according to the meaning of the term in that description.

18. A patent application structure wherein each claim comprises info indicative of a compliance of an invention defined in that claim with patentability requirements.

19. The patent application structure according to claim 18, wherein the indicative info includes the structure and operation of the invention as required for a full disclosure, info indicative of a novelty of the invention and info indicative of a non-obviousness of the invention.

20. The patent application structure according to claim 19, wherein the info indicative of novelty comprises indirect arguments.
